(19) United States
(12) Patent Application Publication
(10) Pub. No.: US 2018/0212957 A1
(43) Pub. Date: Jul. 26, 2018

(54) APPARATUS AND METHOD FOR AUTHENTICATION, AND COMPUTER PROGRAM AND RECORDING MEDIUM APPLIED TO THE SAME

(71) Applicant: Taw Wan LEE, Gwangmyeong-si (KR)

(72) Inventor: Taw Wan LEE, Gwangmyeong-si (KR)

(21) Appl. No.: 15/747,768

(22) PCT Filed: Jul. 28, 2016
(86) PCT No.: PCT/KR2016/008296

§ 371 Date: Jan. 26, 2018

(30) Foreign Application Priority Data
Jul. 28, 2015 (KR) 10-2015-0106917
Sep. 15, 2015 (KR) 10-2015-0130316
Sep. 15, 2015 (KR) 10-2015-0130338
Jul. 25, 2016 (KR) 10-2016-0093978

(51) Int. Cl. H04L 29/06; G06Q 20/40

(52) U.S. Cl. CPC H04L 63/0853; G06Q 20/4014; H04L 63/0869

(57) ABSTRACT

Disclosed are an authentication device and method, and a computer program and a recording medium applied thereto. An authentication device according to the present invention comprises: a registration request unit for, when screen information displayed on a specific screen of a user device is changed by a user's input or changed by a factor other than the user's input, encrypting the changed screen information and requesting registration of the encrypted changed screen information as authentication information; an authentication confirmation unit for receiving an authentication confirmation request from a communication network connected with the user device; and an authentication performing unit for extracting the screen information displayed on the specific screen according to a determination on whether to grant authentication for the authentication confirmation request, encrypting the extracted screen information, and then transmitting the encrypted authentication screen information to the communication network as a response to the authentication confirmation request.

### BACKGROUND

### 1. Technical Field

The present inventive concept relates to an apparatus and method for authentication, and computer program and recording medium applied to the same, and more particularly, to an apparatus and method for authentication, and computer program and recording medium applied to the same authenticating the user or strengthening the security of each object apparatus connected to the Internet.

### 2. Description of the Related Art

Financial service, message service, community service, shopping service, air service, and payment service through communication connection are provided, and these services include most services that can be accessed in real life.

To do this, it is necessary to authenticate the user using the service.

In the conventional authentication method, there is a method of inputting an ID and a password in a login step for accessing a corresponding service, and in a service (for example, a payment service) which needs to be further strengthened in user authentication, there are an public certificate method, phone authentication method, and authentication number input method to confirm and send authentication number sent after sending authentication number by text message.

First, in the method of inputting the ID and the password, the case where the ID and the password of the user are exposed to the outside due to the progress of the hacking technology is very frequent, and accordingly, the change of the password is recommended. Due to this recommendation or the will of the user, more and more users frequently change their password to access the service. However, it is not easy for the user to memorize a different password for each service, and it is also not suitable for security to record in a memo pad. In addition, it is not easy to connect and change login information for all the services used by the user at the time of changing the password, and it is very troublesome for the user.

In the case of the public certificate system, it is a concern of security to store the public certificate in the user apparatus (eg smart phone, PC, etc.). As an alternative to this, it is necessary to store the public certificate in the USB and carry it separately.

Also, in the case of the public certificate system, the password is required to be input, and it is set to be different from the password used in the above-mentioned log-in. Accordingly, the user must also remember the password used for the login and other authorized certificate passwords.

The telephone authentication method is an authentication method that is mainly used in settlement such as bank transfer. In order to additionally confirm a user at payment authentication, a telephone (ARS method) is applied to a registered user's telephone number. This is utilized as an auxiliary authentication means rather than a main authentication because, if the user apparatus is temporarily stolen, it is possible for someone to respond to the incoming telephone call in ARS mode instead.

On the other hand, the authentication number input method is used as various simple payment means. For example, when the user uses the PC to use the shopping service of the company A, and then performs payment processing based on the authentication number input method at the time of payment for the desired shopping item, the user can request payment by inputting the user's mobile phone number or the like on the payment screen provided by the shopping service of company A. Thereafter, the user himself or herself directly confirms the authentication number provided to the user's cellular phone and inputs the confirmed authentication number to the authentication number input window of the payment screen to perform authentication processing.

At this time, the user may feel the inconvenience of confirming the authentication number directly displayed on the mobile phone and inputting the authentication number into the authentication number input window, and the authentication number is limited to four or six digits Even if the authentication number is encrypted, there is a possibility of being exposed by hacking or the like. Due to these concerns, simple payment of mobile phones according to the authentication number input method has a fixed payment limit, and there is a limit to use for payment or remittance of an upward amount. This limitation of the authentication number input method can be a hindrance to the recent application to PINTECH authentication method.

The Internet has been used as a space where humans can share information with producers/consumers of information. In the future, it is predicted that the Internet of Things (IoT) will be able to share environmental information about objects, information about objects, and even objects around us, such as home appliances and sensors.

In other words, it is expected that object internet device (hereinafter referred to as Object Apparatus) supporting IoT will increase rapidly in the future.

When IOT enables communication, interaction, and information sharing between people and people, people and objects, objects and objects, intelligent services that enable self-determined intelligence services become possible, and companies can be an infrastructure to support green IT for cost reduction and green growth.

With the coming of the IoT era, communication between objects and objects is expected to be diverse. IoT-enabled smart devices, such as sensors and home appliances, will be able to access IoT-enabled devices. It is already realized that the connection and control of the object apparatus is commercialized in the smart window and the boiler of the home network part.

However, there are still security obstacles such as hacking in connection and control of object apparatus. In the IoT era, if a security leak occurs, serious damage such as privacy invasion and malfunction of object apparatus will be mass-produced. As a result, It is necessary to solve security problems.

Therefore, there is a need for a method that can overcome all the drawbacks of the above-described prior art authentication schemes.

### SUMMARY

Accordingly, the present invention has been made to solve the above-mentioned problems, and the present invention relates to an authentication apparatus and method for frequency changing authentication information for automatically performing user authentication without user setting, by changing the screen information displayed on the specific screen of the user apparatus, changing the usage information of the user apparatus, or using information that can be combined based on these, and to a computer program and a recording medium applied thereto.

Also, the present invention relates to an object apparatus for automatically changing authentication information for authenticating an object apparatus without setting a user when usage information of the object apparatus is changed, and an authentication method, a computer program, and a recording medium applied thereto.

The present invention also relates to an authentication apparatus and method for preventing the risk of loss and theft of a user apparatus, and a computer program and a recording medium applied thereto.

The purpose of the present invention are not limited to the above-mentioned purposes, and other purposes not mentioned can be clearly understood by those skilled in the art from the following description.

According to an aspect of the present invention, there is provided an authentication apparatus comprising: a registration requester which requests registration of authentication information based on a changed information if at least one of the screen information displayed on a specific screen of an user apparatus and an usage history of the user apparatus is changed by an user's input or is changed to a factor other than the input of the user; an authentication checker which receives an authentication confirmation request from a network connected to the user apparatus; and an authentication launcher which transmits an information for authentication confirmation based on at least one of the screen information and the usage history to the network in response to the authentication confirmation request in correspondence with the changed information.

wherein the screen information includes arrangement information for at least one application of the specific screen, notification detail information, background image, or information that can be combined based on these.

wherein, when requesting the registration of the authentication information, the authentication apparatus transmits the changed information or transmits a plurality of pieces of authentication related information including the changed information.

wherein the usage history may be a total usage history of the user apparatus or at least one specific usage history determined in advance, and the specific usage history may be changed to another specific usage history.

wherein the authentication apparatus is included in the user apparatus or connected to the user apparatus.

wherein the authentication apparatus is used for authentication of an offline payment through the user apparatus, authentication for online payment through the user apparatus, authentication for online payment through the user's other user apparatus, or login service.

According to another aspect of the present invention, there is provided an authentication method comprising: requesting registration of authentication information based on a changed information if at least one of the screen information displayed on a specific screen of an user apparatus and an usage history of the user apparatus is changed by an user's input or is changed to a factor other than the input of the user; receiving an authentication confirmation request from a network connected to the user apparatus; and transmitting an information for authentication confirmation based on at least one of the screen information and the usage history to the network in response to the authentication confirmation request in correspondence with the changed information.

According to another aspect of the present invention, there is provided an authentication method comprising: receiving a registration request of authentication information based on a changed information from a network if at least one of the screen information displayed on a specific screen of an user apparatus and an usage history of the user apparatus is changed by an user's input or is changed to a factor other than the input of the user; registering the authentication information according to the registration request; receiving an authentication request related to the user; receiving information for authentication confirmation based on at least one of the screen information and the usage history in correspondence with the changed information from the user apparatus through the network; comparing the information for authentication confirmation with the registered authentication information; and transmitting an authentication result based on a comparison result in response to the received authentication request.

According to another aspect of the present invention, there is provided a computer program, in combination with an authentication apparatus, storing on a non-transitory recording medium to execute an authentication method, the method comprising: requesting registration of authentication information based on a changed information if at least one of the screen information displayed on a specific screen of an user apparatus and an usage history of the user apparatus is changed by an user's input or is changed to a factor other than the input of the user; receiving an authentication confirmation request from a network connected to the user apparatus; and transmitting an information for authentication confirmation based on at least one of the screen information and the usage history to the network in response to the authentication confirmation request in correspondence with the changed information.

According to another aspect of the present invention, there is provided a non-transitory recording medium on which a computer program to execute an authentication method, the method comprising: requesting registration of authentication information based on a changed information if at least one of the screen information displayed on a specific screen of an user apparatus and an usage history of the user apparatus is changed by an user's input or is changed to a factor other than the input of the user; receiving an authentication confirmation request from a network connected to the user apparatus; and transmitting an information for authentication confirmation based on at least one of the screen information and the usage history to the network in response to the authentication confirmation request in correspondence with the changed information.

According to another aspect of the present invention, there is provided an object apparatus comprising: a registration requester which requests registration of authentication information based on a changed information if an usage information of the object apparatus is changed by an user's input or is changed to a factor other than the input of the user; an authentication checker which receives the connection request directly or indirectly from the other object apparatus and requests input of the connection information corresponding to the registered authentication information or connection authentication in response to the received connection request; and access approver which approves the connection of the other object apparatus according to the authentication of the input connection information or the result of the connection authentication.

wherein the object apparatus further includes a connection request and controller for requesting connection to any other object apparatus to be controlled and for controlling the other object apparatus after connection approval.

According to another aspect of the present invention, there is provided an authentication method comprising: requesting registration of authentication information based on a changed information if an usage information of the object apparatus is changed by an user's input or is changed to a factor other than the input of the user; receiving the connection request directly or indirectly from the other object apparatus and requests input of the connection information corresponding to the registered authentication information or connection authentication in response to the received connection request; and approving the connection of the other object apparatus according to the authentication of the input connection information or the result of the connection authentication.

According to another aspect of the present invention, there is provided a computer program, in combination with an authentication apparatus, storing on a non-transitory recording medium to execute an authentication method, the method comprising: requesting registration of authentication information based on a changed information if an usage information of the object apparatus is changed by an user's input or is changed to a factor other than the input of the user; receiving the connection request directly or indirectly from the other object apparatus and requests input of the connection information corresponding to the registered authentication information or connection authentication in response to the received connection request; and approving the connection of the other object apparatus according to the authentication of the input connection information or the result of the connection authentication.

According to another aspect of the present invention, there is provided a non-transitory recording medium on which a computer program to execute an authentication method, the method comprising: requesting registration of authentication information based on a changed information if an usage information of the object apparatus is changed by an user's input or is changed to a factor other than the input of the user; receiving the connection request directly or indirectly from the other object apparatus and requests input of the connection information corresponding to the registered authentication information or connection authentication in response to the received connection request; and approving the connection of the other object apparatus according to the authentication of the input connection information or the result of the connection authentication.

According to another aspect of the present invention, there is provided an authentication method comprising: receiving a registration request of authentication information based on a changed information from a network if an usage information of any one of the plurality of object apparatus is changed by an user's input or is changed to a factor other than the input of the user; registering the authentication information according to the registration request; receiving a connection authentication request for the second object apparatus directly or indirectly from the first object apparatus among the plurality of object apparatuses; generating a connection authentication result using an authentication result that is executed based on each of the authentication information registered in advance for the first object apparatus and the second object apparatus, and a connection authorization information that is registered in advance for the connection relationship between the first object apparatus and the second object apparatus; and outputting the connection authentication result.

According to another aspect of the present invention, there is provided an authentication apparatus comprising: a multi authentication registration setter which sets registration of a second user apparatus for verifying authentication approval of a first user apparatus in a state in which the registration of the authentication information based on a changed information is executed, if at least one of the screen information displayed on a specific screen of the first user apparatus and an usage history of the first user apparatus is changed by an user's input or is changed to a factor other than the input of the user; an multi authentication checker which receives a verification request for authentication approval of the first user apparatus from a network connected to the second user apparatus; and an multi authentication launcher which transmits an information for verification confirmation to the network in response to the verification request, according to whether or not the verification request is approved.

According to another aspect of the present invention, there is provided an authentication method by authentication apparatus, the method comprising: setting registration of a second user apparatus for verifying authentication approval of a first user apparatus in a state in which the registration of the authentication information based on a changed information is executed, if at least one of the screen information displayed on a specific screen of the first user apparatus and an usage history of the first user apparatus is changed by an user's input or is changed to a factor other than the input of the user; receiving a verification request for authentication approval of the first user apparatus from a network connected to the second user apparatus; and transmitting an information for verification confirmation to the network in response to the verification request, according to whether or not the verification request is approved.

According to another aspect of the present invention, there is provided an authentication method by authentication server, the method comprising: receiving a registration request of a second user apparatus for verifying authentication approval of a first user apparatus in a state in which the registration of the authentication information based on a changed information is executed, if at least one of the screen information displayed on a specific screen of the first user apparatus and an usage history of the first user apparatus is changed by an user's input or is changed to a factor other than the input of the user; registering the second user apparatus according to the registration request; receiving the authentication approval of the first user apparatus, if the authentication request related to the user is received; transmitting a verification request for authentication approval of the first user apparatus to the second user apparatus; generating a final authentication result according to whether the verification request is approved or not, and transmitting the generated final authentication result in response to the received authentication request.

According to another aspect of the present invention, there is provided a computer program, in combination with an authentication apparatus, storing on a non-transitory recording medium to execute an authentication method, the method comprising: setting registration of a second user apparatus for verifying authentication approval of a first user apparatus in a state in which the registration of the authentication information based on a changed information is executed, if at least one of the screen information displayed on a specific screen of the first user apparatus and an usage history of the first user apparatus is changed by an user's input or is changed to a factor other than the input of the user; receiving a verification request for authentication approval of the first user apparatus from a network connected to the second user apparatus; and transmitting an information for verification confirmation to the network in response to the verification request, according to whether or not the verification request is approved.

According to another aspect of the present invention, there is provided a non-transitory recording medium on which a computer program to execute an authentication method, the method comprising: setting registration of a second user apparatus for verifying authentication approval of a first user apparatus in a state in which the registration of the authentication information based on a changed information is executed, if at least one of the screen information displayed on a specific screen of the first user apparatus and an usage history of the first user apparatus is changed by an user's input or is changed to a factor other than the input of the user; receiving a verification request for authentication approval of the first user apparatus from a network connected to the second user apparatus; and transmitting an information for verification confirmation to the network in response to the verification request, according to whether or not the verification request is approved.

Therefore, the present invention has an advantage that it is possible to automatically (and frequently) change the authentication information for user authentication without user setting, by changing the screen information displayed on the specific screen of the user apparatus, changing the usage information of the user apparatus.

In addition, when a user performs authentication required in a specific service, the present invention performs a minimum input (e.g., one click for authentication request) for the authentication request through the terminal accessing the specific service, and performs a minimum input (e.g., one click for confirmation of authentication initiation) for confirmation of authentication initiation through an authentication device, it is possible to proceed both from the start of authentication to the end of authentication based on a reliable level of security. when the specific service to be accessed is an offline payment service, the present invention has an advantage that it is possible to perform both the authentication start and the authentication completion based on a reliable level of security with no user input for authentication and only the selection of the payment means of the user.

In addition, the present invention can replace the password used for login of a specific service, and can also be used for authentication of an offline payment through a user device (e.g., a mobile phone) or for an online payment through a user device, and there is an advantage in that it is possible to provide an authentication platform that can handle authentication and authentication of online payment through a user's other user device (e.g., PC).

Further, when the usage information of the object apparatus is changed, authentication information for authentication of the object apparatus is automatically changed without setting the user, thereby enhancing the security of the object apparatus on the object Internet.

The present invention also has the advantage of being able to prepare for the risk of loss and theft of the user apparatus.

The effects of the present invention are not limited to the effects mentioned above, and other effects not mentioned can be clearly understood by those skilled in the art from the description of the claims.

### BRIEF DESCRIPTION OF THE DRAWINGS

FIG. 1 is a block diagram illustrating a authentication apparatus according to one embodiment of the present inventive concept;

FIG. 2 is a detailed block diagram specifically illustrating that an authentication apparatus of FIG. 1 is included in a user apparatus;

FIG. 3 is a detailed block diagram specifically illustrating that an authentication apparatus of FIG. 1 is connect to a user apparatus;

FIG. 4 is a block diagram illustrating a storage history applied to an authentication apparatus of FIG. 1;

FIG. 5 illustrates an exemplary embodiment of a storage history of FIG. 4;

FIG. 6 is a detailed exemplary embodiment specifically illustrating a storage history of FIG. 5;

FIG. 7 illustrates another exemplary embodiment of a storage history of FIG. 4;

FIG. 8 is a detailed exemplary embodiment specifically illustrating a storage history of FIG. 7;

FIG. 9 illustrates an exemplary embodiment of a service access screen;

FIG. 10 illustrates an exemplary embodiment of a message of authentication request;

FIG. 11 is a detailed block diagram specifically illustrating an authentication system according to one embodiment of the present inventive concept;

FIG. 12 is a detailed block diagram specifically illustrating an authentication system according to another embodiment of the present inventive concept;

FIG. 13 is a detailed block diagram specifically illustrating an authentication system according to another embodiment of the present inventive concept;

FIG. 14 is a detailed block diagram specifically illustrating an authentication system according to another embodiment of the present inventive concept;

FIG. 15 is a detailed block diagram specifically illustrating an authentication system according to another embodiment of the present inventive concept;

FIG. 16 is a detailed block diagram specifically illustrating an authentication system according to another embodiment of the present inventive concept;

FIG. 17 is a detailed block diagram specifically illustrating an authentication system of FIG. 16;

FIG. 18 is a detailed block diagram specifically illustrating an authentication system according to another embodiment of the present inventive concept;

FIG. 19 is a block diagram illustrating an authentication apparatus according to another embodiment of the present inventive concept;

FIG. 20 illustrates an exemplary embodiment of a screen on which a selector of FIG. 19 is executed;

FIG. 21 illustrates an exemplary embodiment of registration of authentication information through the authentication apparatus of FIG. 19;

FIG. 22 illustrates another exemplary embodiment of registration of authentication information through the authentication apparatus of FIG. 19;

FIG. 23 is a flow chart illustrating an exemplary embodiment of an operation process of an authentication apparatus of the present inventive concept;

FIG. 24 is a flow chart illustrating an exemplary embodiment of an operation process of an authentication server of the present inventive concept;

FIG. 25 is a flow chart illustrating an exemplary embodiment of an operation process of an service server of the present inventive concept;

FIG. 26 is a flow chart illustrating an exemplary embodiment of a payment service to which an authentication system of the present invention is applied;

FIG. 27 is a flow chart illustrating another exemplary embodiment of a payment service to which an authentication system of the present invention is applied;

FIG. 28 is a flow chart illustrating another exemplary embodiment of a payment service to which an authentication system of the present invention is applied;

FIG. 29 is a block diagram illustrating an authentication apparatus according to another embodiment of the present inventive concept;

FIG. 30 illustrates an exemplary embodiment of a specific screen of a user apparatus on which an authentication apparatus of FIG. 29 is applied;

FIG. 31 illustrates another exemplary embodiment of a specific screen of a user apparatus on which an authentication apparatus of FIG. 29 is applied;

FIG. 32 illustrates another exemplary embodiment of a specific screen of a user apparatus on which an authentication apparatus of FIG. 29 is applied;

FIG. 33 illustrates another exemplary embodiment of a specific screen of a user apparatus on which an authentication apparatus of FIG. 29 is applied;

FIG. 34 illustrates another exemplary embodiment of a specific screen of a user apparatus on which an authentication apparatus of FIG. 29 is applied;

FIG. 35 illustrates another exemplary embodiment of a specific screen of a user apparatus on which an authentication apparatus of FIG. 29 is applied;

FIG. 36 is a flow chart illustrating another exemplary embodiment of an operation process of an authentication apparatus of the present inventive concept;

FIG. 37 is a flow chart illustrating another exemplary embodiment of an operation process of an authentication server of the present inventive concept;

FIG. 38 is a flow chart illustrating another exemplary embodiment of a payment service to which an authentication system of the present invention is applied;

FIG. 39 is a flow chart illustrating another exemplary embodiment of a payment service to which an authentication system of the present invention is applied;

FIG. 40 is a flow chart illustrating another exemplary embodiment of a payment service to which an authentication system of the present invention is applied;

FIG. 41 is a block diagram illustrating an object apparatus according to one embodiment of the present inventive concept;

FIG. 42 illustrates another exemplary embodiment of an usage history stored in an object apparatus of FIG. 41;

FIG. 43 is a block diagram illustrating an object apparatus according to an another embodiment of the present inventive concept;

FIG. 44 illustrates another exemplary embodiment of communication configuration between object apparatus of the present inventive concept;

FIG. 45 is a detailed block diagram specifically illustrating one exemplary embodiment of configuration for the case where the first object device in FIG. 44 is hacked;

FIG. 46 is a detailed block diagram specifically illustrating one exemplary embodiment of change authentication information for the first object device of FIG. 44;

FIG. 47 illustrates another exemplary embodiment of communication configuration between object apparatus of the present inventive concept;

FIG. 48 is a detailed block diagram specifically illustrating one exemplary embodiment of configuration for the case where the first object device in FIG. 47 is hacked;

FIG. 49 is a detailed block diagram specifically illustrating one exemplary embodiment of changing authentication information for each object apparatus of FIG. 47;

FIG. 50 illustrates another exemplary embodiment of communication configuration between object apparatus of the present inventive concept;

FIG. 51 is a detailed block diagram specifically illustrating an authentication system according to another embodiment of the present inventive concept;

FIG. 52 is a detailed block diagram specifically illustrating an authentication system according to another embodiment of the present inventive concept;

FIG. 53 is a detailed block diagram specifically illustrating an authentication system according to another embodiment of the present inventive concept;

FIG. 54 is a detailed block diagram specifically illustrating an authentication system according to another embodiment of the present inventive concept;

FIG. 55 is a flow chart illustrating one exemplary embodiment of an authentication process of an object apparatus of the present inventive concept;

FIG. 56 is a flow chart illustrating one exemplary embodiment of an authentication process of an authentication server of the present inventive concept;

FIG. 57 is a block diagram illustrating a authentication apparatus according to another embodiment of the present inventive concept.

### DETAILED DESCRIPTION OF THE EMBODIMENTS

The advantages and features of the present invention and the manner of achieving them will become apparent with reference to the embodiments described in detail below with reference to the accompanying drawings. The present invention may, however, be embodied in many different forms and should not be construed as limited to the embodiments set forth herein, and these embodiments are provided so that this disclosure will be thorough and complete, and will fully convey the scope of the invention to those skilled in the art to which the present invention pertains.

In addition, the embodiments described herein will be described with reference to cross-sectional views and/or schematic drawings that are ideal illustrations of the present invention. Thus, the shape of the illustrations may be modified by manufacturing techniques and/or tolerances. In addition, in the drawings of the present invention, each component may be somewhat enlarged or reduced in view of convenience of description.

Exemplary embodiments of the present inventive concept will hereinafter be described with reference to the attached drawings.

An authentication apparatus of the present invention can substitute a password used for login of a specific service, and may be used to authenticate offline payments via a user apparatus (e.g., a mobile phone), authentication of an online payment via a user apparatus (e.g., a mobile phone), authentication of an online payment via a user's other user apparatus (e.g., a PC), and includes a platform configuration for this.

Further, the authentication apparatus of the present invention can automatically change the authentication information for user authentication without user setting and allow the user to access the specific service through the authentication process without memorizing or memorizing the changed authentication information.

To this end, the authentication apparatus of the present invention can automatically perform authentication for user authentication without user setting by changing the screen information displayed on the specific screen of the user apparatus, changing the usage history of the user apparatus, Information can be changed from time to time.

Here, the screen information includes arrangement information, notification detail information, background image, or information that can be combined based on these.

Usage details of the user apparatus include details (e.g., 2015 Jul. 28, 8:20 am to 2015 Jul. 28, 8:35 am A game execution, 2015 Jul. 28, 8:36 am B company message to LEE, from 9:02 am on May 28, 2018 to 9:16 am on May 28, 2015) using the user device by the user, information that the user apparatus is not used by the user but history (For example, receiving the B message at 8:37 am on May 27, 2015, receiving the C notice application application notice at 09:01 am, Jun. 27, 2015) of the user apparatus being used as an external factor, or information that can be combined based thereon.

For example, the usage history of the user apparatus is registered as the authentication information, and subsequently, the registered authentication information can be continuously updated. Five (Example: game A runs from 8:20 am on Jul. 28, 2015 to Jul. 28, 2018 8:35 am→send Company B message to LEE at 8:36 am on Jul. 28, 2015→receiving Company B message at 8:37 am on Jul. 28, 2015→receipt of notifications related to the securities application of Company C at 9:01 am on Jul. 28, 2015→eading the stock news of D company from 9:02 am on Jul. 28, 2015 to 9:16 am on Jul. 28, 2015) of the last usage details of the user apparatus are extracted, and the extracted five usage details can be registered as authentication information or can be updated in place of already registered authentication information. That is, as the user apparatus is continuously used, it is difficult to predict at all which menu or which application to be used, and thereby the authentication information can be updated.

As another example, it is possible to register not only five of the entire usage history of the user apparatus but also the last usage history (3 cases) of a specific usage history (e.g., portal application of company E) as authentication information or to use it as information for updating the registered authentication information It is possible. Here, it is also possible to change the specific use history (for example, the portal application of the company E) to another specific use history (for example, a message application of the company B).

First, the concrete contents of the user authentication based on the change of the usage information will be described.

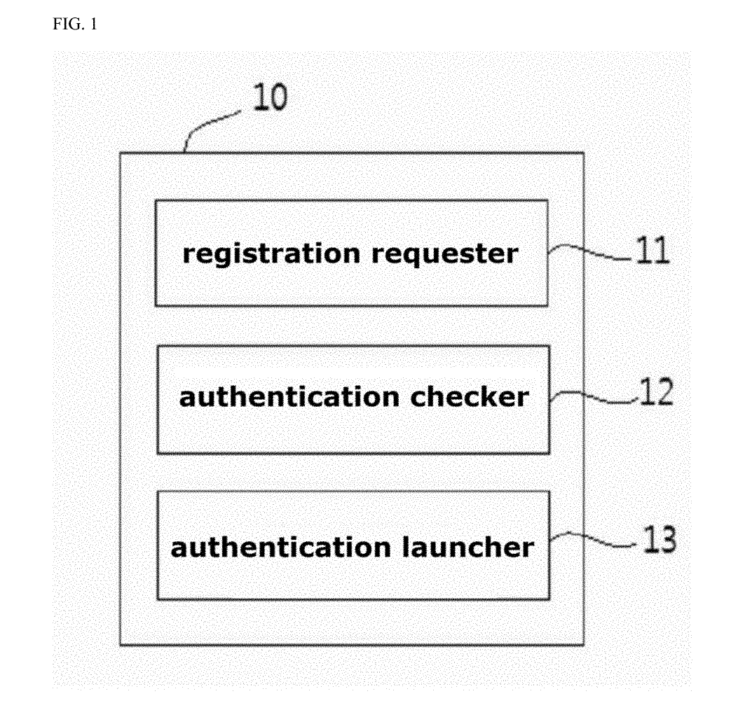

FIG. 1 is a block diagram illustrating a authentication apparatus according to one embodiment of the present inventive concept.

As shown in FIG. 1, the authentication apparatus 10 includes a registration requester 11 which requests registration of authentication information based on a changed information if at least one of the screen information displayed on a specific screen of an user apparatus and an usage history of the user apparatus is changed by an user's input or is changed to a factor other than the input of the user, an authentication checker 12 which receives an authentication confirmation request from a network connected to the user apparatus and an authentication launcher 13 which transmits an information for authentication confirmation based on at least one of the screen information and the usage history to the communication network in response to the authentication confirmation request in correspondence with the changed information.

Here, the user apparatus may be any one of a mobile phone such as a smart phone, a PC, and an electronic device that a user frequently uses frequently.

Also, the usage information of the user apparatus refers to details using the user apparatus by the user, information on the use of the user apparatus by external factors rather than the user apparatus by the user, or information that can be combined based thereon.

The registration requester 11 encrypts the registration request usage information including the changed usage information when the usage information of the user apparatus is changed by a user's input or changed to a factor other than the user's input, and requests the authentication server to register it as the authentication information. At this time, the registration request includes not only requesting the initial registration but also requesting to update the already registered authentication information.

Specifically, it is possible to utilize only the changed usage information as the registration request usage information, but it is also possible to combine the changed usage information and the existing usage information to use as the registration request usage information.

The registration request usage information may be the same as the entire portion of the registered authentication information, or may be the same as a part of the registered authentication information.

Here, the same parts of the registration request usage information and the registered authentication information mean that the registration request usage information is directly used as authentication information. For example, when the registration request usage information is ABCDE, the registered authentication information also becomes ABCDE. At this time, each alphabet of ABCDE means usage information of the user apparatus.

In addition, the fact that the registration request usage information is the same as a part of the registered authentication information means that only some information is consistent between the registration request usage information and the authentication information. This is to prepare for security exposure due to hacking during information transmission. When the registration request usage information does not transmit all the information for registering as the authentication information, but only ABC, which is a part, is transmitted, ABCDE as the final authentication information by combining the received registration request usage information ABC and the existing registration details CD according to the determined authentication information registration algorithm.

That is, if only A is the changed usage information and BC is the existing usage information among the registration request usage information ABC, the authentication server extracts the third and fourth existing usage information CD Accordingly, ABCDE can be finally registered as the final authentication information as described above.

The authentication checker 12 receives an authentication confirmation request from a network connected to the user apparatus.

For example, when a user uses a shopping service using another user apparatus (e.g., a PC), the authentication service of the present invention can be used at the payment step of the shopping service in use. At this time, the user inputs a specific number (e.g., a telephone number) of a user apparatus (e.g., a mobile phone) including the authentication apparatus 10 in a payment step of the shopping service, and then clicks an authentication request, in a state where a specific number (e.g., a telephone number) of a user apparatus (e.g., a mobile phone) including the user is input, the service server of the shopping service transmits the authentication request of the user to the authentication server, the server delivers the authentication confirmation request corresponding to the received authentication request to the user apparatus (e.g., cellular phone). Then, the user apparatus (e.g., cellular phone) receives the received authentication confirmation request as a message and outputs the received message to the terminal screen so that the user can confirm the received message, thereby allowing the user to recognize the authentication progress status.

In the above example, when the user makes one-touch input for authentication approval, the authentication launcher 13 extracts specific usage information of a predetermined reference among the entire usage information stored in advance in the storage details of the user apparatus, and transmits the encrypted authentication usage information to the authentication server via the network in response to the authentication confirmation request.

As another example, when a user uses a payment service in an offline store using a user apparatus (e.g., a mobile phone), one of the menus of the user apparatus (e.g., mobile phone) can select one registration card for payment. At this time, the authentication apparatus 10 included in the user apparatus (e.g., cellular phone) automatically requests the authentication server to transmit an authentication request and specific usage information of the user apparatus (e.g., mobile phone) according to the selection of the registration card it is possible. That is, when the registration card is selected, the authentication apparatus 10 in this case receives the authentication confirmation request from the application for payment in the off-line store, and in response to the received authentication confirmation request, the authentication request and the specific usage information of the user apparatus (e.g., mobile phone) can be encrypted and processed in the authentication server immediately without going through the process.

The network referred to in the present invention is a term including both an external network for connecting a user apparatus to an externally located server and an internal network for communication between the user apparatus and the authentication apparatus 10. Also, the external network includes a network that changes according to the location of the user apparatus. When the authentication apparatus 10 requests registration, the network connecting to the authentication server may be the same as or different from the network connected when performing the authentication. The network in which the authentication apparatus 10 receives the authentication confirmation request is also a network having the same contents as above.

The specific usage information extracted through the authentication launcher 13 may be the same as the entire portion of the registered authentication information or may be the same as a part of the registered authentication information.

Here, the fact that the extracted specific usage information and all the registered authentication information are the same means that specific usage information is extracted like the registered authentication information. For example, if the registered authentication information is ABCDE, the specific usage information extracted also becomes ABCDE.

In addition, the fact that the extracted specific usage information is the same as a part of the registered authentication information means that only some pieces of information are identical between the extracted specific usage information and the authentication information. Also, in order to better prepare for exposure to the risk of hacking during information transmission, when the specific usage information transmits only a part of CDE without transmitting all information to be compared with the authentication information, the registered authentication information is the specific usage information CDE transmitted through the authentication execution algorithm is combined with the existing registration details AB to complete ABCDE which is the final specific usage information of the comparison target to be compared with the registered authentication information.

That is, the specific usage information extracted in the authentication execution process and the registration request usage information of the registration process may be different from each other as described above. Of course, it is also possible to set the specific usage information extracted in the authentication execution process and the registration request usage information of the registration process to be the same.

The registration requester 11 includes a configuration for detecting whether the usage information of the user apparatus is changed by a user's input or a factor other than a user's input, and requests the registration of the authentication information based on the changed usage information when the usage information is changed through such a detection configuration.

It is preferable that the authentication information registration request of the registration request unit 11 is executed automatically at every change of the usage information of the user apparatus. The specific usage information of the authentication launcher 13 is extracted and transferred, which means that it is not easy for the user to confirm the usage information of the user apparatus and then to memorize and use the usage information registered as the authentication information. Therefore, it is preferable that the specific usage information of the authentication launcher 13 is extracted and transmitted automatically.

On the other hand, it is possible to automatically change the authentication information. However, when the user intends to change the authentication information more frequently, he or she may call the terminal of another user whenever the user thinks, It is also possible to change the authentication information by changing usage information such as deleting some usage information from the stored old usage information.

The registration requester 11 may periodically or non-periodically change the same part of the mutual information if the registration request usage information and the registered authentication information are identical.

For example, the periodic change of the registration requester 11 may be performed by combining at least one of the date, the week, and the time according to the pre-programmed logic to identify a part of the same between the registration request usage information and the registered authentication information. As a more specific example, if the same part of the registration information of the registration request used in 2015 Sep. 14 and the registered authentication information corresponds to 3 weeks of September 2015 based on the week of the corresponding month, the same part of the authentication information can be identified as the same part from the first to the third digit of the registered authentication information.

An example of the non-periodic change of the registration requester 11 is that the registration requester 11 can change the same part between the registration request usage information and the registered authentication information based on the update information received from the authentication server.

The authentication launcher 13 can also change the same part of the mutual information periodically or non-periodically if one part is identical between the specific usage information extracted from the total usage information and the registered authentication information.

For example, the periodical change of the authentication launcher 13 may be performed by using a combination of at least one of a date, a week, and a time, according to pre-programmed logic. As a more specific example, when the same part extracted between the specific usage information extracted from the registration information and the registered authentication information is divided into an even numbered day and an odd numbered day, the 14th day corresponds to an even number day, the same part of the same part can be specified as the same part from the previous letter of the registered authentication information up to 2 digits.

As an example of the non-periodic change of the authentication launcher 13, the authentication launcher 13 can obtain the same part of the specific usage information extracted based on the update information received from the authentication server and the registered authentication information.

The registration requester 11 can encrypt the changed usage information and the authentication launcher 13 can encrypt the extracted specific usage information.

Here, at least one of various encryption schemes having a high security level can be applied to the encryption scheme.

For example, at least one of the registration requester 11 and the authentication launcher 13 can encrypt the public key using a prime number greater than a predetermined number of digits.

The public key cryptosystem can easily obtain the product m (=pq) of two prime numbers when p and q are given, with two prime numbers (1 and a natural number that can not be separated by a natural number other than the number itself) Given a product m of a prime number, it is hard to know which m is a product of two prime numbers. In other words, the public key system is provided with a device such as a trapdoor in which anyone can easily enter in one direction but can not come back except for a specific user.

When you expose m products of two prime numbers, you can use prime numbers in which two prime numbers p and q are 100 or more digits each. For example, m may be:

m=1143816257578888676692357799761466120102182967212423625625618429357 06935245733897830597123563958705058989075147599290026879543541

The two prime factors p and q of the top m obtained by the factorization algorithm are as follows.

p=3490529510847650949147849619903898133417764638493387843990820577

q=32769132993266709549961988190834461413177642967992942539798288533

Even if two prime factors p and q of the top m are obtained by using the factorization algorithm, it takes time to derive the result value. This requires absolute computation processing time even if the factorization algorithm is continuously improved.

Accordingly, it is preferable that the public key cryptosystem is encrypted with prime numbers greater than the two prime factors p and q mentioned above. In other words, public key cryptography is a method that requires a minimum amount of time (for example, several days) to decrypt even if it is exposed to a hacking program.

m=1143816257578888676692357799761466120102182967212423625625618429357 06935245733897830597123563958705058989075147599290026879543541

The authentication apparatus 10 of the present invention changes the authentication information every time the usage information of the user apparatus is changed. For example, when the user apparatus is a cellular phone, the changing interval of the authentication information is different for each user, it can be changed at intervals of a few second or several hours.

That is, even if the usage information of the user apparatus changed frequently is encrypted by the public key cryptosystem and exposed and decrypted by the public key cryptosystem, the authentication information is changed to the new authentication information at the time when the decryption is completed. With this principle, the authentication apparatus 10 of the present invention can combine not only user convenience but also strong security by minimizing user input (e.g., no input of a password).

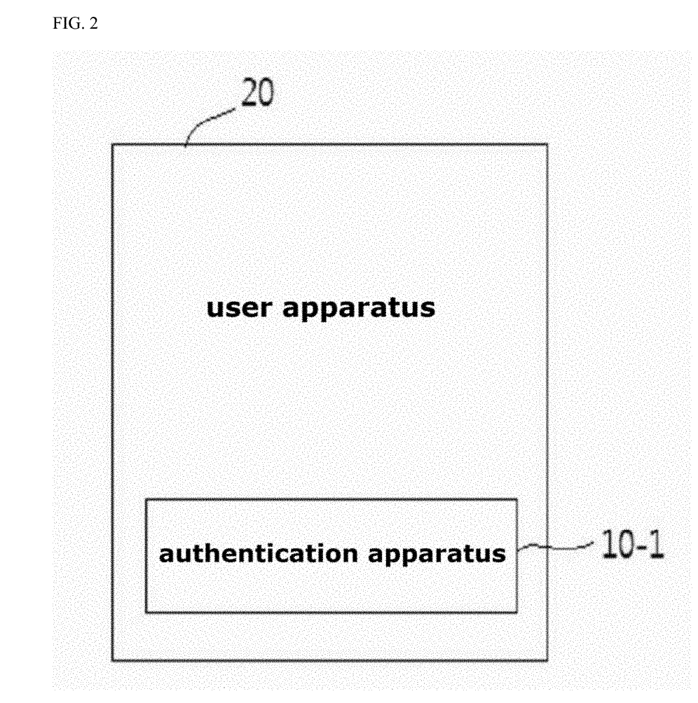

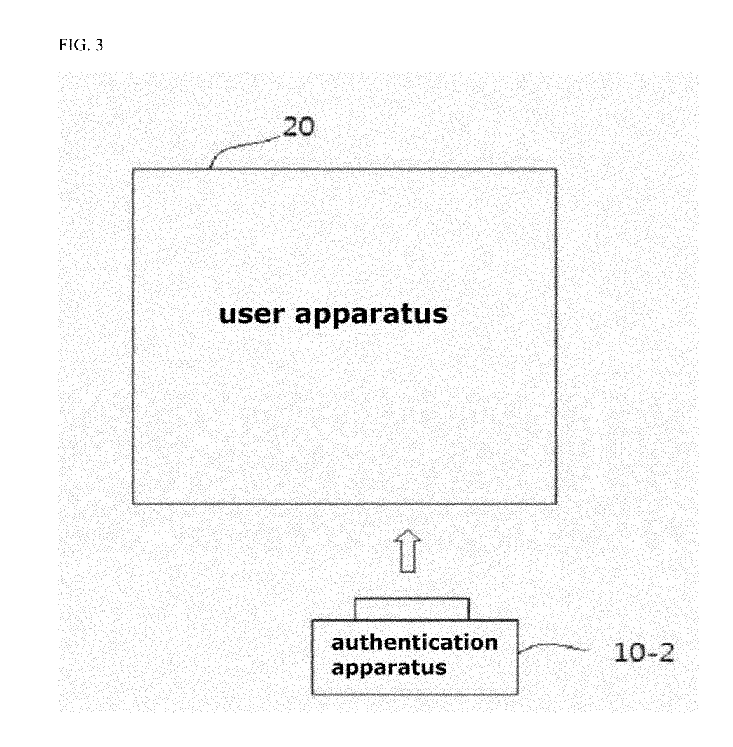

FIG. 2 is a detailed block diagram specifically illustrating that an authentication apparatus of FIG. 1 is included in a user apparatus, and FIG. 3 is a detailed block diagram specifically illustrating that an authentication apparatus of FIG. 1 is connect to a user apparatus.

As shown in FIG. 2, the authentication apparatus 10-1 may be included in the user apparatus 20. For example, by installing the downloaded authentication program in the user apparatus 20 after the user apparatus 20 downloads the authentication program via an authentication server or other root, the memory of the user apparatus 20 and the operation of at least one processor that is possible to provide an authentication device configuration.

On the other hand, as shown in FIG. 3, the authentication apparatus 10-2 may be connected to the user apparatus 20. The authentication apparatus 10-2 may be configured as a separate module so that the configured module can be connected to a specific port of the user apparatus 20 to link the two apparatus together.

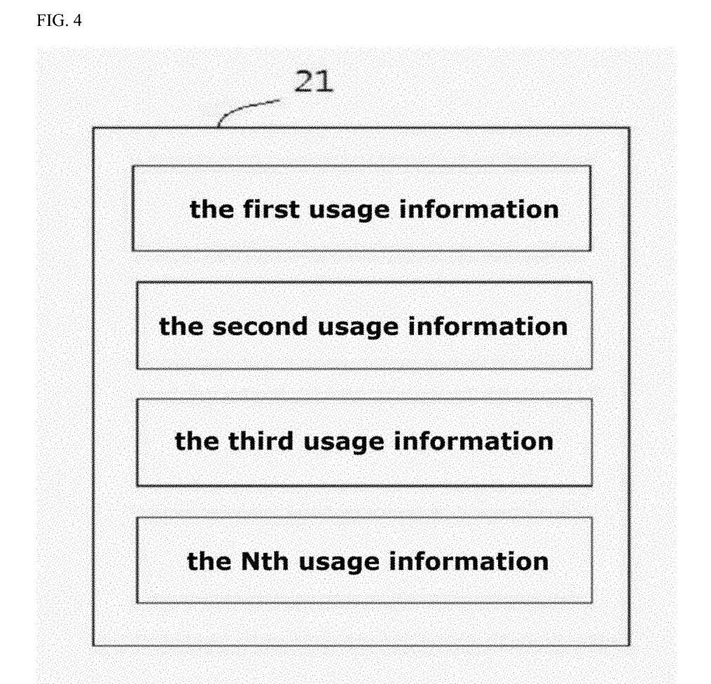

FIG. 4 is a block diagram illustrating a storage history applied to an authentication apparatus of FIG. 1

As shown in FIG. 4, a plurality of pieces of usage information are stored in the storage 21 of the user apparatus. For example, the first usage information, the second usage information, the third usage information, and the Nth usage information may be included in the user apparatus by dividing each usage information.

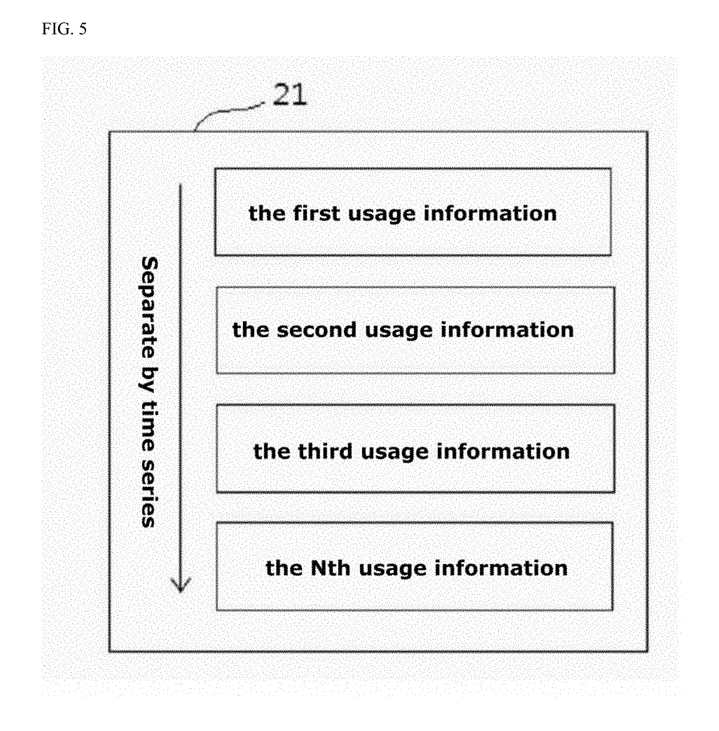

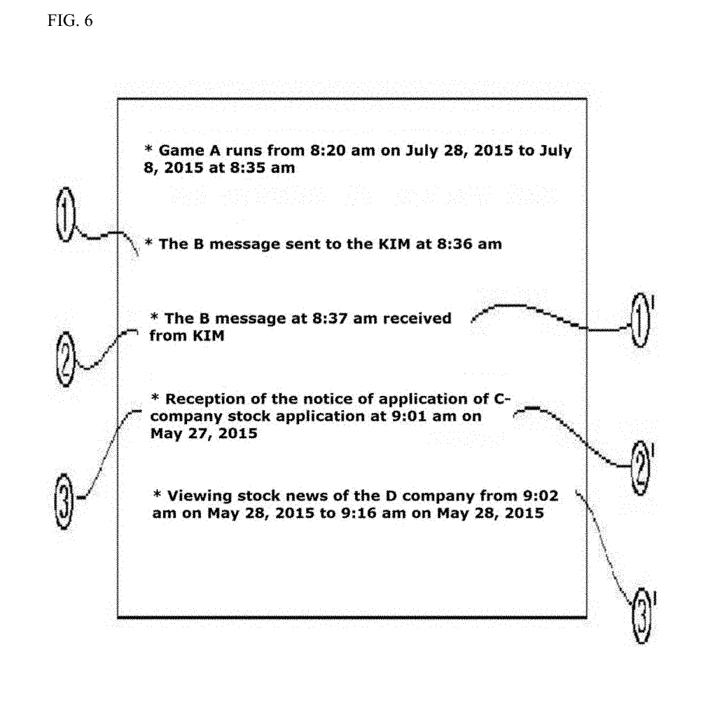

FIG. 5 illustrates an exemplary embodiment of a storage history of FIG. 4, and FIG. 6 is a detailed exemplary embodiment specifically illustrating a storage history of FIG. 5;

As shown in FIG. 5, the first usage information, the second usage information, the third usage information, and the Nth usage information may specify the order of information according to a time series sequence. When the registration requester 11 requests registration to the authentication server including the three pieces of usage information as the registration request usage information, the first usage information to the third usage information may be used as the registration request usage information according to the time series order.

The usage information shown in FIG. 6 is different from FIG. 5 in a time-series arrangement in which the recent usage history is arranged below and the past usage history is placed on the top. The registration requester 11 uses the three pieces of usage information of the latest three pieces of usage information, that is, (1) usage information for the B message sent to the KIM at 8:36 am, (2) usage information about the B message at 8:37 am received from KIM, and (3) usage information about reception of the notice of application of C-company stock application at 9:01 am on May 27, 2015, may be requested as authentication information.

When the usage information of the user apparatus is added and changed, for example, in addition to the above-described usage history, the registration requester 11 also receives usage information about viewing the securities news of the company D from 9:02 am on Jul. 28, 2015 to 9:16 am on July 8, the usage information can be added. At this time, the registration request unit 11 uses the (1-1) usage information of the registration request usage information as information about receiving the B message from the KIM at 8:37 am on May 28, 2015, (2-1) information on receipt of the securities application notice of the C company at 9:01, and (3-1) usage information about viewing stock news of the D company from 9:02 am on May 28, 2015 to 9:16 am on May 28, 2015, and can request registration as authentication information.

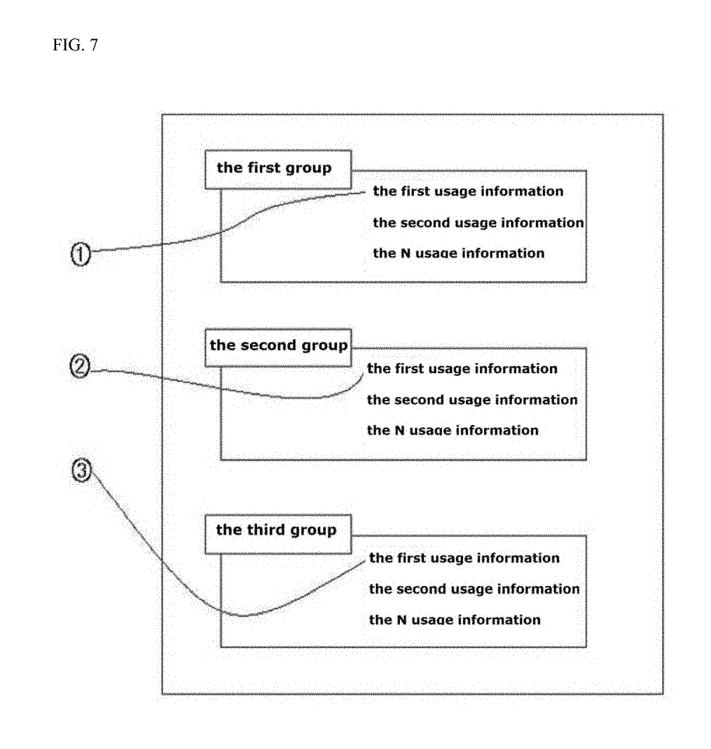

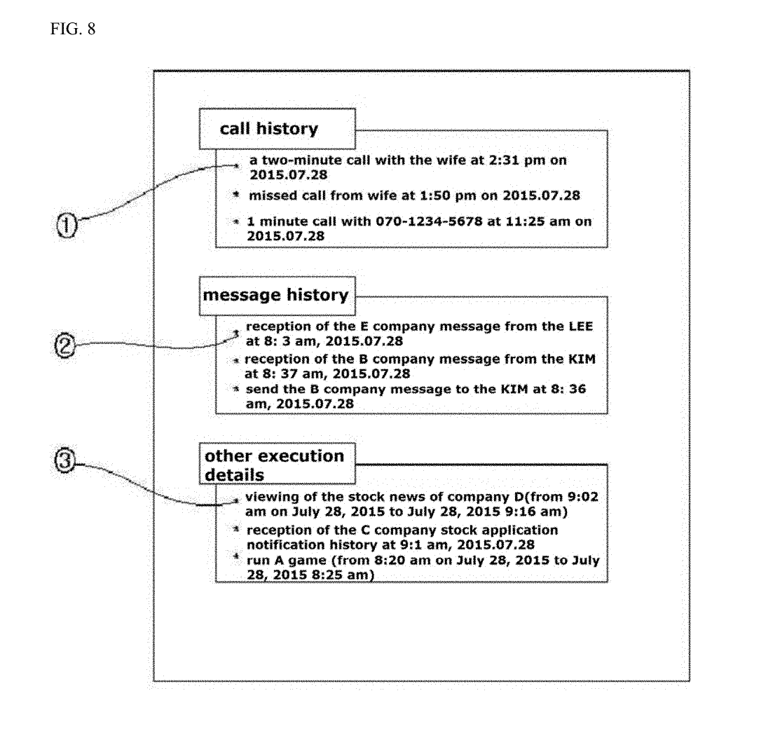

FIG. 7 illustrates another exemplary embodiment of a storage history of FIG. 4, and FIG. 8 is a detailed exemplary embodiment specifically illustrating a storage history of FIG. 7.

As shown in FIG. 7, the registration requester 11 may classify the usage information of the user apparatus according to a category, and extract usage information to be included in the registration request usage information from each group.

For example, when the registration request usage information is set to three pieces of usage information, the first usage information of the first group is extracted as (1) usage information of the registration request usage information, the first usage information of the second group is extracted as (2) usage information of the registration request usage information, and the first usage information of the third group can be extracted as (3) usage information of the registration request usage information.

As shown in FIG. 8, the first group described above may be a call history, and may include usage information related to a two-minute call with the wife at 2:31 pm on 2015 Jul. 28, the latest call history of the call history, it can be extracted as (1) usage information of the registration request usage information.

The second group may be the message history. The usage information about the reception of the E company message from the LEE at 8:3 am, 2015 Jul. 28, which is the most recent message history of the message history, It can be extracted as (2) usage information of the registration request usage information.

The above-mentioned third group may be other execution details, and usage information about the viewing of the stock news of company D (from 9:02 am on Jul. 28, 2015 to Jul. 28, 2015 9:16 am), which is the most recent message among other execution details, can be extracted as (3) usage information of the registration request usage information.

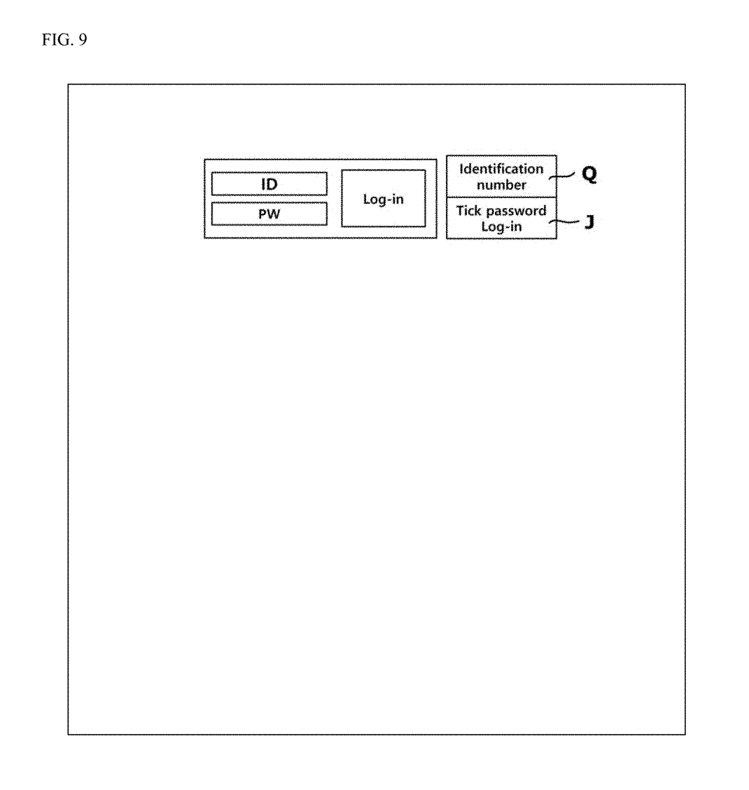

FIG. 9 illustrates an exemplary embodiment of a service access screen.

The user accesses the service connection screen 30 for providing a specific portal service using another user apparatus (e.g., PC), and inputs the specific number (Q) of the user apparatus (e.g., cellular phone 20) in the service connection screen 30. Then, when the authentication request J is clicked, the authentication request received at the service server providing the specific portal service is retransmitted to the authentication server. When the authentication server confirms the authentication request corresponding to the authentication request received by the user apparatus 20 by sending the request, the user can be informed whether the authentication is started or not.

Here, the specific number (Q) refers to information capable of identifying a user apparatus in which an authentication apparatus is installed, and there is no need to be construed as limiting.

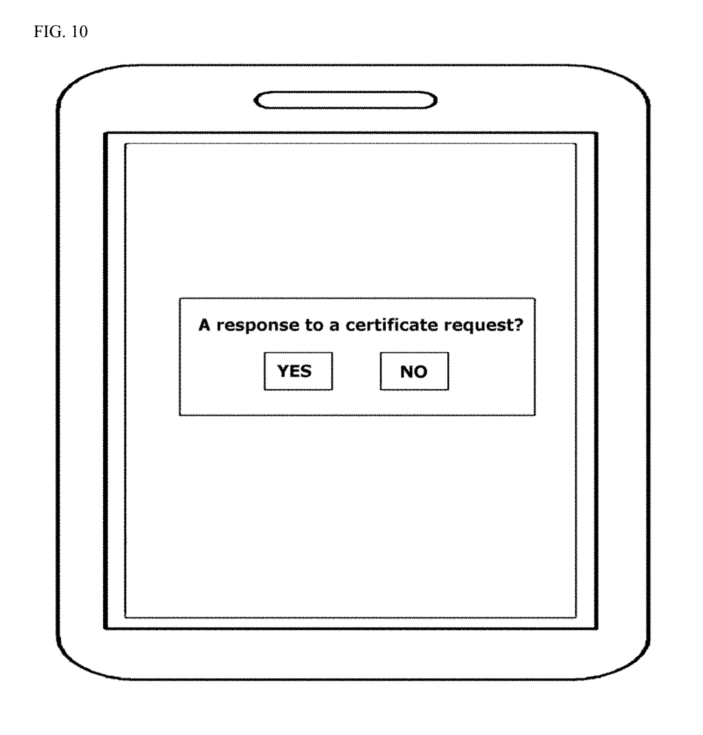

FIG. 10 illustrates an exemplary embodiment of a message of authentication request.

The authentication apparatus 10 of the user apparatus (e.g., cellular phone 20) can receive a message for confirming the authentication request transmitted from the authentication server and output it to the terminal screen. On the other hand, the user can select approval or rejection on the message being output on the terminal screen.

When the user selects approval, the authentication apparatus 10 of the user apparatus 20 (for example, the mobile phone 20) extracts specific usage information of a predetermined reference from the entire usage information of the user device 20, After encrypting the usage information, the encrypted authentication usage information can be transmitted to the authentication server in response to the authentication confirmation request.

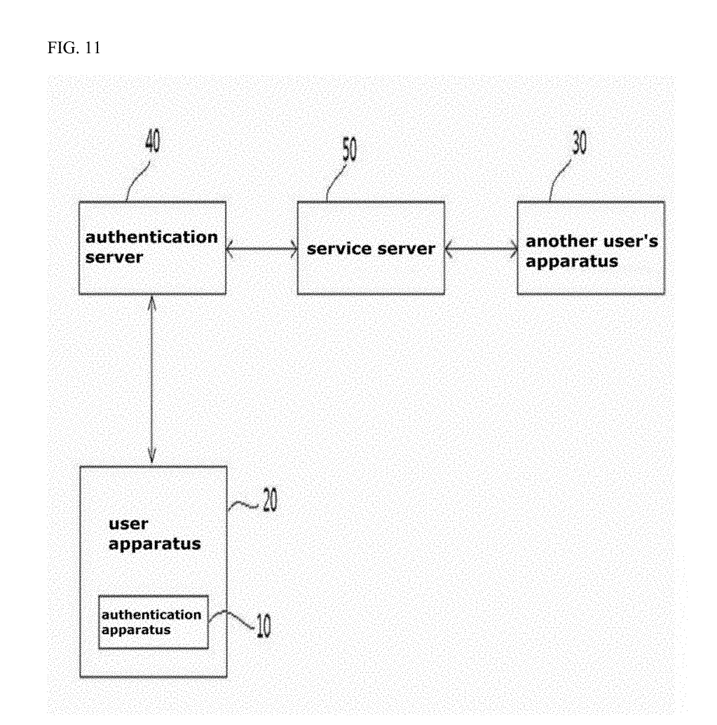

FIG. 11 is a detailed block diagram specifically illustrating an authentication system according to one embodiment of the present inventive concept.

Referring to FIG. 11, the authentication system includes an authentication server 40, a service server 50, another user apparatus (e.g., PC 30), a user apparatus (e.g., mobile phone 20), and an authentication apparatus (10).

For example, when a user connects to a service server 50 providing a shopping service using another user's apparatus (e.g., PC 30), the user may use the authentication service of the present invention. The authentication request may be requested on the service connection screen. Thereafter, the service server 50 transmits an authentication request of the user request to the authentication server 40, and the authentication server 40 transmits an authentication confirmation request corresponding to the received authentication request to the user apparatus 20 using the specific number of the user apparatus 20. Thereafter, when the user inputs approval approval to the authentication confirmation request message output on the terminal screen of the user apparatus 20, the authentication apparatus 10 included in the user apparatus 20 or connected to the user apparatus 20 extracts the specific usage information of the user apparatus 20, encrypts the extracted specific usage information, and transmits the encrypted authentication usage information to the authentication server 40. Then, the authentication server 40 decrypts the received encrypted authentication usage information, compares the decrypted authentication usage information with the authentication information being registered, and generates an authentication result. The authentication server 40 provides the generated authentication result to the service server 50).

The service server 50 completes the payment through the user authentication step according to the authentication result provided.

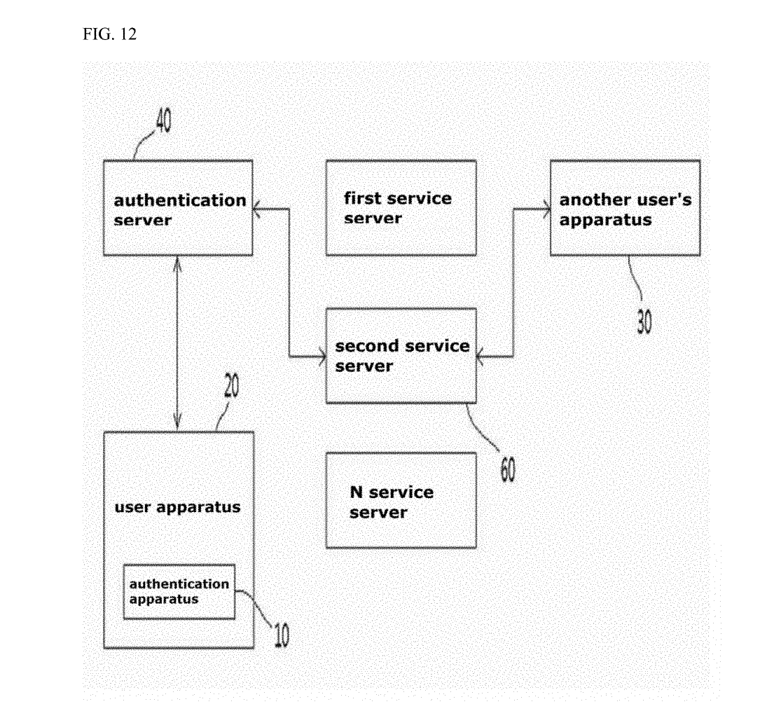

FIG. 12 is a detailed block diagram specifically illustrating an authentication system according to another embodiment of the present inventive concept.

As shown in FIG. 12, the authentication system includes an authentication server 40, a plurality of service servers, another user apparatus (e.g., a PC 30), a user apparatus (e.g., a mobile phone 20), and an authentication apparatus (10). That is, a plurality of service servers perform user authentication through the authentication service of the present invention, and other user apparatus (e.g., a PC 30) accesses one of a plurality of service servers 60, and may request the authentication service of the present invention.

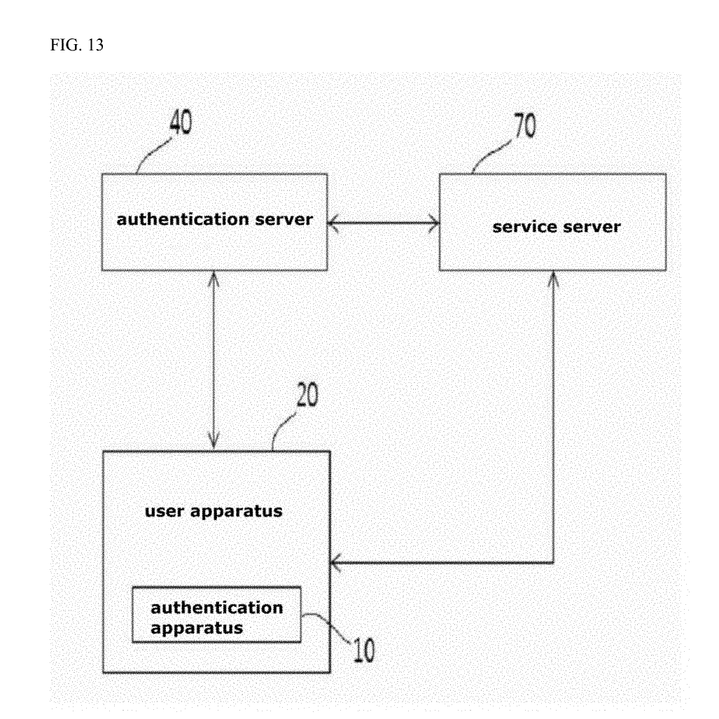

FIG. 13 is a detailed block diagram specifically illustrating an authentication system according to another embodiment of the present inventive concept.

As shown in FIG. 13, the authentication system may include an authentication server 40, a service server 70, a user apparatus (e.g., cellular phone 20), and an authentication apparatus 10 when the user uses a service on the mobile.

For example, when a user connects to a service server 70 that provides a shopping service for mobile using a user apparatus (e.g., mobile phone 20), when the user authenticates at the payment step, the authentication service of the present invention is used a request for authentication can be requested on the mobile service connection screen. Thereafter, the service server 70 transmits an authentication request of the user request to the authentication server 40, and an authentication confirmation request corresponding to the authentication request received by the authentication server 40 is transmitted to the user apparatus 20 specified by a specific number of the user apparatus 20. Thereafter, when the user inputs approval approval to the authentication confirmation request message output on the terminal screen of the user device 20, the authentication apparatus 10 included in the user apparatus 20 or connected to the user apparatus 20 extracts the specific usage information of the user apparatus 20, encrypts the extracted specific usage information, and transmits the encrypted authentication usage information to the authentication server 40. Then, the authentication server 40 decrypts the received encrypted authentication usage information, compares the decrypted authentication usage information with the authentication information being registered, and generates an authentication result. The authentication server (40) provides the generated authentication result to the service server (70).

The service server 70 completes the payment through the user authentication step according to the provided authentication result.

Here, it is also possible to further input a password in order to prevent the user from habitually accepting the authentication confirmation request. Here, the password can be configured in a simple form such as a four-digit password.

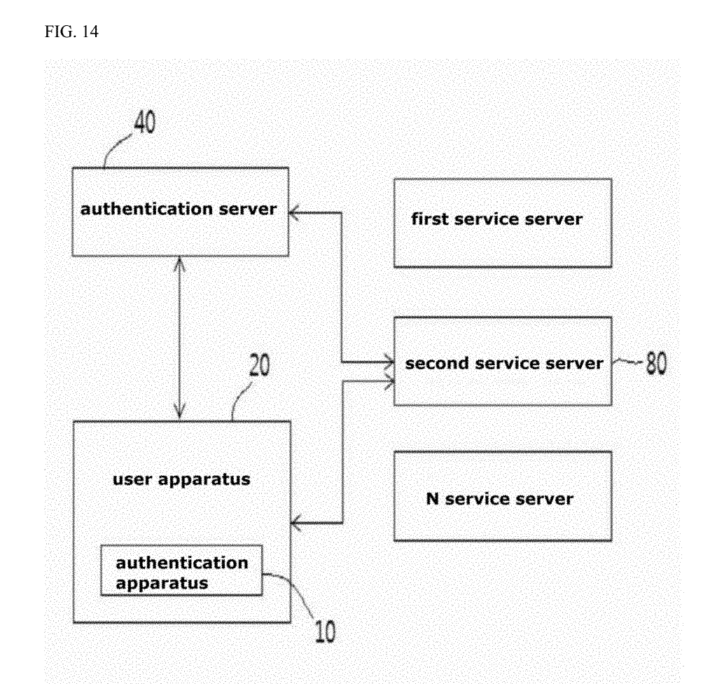

FIG. 14 is a detailed block diagram specifically illustrating an authentication system according to another embodiment of the present inventive concept.

As shown in FIG. 14, The authentication system may include an authentication server 40, a plurality of service servers, a user apparatus (e.g., cellular phone 20), and an authentication apparatus 10 when the user uses a service on the mobile. That is, a plurality of service servers perform user authentication through the authentication service of the present invention. A user apparatus (e.g., cellular phone 20) accesses any one of a plurality of service servers 80, and may request the authentication service of the present invention.

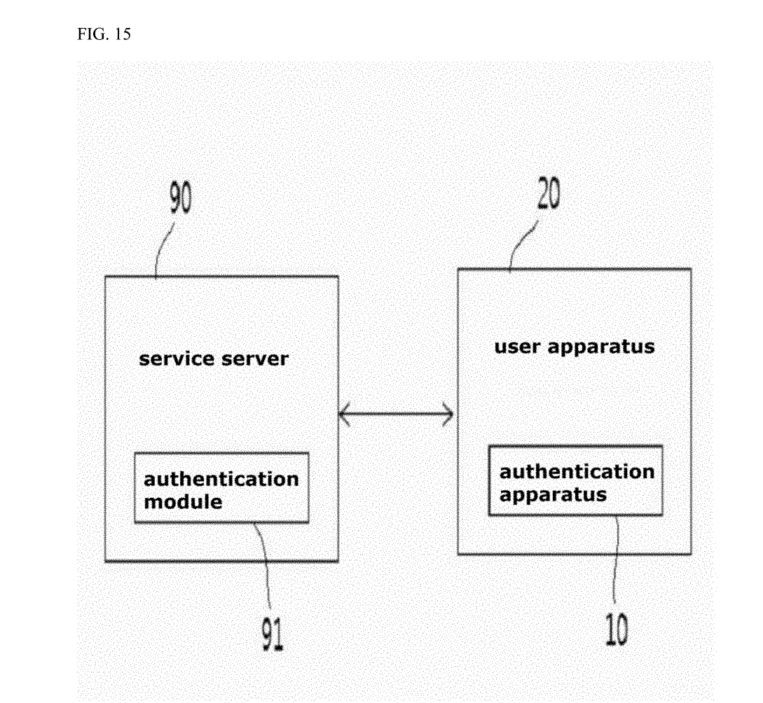

FIG. 15 is a detailed block diagram specifically illustrating an authentication system according to another embodiment of the present inventive concept.

As shown in FIG. 15, it is possible to provide the authentication service of the present invention independently without connecting to the authentication server 40 by further including the authentication module 91 that can execute the authentication of the present invention in the service server 90.

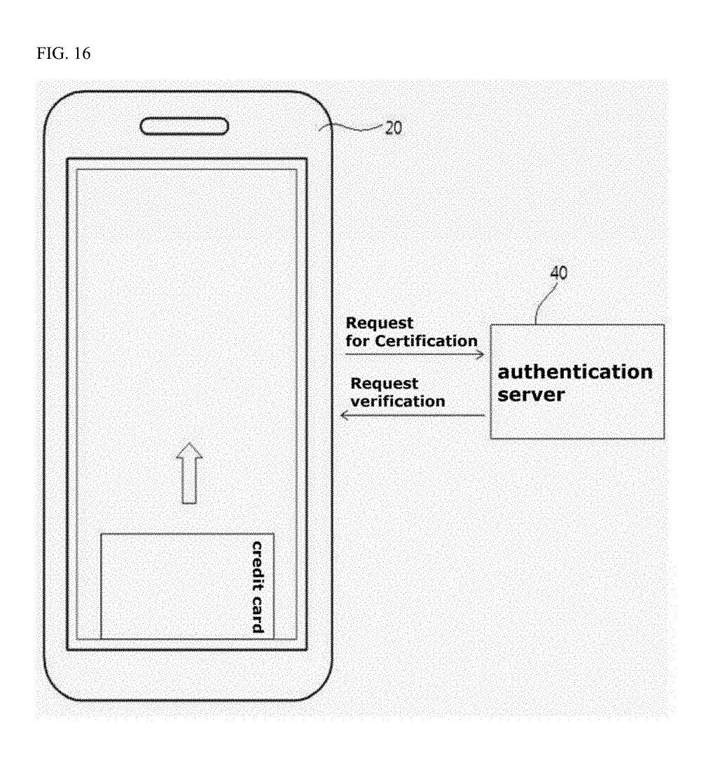

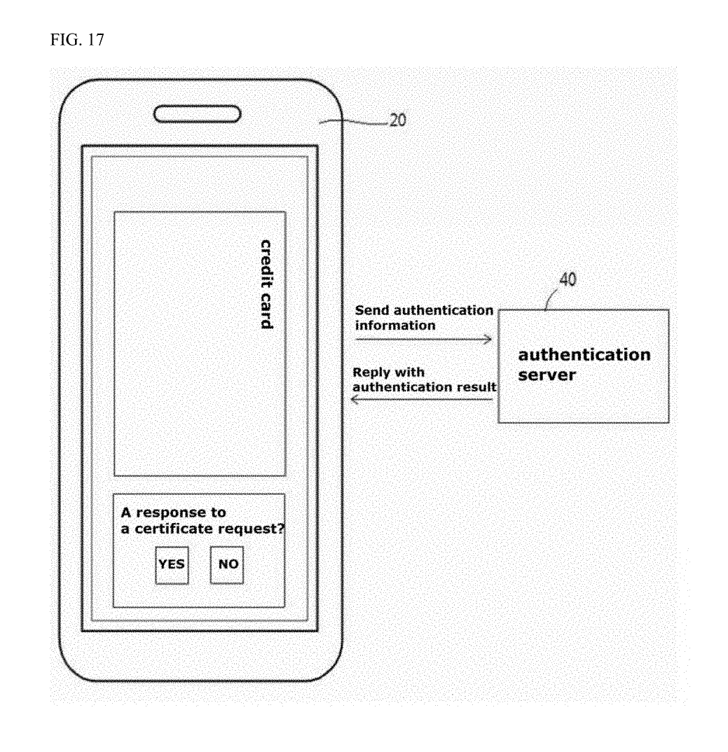

FIG. 16 is a detailed block diagram specifically illustrating an authentication system according to another embodiment of the present inventive concept, FIG. 17 is a detailed block diagram specifically illustrating an authentication system of FIG. 16.

As shown in FIG. 16 and FIG. 17, the authentication service of the present invention is also capable of user authentication even when payment is made through the user apparatus 20 in the off-line store.

The user can select any one of the registration cards as a payment means in the offline store at the user apparatus (e.g., cellular phone 20). For example, when a screen is swept upward from the bottom of the terminal screen of the user apparatus (e.g., cellular phone 20), one of the registration cards is selected and moved to the center of the screen. At this time, the authentication apparatus 10 included in the user apparatus (e.g., cellular phone 20) receives the selection of the registration card as an instruction of the authentication request, and sends an authentication request to the authentication server 40.

Then, the authentication server 40 transmits an authentication confirmation request corresponding to the received authentication request to the user apparatus 20 through the specific number of the user apparatus 20 received together with the authentication request.

The authentication apparatus 10 of the user apparatus 20 outputs a message of the received authentication confirmation request to the terminal screen so that the user can confirm whether or not the authentication is started.

If the user selects approval from the approval or rejection of the message, the authentication apparatus 10 of the user apparatus 20 extracts specific usage information of the user apparatus 20, encrypts the extracted usage information, and transmits the encrypted authentication usage information to the authentication server 40.

Thereafter, the authentication server 40 decrypts the received encrypted authentication usage information, compares the decrypted authentication usage information with the authentication information being registered, generates an authentication result, and transmits the generated authentication result to authentication apparatus 10 of the user apparatus 20.

Upon receiving the authentication result, the authentication apparatus 10 of the user apparatus 20 transmits the authentication completion to the corresponding payment program of the user apparatus 20, and the payment program can use the selected registration card in the offline store.

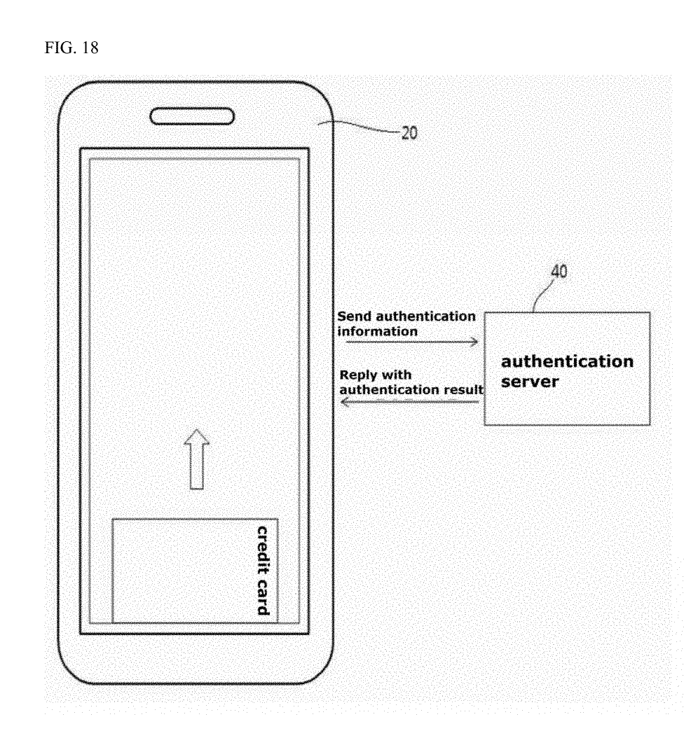

FIG. 18 is a detailed block diagram specifically illustrating an authentication system according to another embodiment of the present inventive concept.

As shown in FIG. 18, by touching and raising the screen from the bottom of the terminal screen of the user apparatus (for example, mobile phone 20), one registration card is selected and moved to the center of the screen. At this time, the authentication apparatus 10 included in the user apparatus (for example, the cellular phone 20) receives the selection of the registration card as an instruction for approval for the authentication request and authentication confirmation request, extracts the specific usage information extracted, encrypts the extracted specific usage information, and transmits the encrypted authentication usage information to the authentication server together with the authentication request.

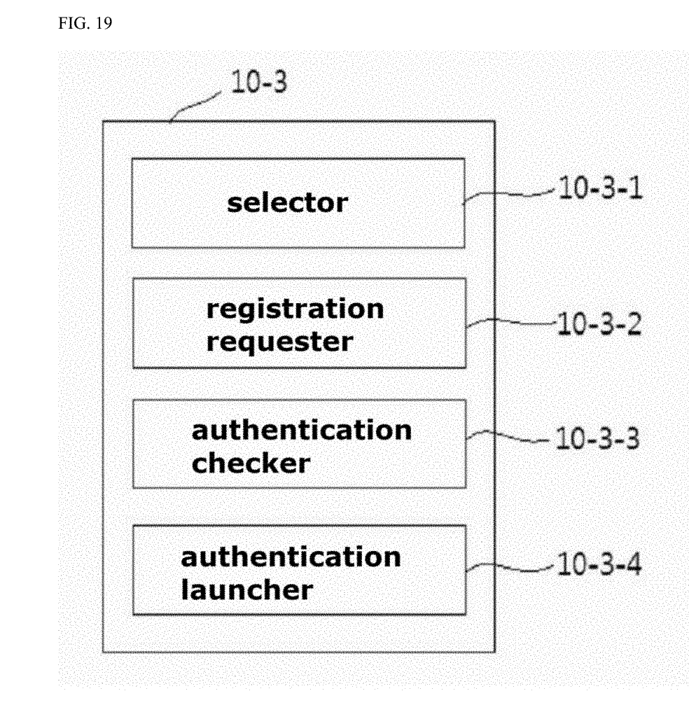

FIG. 19 is a block diagram illustrating an authentication apparatus according to another embodiment of the present inventive concept.

As shown in FIG. 19, the authentication apparatus 10-3 includes a registration requester 10-3-2, an authentication checker 10-3-3, an authentication launcher 10-3-4, and a selector 10-3-1).

Here, the selector 10-3-1 supports the user to select at least one of the category and the size of the authentication information and the usage information to be used.

The category of the usable information selectable by the user may be a call history as usage information for registering with the authentication information, and may be limited to a specific user (e.g., the user himself or another user designated by the user) among the call history, it may mean distinguishable classification such as outgoing call history or incoming call history in the call history.

The size of the usable information that can be selected by the user means that the usability information for registering with the authentication information includes three pieces of usage information such as the first usage information to the third usage information, the number of pieces of usage information can be changed, for example, by including only one piece of usage information, or the memory capacity of usage information that can be registered with the authentication information.

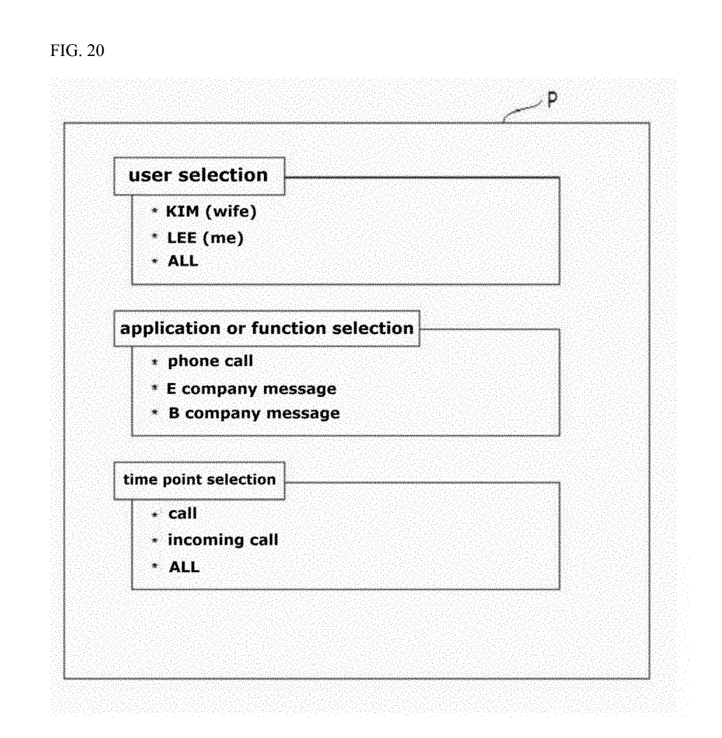

FIG. 20 illustrates an exemplary embodiment of a screen on which a selector of FIG. 19 is executed.

As shown in FIG. 20, the selector 10-3-1 may be configured with a selection menu P such as a user selection, an application or function selection, and a view selection.

That is, in the selection menu P, the user selects a wife from the user selection menu, selects a phone call, a company message, and an E company message from the application or function menu, and can be select a call or an incoming call from the time point selection menu.

In this case, the usage information of the user apparatus 20 is changed every time the phone call, the B message, and the E message are transmitted or received from the wife. The authentication information registration based on the changed usage information can be executed. Therefore, in this case, the wife of the user can be regarded as a helper for changing the authentication information of the user device at any time.

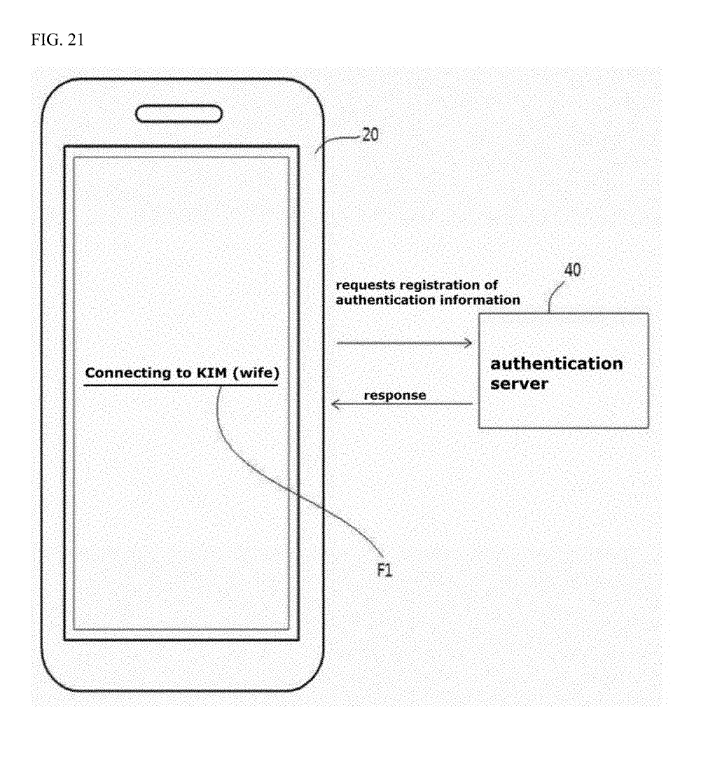

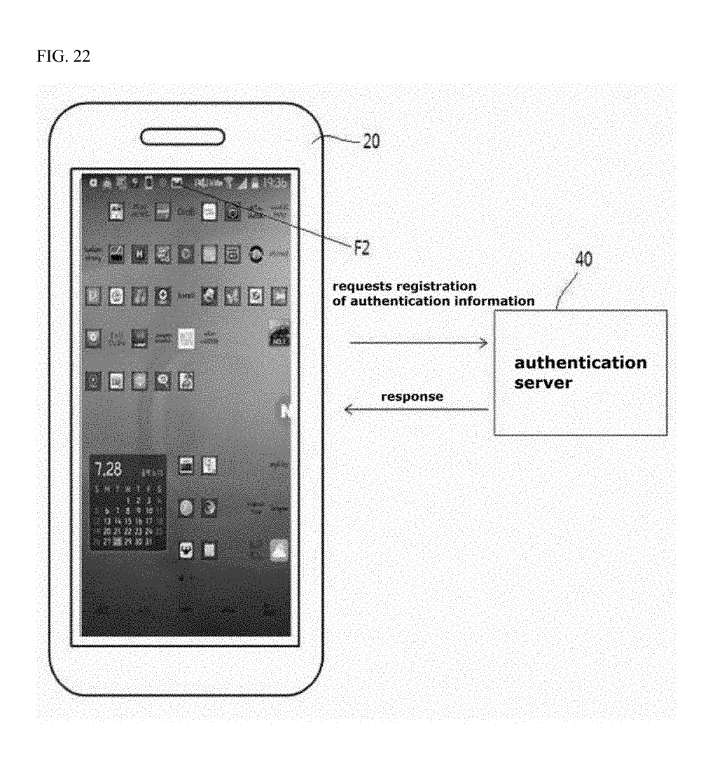

FIG. 21 illustrates an exemplary embodiment of registration of authentication information through the authentication apparatus of FIG. 19, and FIG. 22 illustrates another exemplary embodiment of registration of authentication information through the authentication apparatus of FIG. 19.

As shown in FIG. 21, when making a call to the user's wife KIM, the user apparatus 20 requests the authentication server 40 to register the authentication information through the use of the registration request usage information including the addition of the usage information (F1) for calling the KIM. Thereafter, as the user apparatus 20 receives the response from the authentication server 40, the authentication information registration process can be completed.

Also, as shown in FIG. 22, the authentication server 40 requests the authentication server 40 to register the authentication information through the registration request usage information including the usage information F2 from which the user has received the text message. Thereafter, as the user apparatus 20 receives the response from the authentication server 40, the authentication information registration process can be completed.

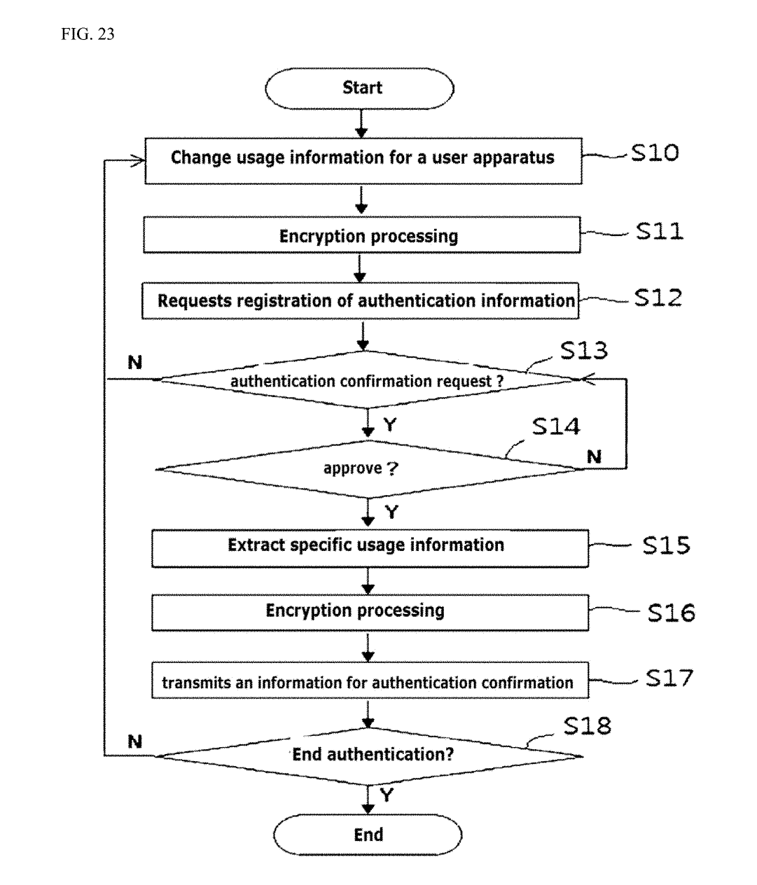

FIG. 23 is a flow chart illustrating an exemplary embodiment of an operation process of an authentication apparatus of the present inventive concept.

As shown in FIG. 23, the authentication apparatus 10 encrypts the registration request usage information including the changed usage information when the usage information of the user apparatus 20 is changed by a user's input or changed to a factor other than the user's input, and requests the authentication server 40 to register the usage information as the authentication information (S10 to S12).

Thereafter, when the user requests the authentication service of the present invention while using a specific service, the authentication apparatus 10 included in the user apparatus 20 receives an authentication confirmation request for confirming whether the authentication of the user is initiated or not (S13).

A message of the authentication confirmation request received in the step S13 is outputted to the terminal screen of the user apparatus 20 and the authentication process can be continued by selecting approval among approval or rejection (S14).

Then, the authentication apparatus 10 extracts specific usage information of a predetermined reference (S15), encrypts the extracted specific usage information, and transmits the encrypted authentication usage information to the authentication server 40 (S16 and S17).

Thereafter, when the authentication function of the user apparatus 20 is terminated, execution of the steps is also ended (S18).

Each of the steps of the authentication process may be implemented as a computer program stored on a recording medium in combination with the authentication apparatus 10 or a computer readable medium including instructions for executing the above steps when executed by the authentication apparatus 10.

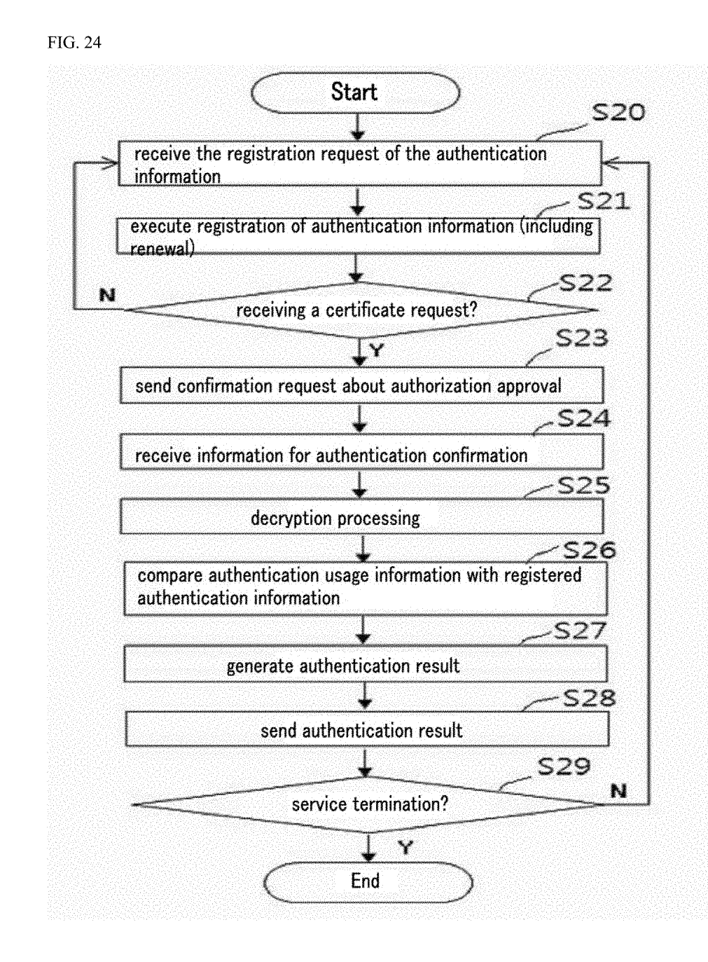

FIG. 24 is a flow chart illustrating an exemplary embodiment of an operation process of an authentication server of the present inventive concept.

As shown in FIG. 24, The authentication server 40 may receive the registration request of the authentication information based on the changed usage information included in the user apparatus 20 or from the connected authentication apparatus 10 (S20). At this time, in order for the authentication server 40 to register the authentication information based on the changed usage information, the authentication server 40 may proceed after the registration procedure for using the authentication service of the present invention has been performed in advance. The subscription procedure may be performed in accordance with a normal service subscription procedure.

Thereafter, the authentication information is registered according to the registration request received in step S20 (S21). Here, registration is a concept that includes registration of the first authentication information or updating of already registered authentication information.

Thereafter, when the user requests the authentication service of the present invention while using a specific service, the user can receive the authentication request received from the service server providing the specific service (S22).

Then, the authentication server 40 specifies the user apparatus 20 through the specific number received together with the authentication request, and transmits an authentication confirmation request to the user apparatus 20 so that the user can confirm whether or not the authentication is started (S23).

Thereafter, the authentication server 40 receives the specific usage information of the user apparatus 20 from the authentication apparatus 10 of the user apparatus 20 in an encrypted state (S24).

The encrypted authentication usage information received in step S24 is decrypted (S25).

Thereafter, the authentication usage information decrypted in step S25 is compared with the registered authentication information (S26).

The authentication result is generated based on the comparison result in step S26 (S27), and the authentication result generated in step S27 is provided to the service server 70, 80 or 90 (S28).

Thereafter, when the authentication service is terminated, the execution of the above steps is also ended (S29).

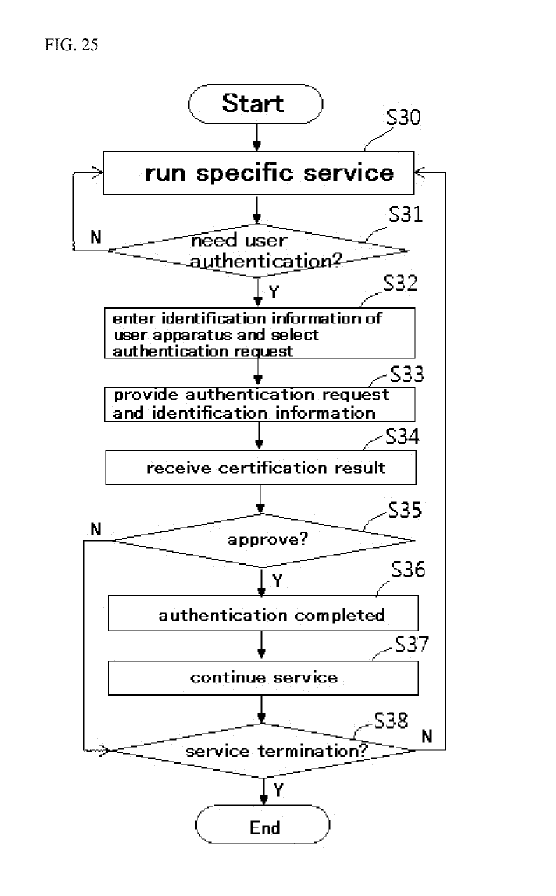

FIG. 25 is a flow chart illustrating an exemplary embodiment of an operation process of an service server of the present inventive concept.

As shown in FIG. 25, The service server (50 or 60) executes a specific service such as a payment service in response to another user apparatus (e.g., a PC) (S30).

If the specific service executed in step S30 requires user authentication, the user is guided through the service connection screen (S31).

After the user receives the service guidance in step S31, a specific number (e.g., a telephone number) and an authentication request of the user apparatus for user authentication are input to the service connection screen (S32).

The service server (50 or 60) provides the authentication request and the specific number received in step S32 to the authentication server (S33).

Thereafter, when the authentication result is received as the execution of the authentication server 40 (S34), the service is continued according to the received authentication result (S35 to S37).

Thereafter, when the user's use of the service is terminated, the execution of the steps is also terminated (S38).

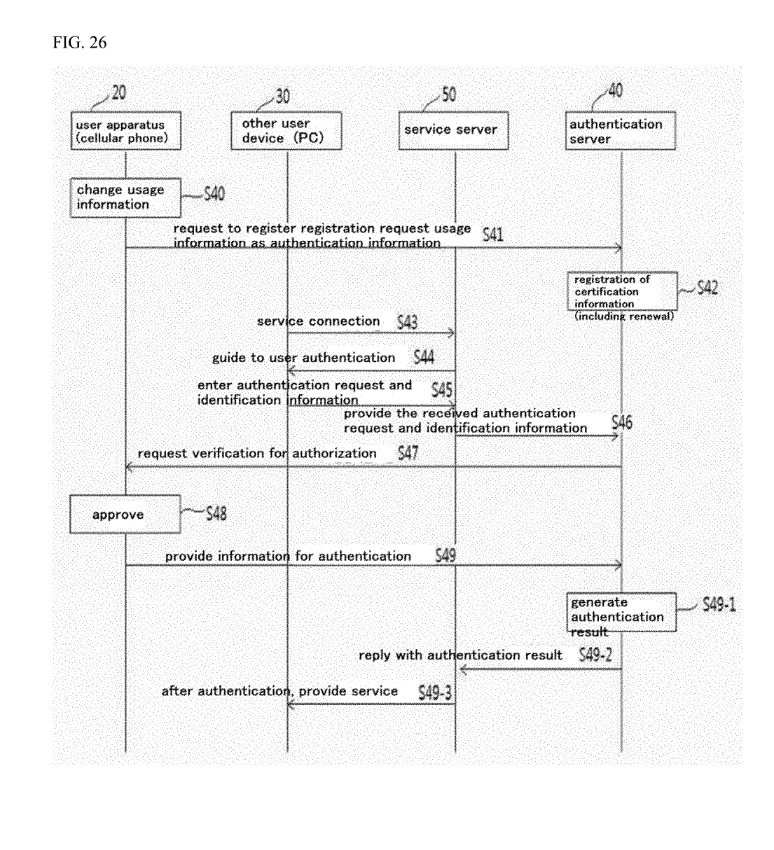

FIG. 26 is a flow chart illustrating an exemplary embodiment of a payment service to which an authentication system of the present invention is applied

As shown in FIG. 26, the authentication apparatus 10 included in the user apparatus 20 can be configured such that when the usage information of the user apparatus 20 is changed by a user's input or changed to a factor other than the user's input (S40) The registration request usage information is encrypted and the encrypted registration request usage information is registered as the authentication information in the authentication server 40 (S41).

In step S42, the authentication server 40 checks the existing subscription history according to the registration request received in step S41 and registers the encrypted registration request usage information as authentication information. Here, registration is a concept that includes registration of the first authentication information or updating of already registered authentication information.

Thereafter, when the user requests the authentication service of the present invention while using a specific web service through another user device (PC 30) (S45), the authentication server 40 transmits the authentication service to the service server and receives the authentication request and the telephone number from the server 50 (S46).

Then, the authentication server 40 transmits an authentication confirmation request to the user apparatus 20 together with the authentication request to allow the user to confirm whether or not the authentication is started (S47).

Thereafter, if there is a user approval input for the authentication confirmation request message in the authentication apparatus 10 included in the user apparatus 20 (S48), the specific usage information of the user apparatus 20 is extracted, and transmits the encrypted authentication usage information to the authentication server 40 (S49).

The authentication server 40 decrypts the received encrypted authentication usage information, and generates an authentication result based on a result of comparing the decrypted authentication usage information and the registered authentication information (S49-1).

Then, the authentication server 40 provides the authentication result generated in step S49-1 to the service server 50 (S49-2).

Thereafter, the service server 50 provides the service, which can be provided after authentication, to another user apparatus (PC) 30 (S49-3).

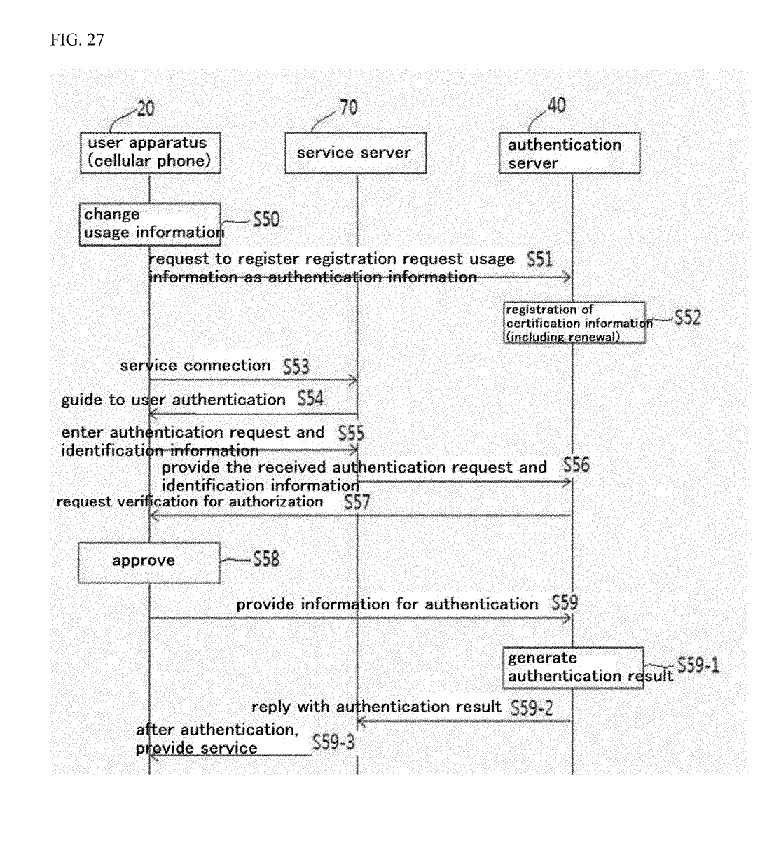

FIG. 27 is a flow chart illustrating another exemplary embodiment of a payment service to which an authentication system of the present invention is applied.

As shown in FIG. 27, when the usage information of the user apparatus is changed by a user's input or changed to a factor other than the user's input (S50), the authentication apparatus 10 included in the user apparatus 20 uses the registration request including the changed usage information and requests the authentication server 40 to register the encrypted registration request usage information as authentication information (S51).

In response to the registration request received in step S51, the authentication server 40 confirms the existing subscription history and registers the encrypted registration request usage information as authentication information (S52). Here, registration is a concept that includes registration of the first authentication information or updating of already registered authentication information.

Thereafter, when the user requests the authentication service of the present invention (S53 and S54) while using a specific mobile service through a user apparatus (e.g., mobile phone 20), the authentication server 40 receives the authentication request and the telephone number from the service server 70 (S55 and S56).

Then, the authentication server 40 transmits an authentication confirmation request for allowing the user to confirm whether or not the authentication is started, to the user device 20 using the received telephone number together with the authentication request (S57).

Thereafter, when there is a user approval input for the message of the authentication confirmation request received in the authentication apparatus 10 included in the user apparatus 20 (S58), the specific usage information of the user apparatus 20 is extracted, and transmits the encrypted authentication usage information to the authentication server 40 (S59).

The authentication server 40 decrypts the received encrypted authentication usage information, and generates an authentication result based on a result of comparing the decrypted authentication usage information and the registered authentication information (S59-1).

Thereafter, the authentication server 40 provides the authentication result generated in step S59-1 to the service server 70 (S59-2).

Thereafter, the service server 70 provides the service that can be provided after authentication to the user apparatus (e.g., mobile phone 20) (S59-3).

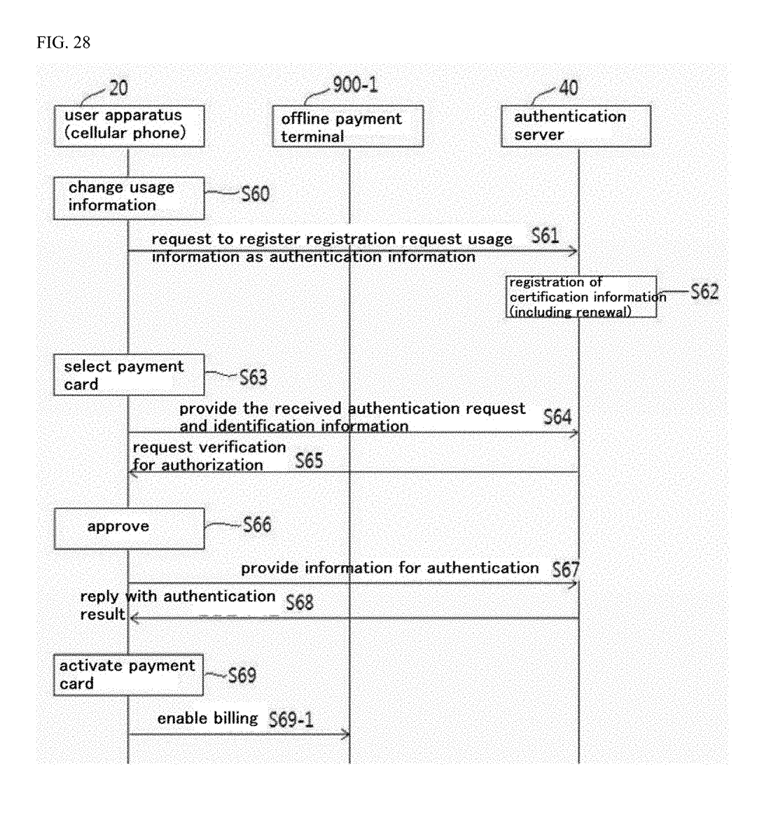

FIG. 28 is a flow chart illustrating another exemplary embodiment of a payment service to which an authentication system of the present invention is applied.

As shown in FIG. 28, the authentication device 10 included in the user device 20 is configured such that when the usage information of the user device 20 is changed by a user's input or changed to a factor other than the user's input (S60), encrypts the registration request usage information, and requests the authentication server 40 to register the encrypted registration request usage information as authentication information (S61).

In response to the registration request received in step S61, the authentication server 40 confirms the existing subscription history and registers the encrypted registration request usage information as authentication information (S62). Here, registration is a concept that includes registration of the first authentication information or updating of already registered authentication information.

Thereafter, the user can select any one registration card for payment in the offline store at the user apparatus (e.g., mobile phone 20) (S63).

The authentication apparatus 10 included in the user apparatus 20 receives the registration card selection of the step S63 as an instruction of the authentication request and sends an authentication request to the authentication server 40 and a telephone number of the user apparatus 20 (S64).

Thereafter, the authentication server 40 transmits an authentication confirmation request for allowing the user to confirm whether or not the authentication is started, to the user apparatus 20 through the received telephone number together with the authentication request (S65).

Thereafter, when there is a user approval input for the message of the authentication confirmation request received in the authentication apparatus 10 included in the user apparatus 20 (S66), the specific usage information of the user apparatus 20 is extracted, encrypts the usage information, and transmits the encrypted authentication usage information to the authentication server 40 (S67).

The authentication server 40 decrypts the received encrypted authentication usage information, generates an authentication result based on a result of comparing the decrypted authentication usage information with the registered authentication information, and transmits the generated authentication result to the user apparatus 10 (S68).

Thereafter, when the authentication result is normal authentication, the selected registration card is activated in a usable state (S69). In step S69, the user apparatus 20 is connected to the off-line payment terminal, (S69-1).

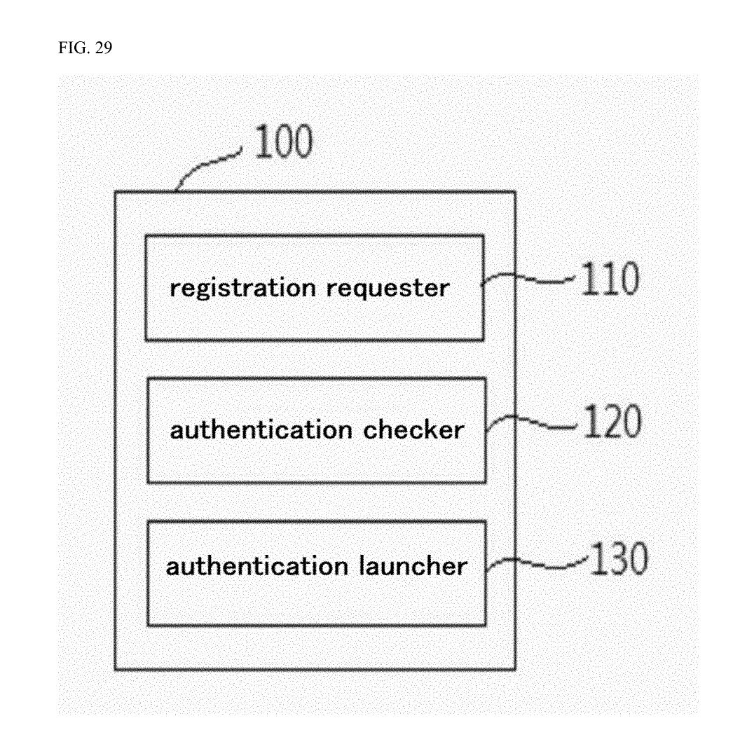

FIG. 29 is a block diagram illustrating an authentication apparatus according to another embodiment of the present inventive concept.

As shown in FIG. 29, the authentication apparatus 100 of the present invention can also perform user authentication based on screen information change of the user apparatus 200.

When the screen information displayed on the specific screen of the user apparatus is changed by a user's input (Example: When the user installs the E-company web toon viewing application on his/her mobile phone, the icon corresponding to the background screen of the mobile phone is added, and the arrangement information for the application on the background screen is changed) or other factors other than the input of the user (Example: When a received text message is received on a user's mobile phone, a notification for notifying the reception of an incoming text message is added to the wallpaper of the mobile phone, thereby changing the notification history information of the wallpaper), the authentication apparatus 100 of the present invention includes a configuration for encrypting changed screen information, registering encrypted change screen information as authentication information, updating already registered authentication information, and performing user authentication on the basis of the updated authentication information.

Specifically, an authentication apparatus 100 comprising a registration requester 110 which requests registration of authentication information based on a changed information if at least one of the screen information displayed on a specific screen of an user apparatus 200 is changed by an user's input or is changed to a factor other than the input of the user, an authentication checker 120 which receives an authentication confirmation request from a network connected to the user apparatus 200 and an authentication launcher 130 which transmits an information for authentication confirmation based on at least one of the screen information to the network in response to the authentication confirmation request in correspondence with the changed information.

The specific screen of the user apparatus 200 may be a screen mainly used by the user when the user apparatus 200 is used. For example, when the user apparatus 200 is a smart phone, and the background image of the smartphone which is the main operation screen where various applications are located.

The registration requester 110 encrypts the changed screen information and registers the encrypted change screen information as authentication information in an authentication server (not shown) when the screen information on the specific screen of the user apparatus 200 is changed request. Here, the registration request includes not only requesting the initial registration but also requesting to update the already registered authentication information.

In addition, when the screen information for the specific screen of the user apparatus 200 is changed, the changed screen information is encrypted and the encrypted change screen information is requested to be registered as the authentication information. This means that the screen information for the specific screen of the user apparatus 200 (Not shown) every time the authentication information is changed.

The screen information includes arrangement information, notification detail information, background image or combination information for at least one application of a specific screen, and information to be included in the screen information can be selected according to the authentication level.

For example, when the authentication level is high, such as a financial service, the screen information includes both the arrangement information, the notification detail information, and the background image for at least one application of the specific screen, thereby expanding the parameters for changing the authentication information it is possible.

On the other hand, when the authentication level is ‘medium’ as in the search service, the screen information may be included as array information or notification history information for at least one application on a specific screen, and parameters for changing the authentication information may be set to be reduced have.

Preferably, the authentication level is maintained at a high level for all services connectable via the user apparatus 200.

The registration requester 110 includes a configuration for detecting whether the screen information displayed on the specific screen of the user device 200 is changed by a user's input or is changed to a factor other than the user's input, and requests the registration of the authentication information based on the change screen information.

Although it is possible to change the authentication information automatically as described above, when the authentication information is to be changed artificially more frequently from the user's point of view, an arbitrary application icon arranged in a specific screen of the user apparatus 200 it is also possible to automatically change the authentication information by performing unnecessary application deletion frequently on a specific screen or deliberately sending a security message to another user.

The authentication checker 120 receives an authentication confirmation request from the network connected to the user apparatus 200.

For example, when a user uses a shopping service using another user apparatus (e.g., a PC, not shown), the authentication service of the present invention can be used at the payment step of the shopping service in use. At this time, the user inputs a specific number (e.g., telephone number) of a user apparatus (e.g., mobile phone 200) including the authentication apparatus 100 in the payment step of the shopping service, and then clicks an authentication request, In a state where a specific number (e.g., a telephone number) of a user apparatus (e.g., mobile phone 200) including the apparatus 100 is input, if the authentication request is only clicked, the service server (not shown) (Not shown), and an authentication server (not shown) transmits an authentication confirmation request corresponding to the received authentication request to the user apparatus (e.g., mobile phone 200). Then, the user apparatus (e.g., mobile phone 200) receives the received authentication confirmation request as a message and outputs the received message to the terminal screen so that the user can confirm the received message, thereby allowing the user to recognize the authentication progress status.

In the above example, when the user performs one-touch input for authentication approval, the authentication launcher extracts screen information displayed on a specific screen of the user apparatus 200, encrypts the extracted screen information, the information can be transmitted to the authentication server (not shown) via the network in response to the authentication confirmation request.

As another example, when a user uses a payment service in an offline store using a user apparatus (e.g., mobile phone, 200), one of the menus of the user apparatus (e.g., mobile phone 200). At this time, according to the selection of the registration card, the authentication apparatus 100 included in the user apparatus (for example, the mobile phone 200) automatically requests the authentication server (not shown) for authentication, can transmit encrypted screen information for a specific screen of the user apparatus (for example, the mobile phone 200). That is, when the registration card is selected, the authentication apparatus 100 in this case receives the authentication confirmation request from the application for payment in the off-line store, and in response to the received authentication confirmation request, it is possible to immediately transmit the authentication request to the authentication server (not shown) and the encrypted screen information for the specific screen of the user apparatus (e.g., the mobile phone 200) without going through the user verification process.

The network referred to in the present invention is a term including both an external network for connecting the user apparatus 200 to an external server and an internal network for communication between the user apparatus 200 and the authentication apparatus 100. The external network includes a network that is changed according to the location of the user apparatus 200. The external network is connected to a network connected to an authentication server (not shown). The networks may be the same or different. The network in which the authentication apparatus 100 receives the authentication confirmation request is also a network having the same contents as described above.

The registration requester 110 encrypts the change screen information, and the authentication checker 130 encrypts the extracted screen information.

At this time, at least one of the registration requester 110 and the authentication launcher 130 can encrypt the public key using a decryption key using a prime number greater than a predetermined number of digits.

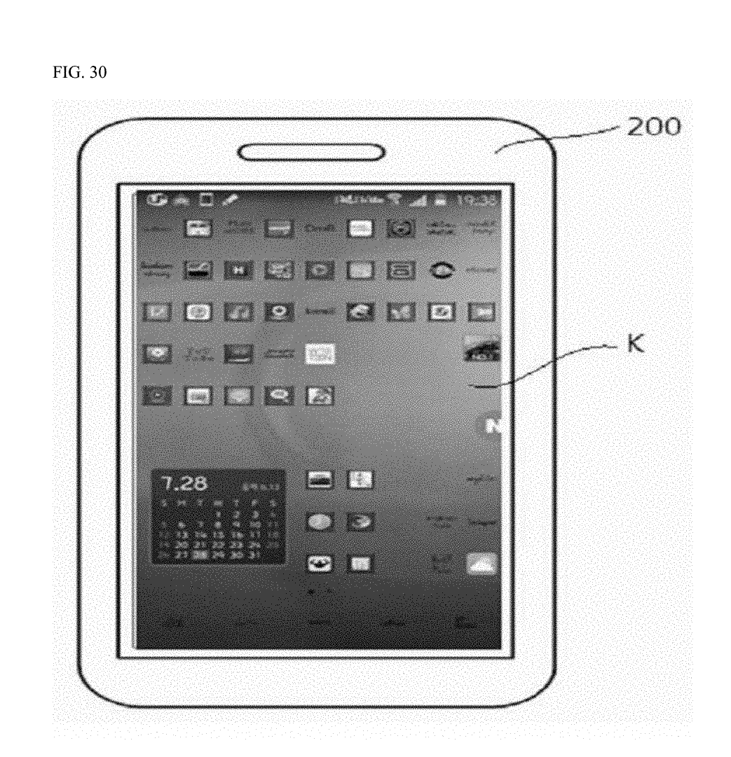

FIG. 30 illustrates an exemplary embodiment of a specific screen of a user apparatus on which an authentication apparatus of FIG. 29 is applied.

As shown in FIG. 30, The specific screen of the user apparatus 200 can be set as the background screen K which is the main control screen frequently accessed by the user. In the background screen K, a plurality of applications are arranged.

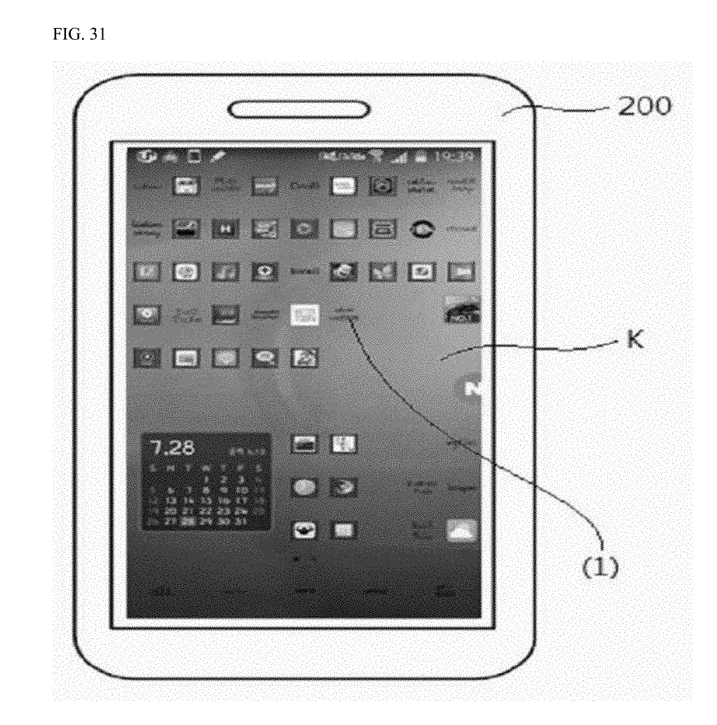

FIG. 31 illustrates another exemplary embodiment of a specific screen of a user apparatus on which an authentication apparatus of FIG. 29 is applied.

As shown in FIG. 31, The new application 1 can be added by the user's input to the specific screen K of the reference shown in FIG. 30. In this case, the addition of the new application 1 means that the arrangement information for at least one application of the specific screen K is changed. At this time, the authentication apparatus 100 detects the change of the screen information, and then proceeds to register the authentication information based on the changed screen information.

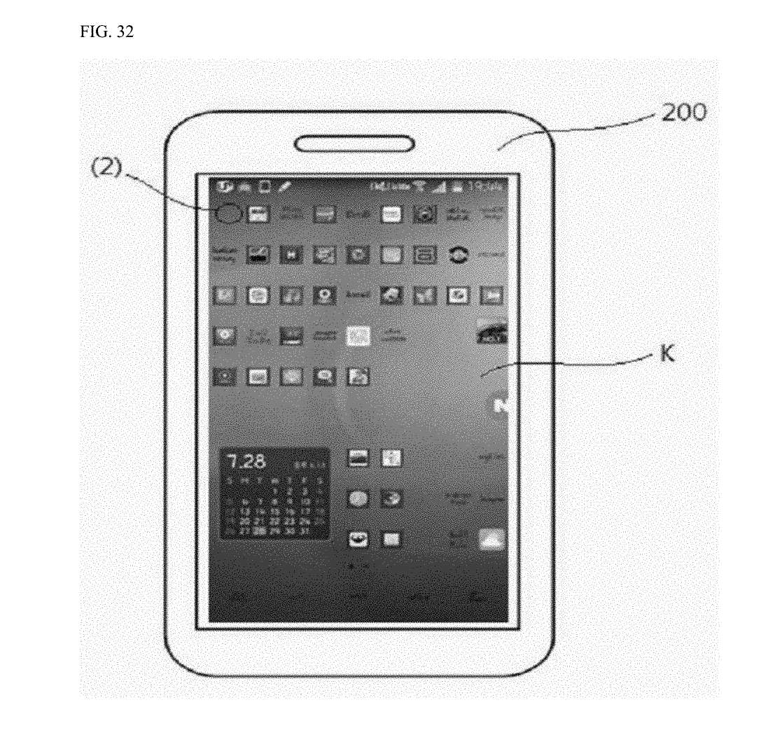

FIG. 32 illustrates another exemplary embodiment of a specific screen of a user apparatus on which an authentication apparatus of FIG. 29 is applied.

As shown in FIG. 32, an application 2 can be deleted by the user's input on the specific screen K of the reference shown in FIG. 31.

In this case, the deletion of the existing application 2 from the specific screen K means that the arrangement information for at least one application of the specific screen K is changed. At this time, the authentication apparatus 100 detects the change of the screen information, and then proceeds to register the authentication information based on the changed screen information.

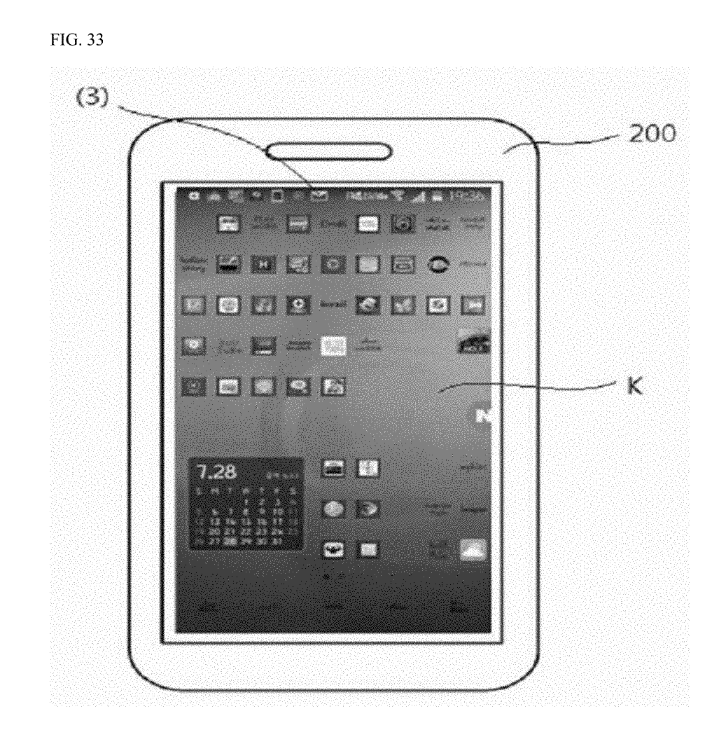

FIG. 33 illustrates another exemplary embodiment of a specific screen of a user apparatus on which an authentication apparatus of FIG. 29 is applied.

As shown in FIG. 33, a notification history 3 informing that an email sent by another user has been received as a factor other than the user's input in the existing specific screen K shown in FIG. 32 can be displayed at the top of the specific screen K.

As in this case, reception of new mail means that the notification history information displayed on the specific screen K is changed. At this time, the authentication apparatus senses the change of the screen information according to the change of the notification history information, and then proceeds to register the authentication information change based on the changed screen information.

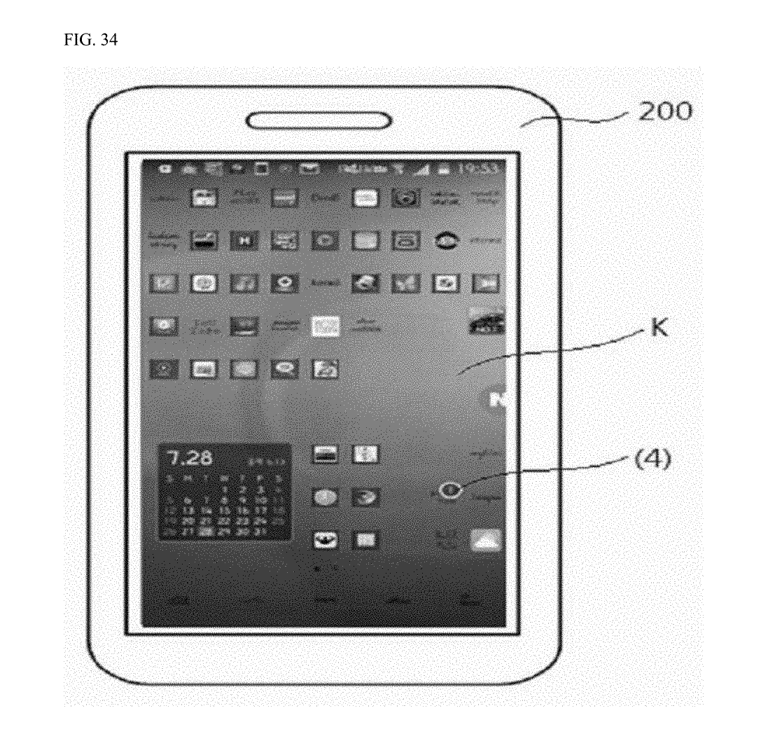

FIG. 34 illustrates another exemplary embodiment of a specific screen of a user apparatus on which an authentication apparatus of FIG. 29 is applied.

As shown in FIG. 34, a notification history 4 indicating that a message sent by another user has been received as a factor other than the input of the user in the existing specific screen K shown in FIG. 33 can be displayed on one side of the corresponding application of the specific screen K.

As in this case, reception of a new message means that the notification history information displayed on the specific screen K is changed. At this time, the authentication apparatus 100 detects a change of the screen information according to the change of the notification history information, and then proceeds to register the authentication information based on the changed screen information.

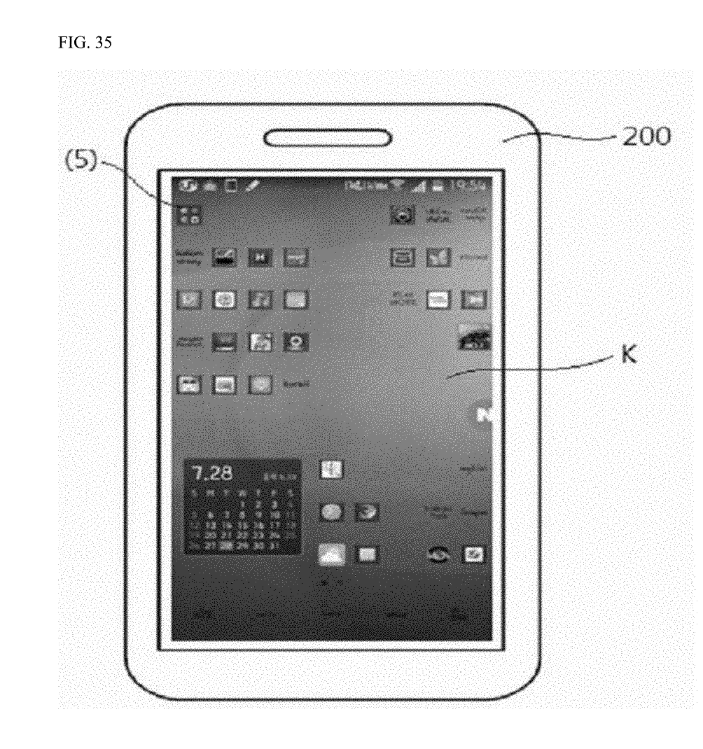

FIG. 35 illustrates another exemplary embodiment of a specific screen of a user apparatus on which an authentication apparatus of FIG. 29 is applied.

As shown in FIG. 35, the folder 5 is created by the user's input in the existing specific screen K shown in FIG. 34, and then various applications are grouped and arranged in the created folder 5, and the remaining applications can be rearranged according to the convenience of the user.

As in this case, rearranging the applications in the array again means that the arrangement information for at least one application of the specific screen K is changed. At this time, the authentication apparatus detects the change of the screen information, and then proceeds to register the authentication information based on the changed screen information.

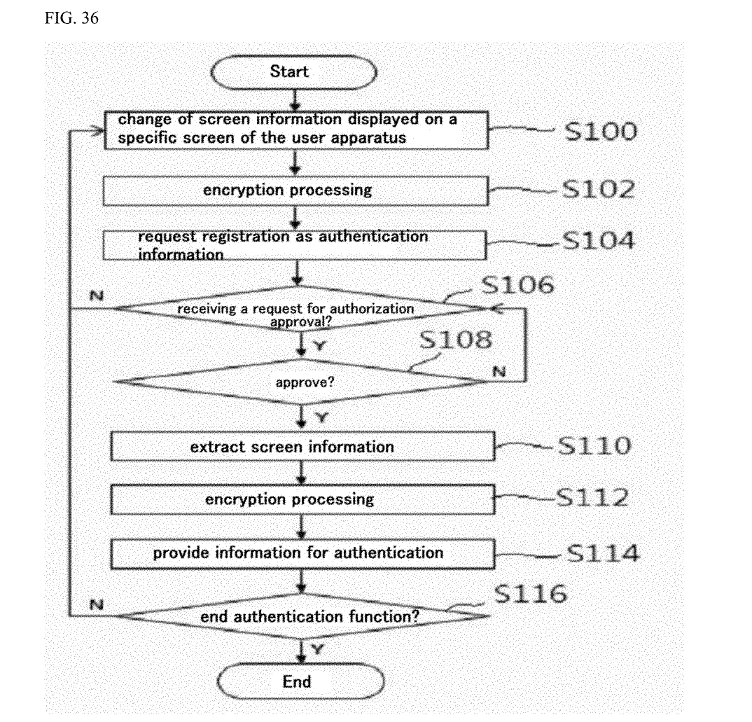

FIG. 36 is a flow chart illustrating another exemplary embodiment of an operation process of an authentication apparatus of the present inventive concept.

As shown in FIG. 36, when the screen information displayed on the specific screen K of the user device 200 is changed by a user's input or changed to a factor other than the user's input (S100), the authentication device 100 encrypts the changed screen information and requests the authentication server 40 to register the encrypted change screen information as the authentication information (S102 and S104).

Thereafter, when the user requests the authentication service of the present invention while using a specific service, the authentication apparatus 100 included in the user apparatus 200 transmits an authentication confirmation request (S106).

A message of the authentication confirmation request received in step S106 is output to the terminal screen of the user device 200 and the authentication process is continued by selecting ‘approval’ from ‘approval’ or ‘rejection’ displayed together with the message (S108).

Then, the authentication apparatus 100 extracts screen information displayed on the specific screen K (S110), encrypts the extracted screen information, and transmits the encrypted authentication screen information to the authentication server 40 (S112, S114).

Thereafter, when the authentication function in the user apparatus 200 is terminated, execution of the steps is also ended (S116).

Each of the steps of this authentication process is implemented as a computer program stored in a recording medium in combination with the authentication device 100 or a computer readable recording medium including instructions for executing the above steps when being executed by the authentication device 100.

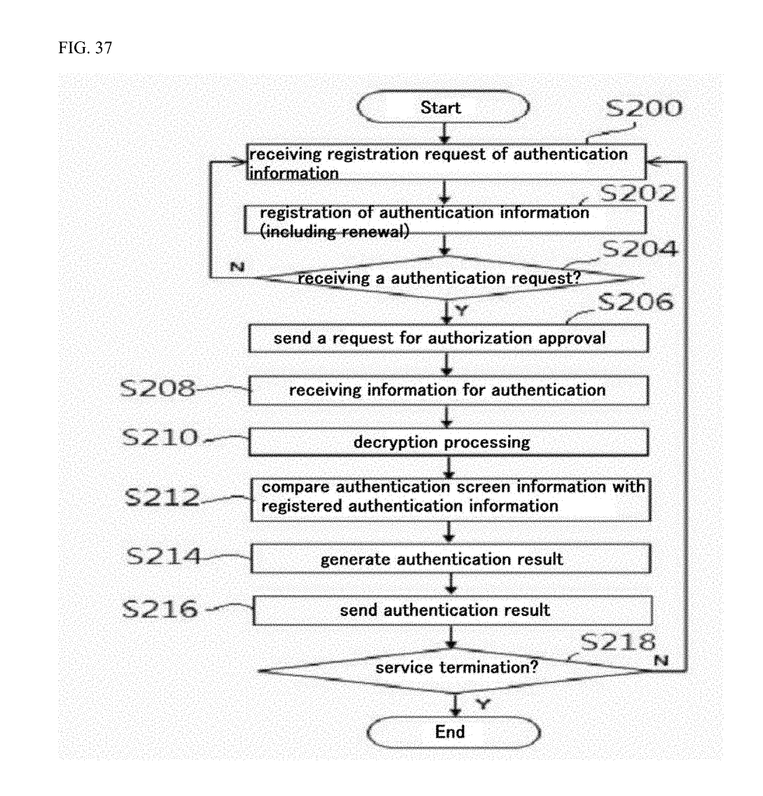

FIG. 37 is a flow chart illustrating another exemplary embodiment of an operation process of an authentication server of the present inventive concept.

As shown in FIG. 37, the authentication server 40 may receive a request for registration of authentication information based on the changed screen information from the authentication apparatus 100 included in or connected to the user apparatus 200 (S200). At this time, in order for the authentication server 40 to register the authentication information based on the changed screen information, it may proceed after the registration procedure for using the authentication service of the present invention has been performed in advance. The above-mentioned subscription procedure is performed in accordance with the normal service subscription procedure, and a detailed description thereof will be omitted.

Thereafter, in accordance with the registration request received in step S200, authentication information is registered (S202). Here, registration is a concept that includes registration of the first authentication information or updating of already registered authentication information.

Thereafter, when the user requests the authentication service of the present invention while using a specific service, the authentication server receives the authentication request received from the service server 500 providing the specific service (S204).

Thereafter, the authentication server 40 transmits an authentication confirmation request for allowing the user to confirm whether or not to start the authentication to the user apparatus 200 via the specific number received together with the authentication request (S206).

Then, the authentication server 40 receives the screen information displayed on the specific screen K of the user apparatus 200 from the authentication apparatus of the user apparatus 200 in an encrypted state (S208).

The encrypted authentication screen information received in step S208 is decrypted (S210).

The authentication screen information decrypted in step S201 is compared with the authentication information being registered (S212).

The authentication result is generated based on the comparison result in step S212 (S214), and the authentication result generated in step S214 is provided to the service server 500 (S216).

Thereafter, when the authentication service is terminated, the execution of the steps is also terminated (S218).

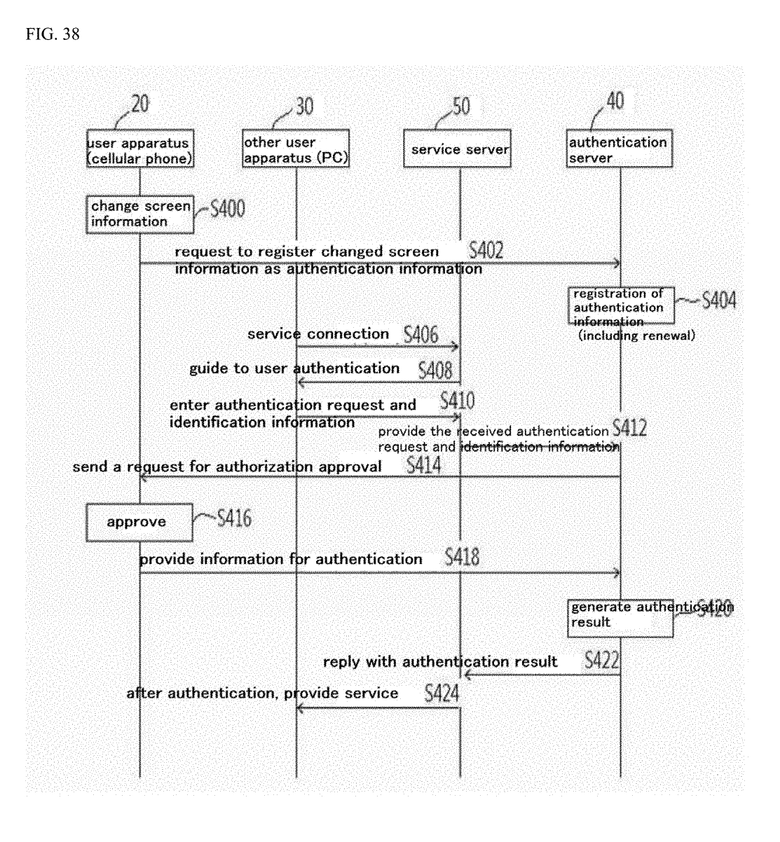

FIG. 38 is a flow chart illustrating another exemplary embodiment of a payment service to which an authentication system of the present invention is applied

As shown in FIG. 38, when the screen information displayed on the specific screen K of the user apparatus 200 is changed by a user's input or changed to a factor other than the input of the user, the authentication apparatus 100 included in the user apparatus 200 (S404), encrypts the changed screen information, and requests the authentication server 40 to register the encrypted change screen information as authentication information (S402).

In response to the registration request received in step S402, the authentication server 40 checks the existing subscription history and registers the encrypted change screen information as authentication information (S404). Here, registration is a concept that includes registration of the first authentication information or updating of already registered authentication information.

Thereafter, when the user requests the authentication service of the present invention while using a specific web service through another user apparatus 30 (PC) (S406 to S410), the authentication server 40 provides the specific service And receives the authentication request and the telephone number from the service server 500 (S412).

After that, the authentication server 40 transmits an authentication confirmation request to the user apparatus 200 through the received telephone number together with the authentication request (S414).

If there is a user approval input for a message of the authentication confirmation request (S416), the authentication apparatus 100 included in the user apparatus 200 extracts screen information displayed on a specific screen K of the user apparatus 200, encrypts the extracted screen information, and transmits the encrypted authentication screen information to the authentication server (S418).

The authentication server 40 decrypts the received encrypted authentication screen information, and generates an authentication result based on a result of comparing the decrypted authentication screen information with the authentication information being registered (S420).

Thereafter, the authentication server 40 provides the authentication result generated in step S420 to the service server 50 (S422).

Thereafter, the service server 50 provides the service that can be provided after authentication to the other user apparatus 300 (PC) (S424).

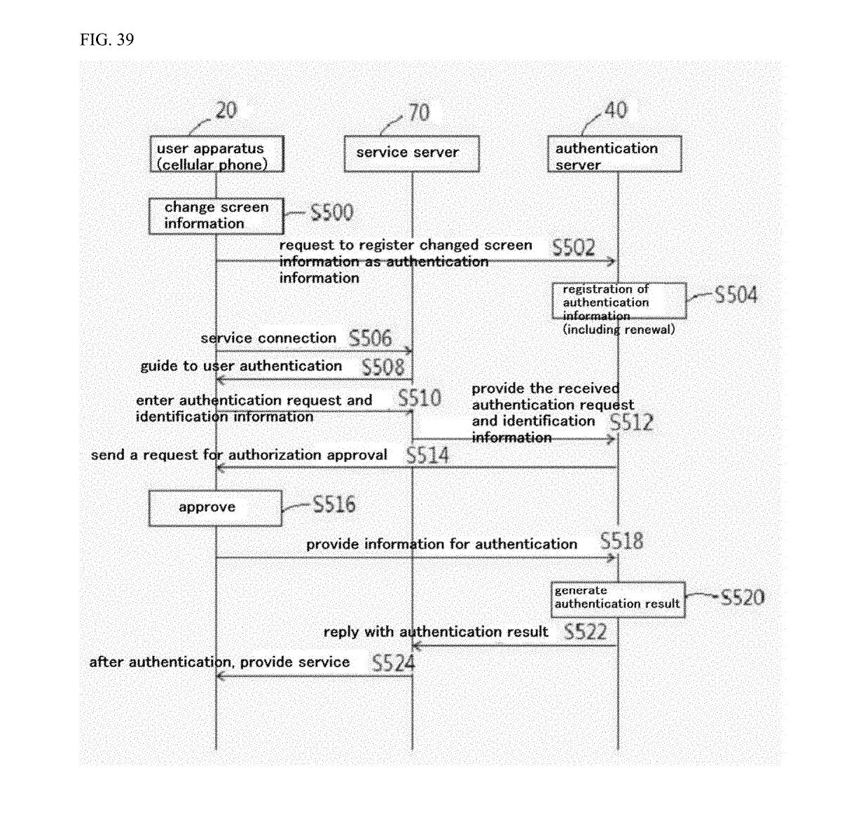

FIG. 39 is a flow chart illustrating another exemplary embodiment of a payment service to which an authentication system of the present invention is applied.

As shown in FIG. 39, when the screen information displayed on the specific screen K of the user apparatus 200 is changed by a user's input or changed to a factor other than the input of the user, the authentication apparatus 100 included in the user apparatus 200 (S500), the changed screen information is encrypted and the encrypted change screen information is requested to be registered in the authentication server 40 as authentication information (S502).

the authentication server 40 checks the existing subscription history according to the registration request received in step S502, and registers the encrypted change screen information as the authentication information (S504). Here, registration is a concept that includes registration of the first authentication information or updating of already registered authentication information.

Thereafter, when the user requests the authentication service of the present invention while using a specific mobile service through a user apparatus (e.g., mobile phone 200) (S506 to S510), the authentication server 40 transmits And receives the authentication request and the telephone number from the service server 50 (S512).

After that, the authentication server 40 transmits an authentication confirmation request for allowing the user to confirm whether or not the authentication is started, to the user device 200 through the received telephone number together with the authentication request (S514).

If there is a user approval input for the message of the authentication confirmation request (S516), the authentication apparatus 100 included in the user apparatus 200 extracts the screen information displayed on the specific screen K of the user apparatus 200, encrypts the extracted screen information and transmits the encrypted authentication screen information to the authentication server 40 (S518).

The authentication server 40 decrypts the received encrypted authentication screen information, and generates an authentication result based on a result of comparing the decrypted authentication screen information with the authentication information being registered (S520).

Thereafter, the authentication server 40 provides the service server 50 with the authentication result generated in step S520 (S522).

Then, the service server 50 provides the service that can be provided after authentication to the user apparatus (e.g., the mobile phone 200) (S524).

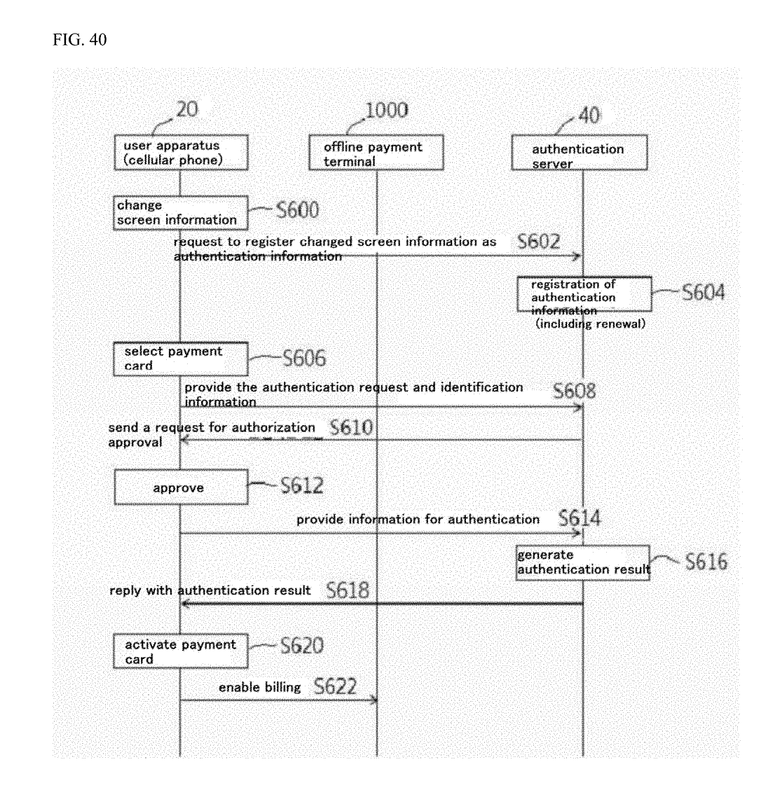

FIG. 40 is a flow chart illustrating another exemplary embodiment of a payment service to which an authentication system of the present invention is applied

As shown in FIG. 40, when the screen information displayed on the specific screen K of the user device 200 is changed by a user's input or changed to a factor other than the input of the user, the authentication apparatus 100 included in the user apparatus 200 (S600), the changed screen information is encrypted and the encrypted change screen information is registered as authentication information in the authentication server 40 (S602).

In response to the registration request received in step S602, the authentication server 40 confirms the existing subscription history and registers the encrypted change screen information as the authentication information (S604). Here, registration is a concept that includes registration of the first authentication information or updating of already registered authentication information.

Thereafter, the user can select any one registration card for payment in the offline store at the user apparatus (e.g., mobile phone 200) (S606).

The authentication apparatus 100 included in the user apparatus 200 receives the registration card selection in step S606 as an instruction of the authentication request, the authentication apparatus 100 provides an authentication request and a telephone number of the user apparatus 200 to the authentication server 40 in accordance with the received command (S608).

Thereafter, the authentication server 40 transmits an authentication confirmation request for allowing the user to confirm whether or not the authentication is started, to the user apparatus 200 through the received telephone number together with the authentication request (S610).

If there is a user approval input for the authentication confirmation request message (S612), the authentication device 100 included in the user device 200 extracts the screen information displayed on the specific screen K of the user device 200, encrypts the extracted screen information, and transmits the encrypted authentication screen information to the authentication server 40 (S614).

The authentication server 40 decrypts the received encrypted authentication screen information, and generates an authentication result based on a result of comparing the decrypted authentication screen information with the authentication information being registered (S616).

Then, the authentication server 40 provides the authentication result generated in step S616 to the user apparatus 200 (S618).

If the authentication result is normal authentication, the selected registration card is activated in a usable state (S620). In the state of step S620, the user apparatus 200 is connected to the off-line payment terminal 1000 by close proximity or by magnetic connection (S622).

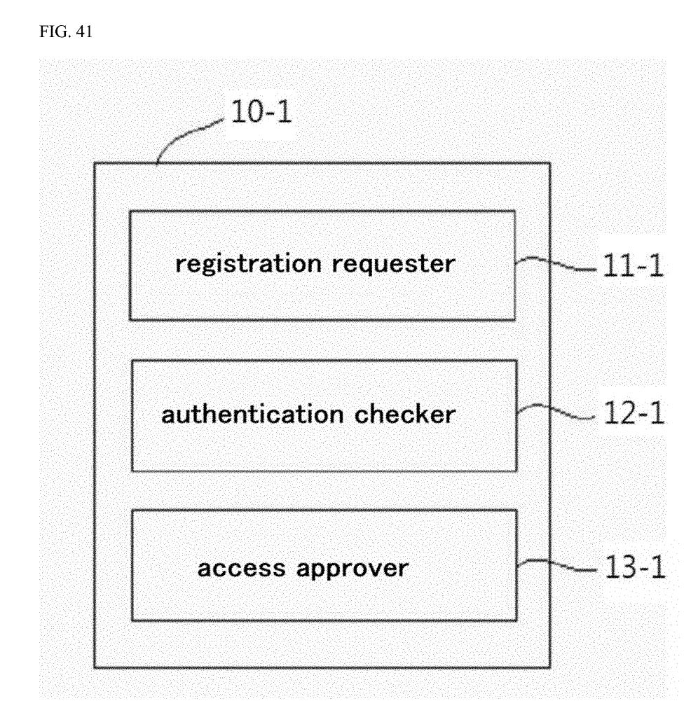

FIG. 41 is a block diagram illustrating an object apparatus according to one embodiment of the present inventive concept.

Referring to FIG. 41, an object apparatus 10-1 comprising a registration requester 11-1 which requests registration of authentication information based on a changed information if an usage information of the object apparatus 10-1 is changed by an user's input or is changed to a factor other than the input of the user, an authentication checker 12-1 which receives the connection request directly or indirectly from the other object apparatus and requests input of the connection information corresponding to the registered authentication information or connection authentication in response to the received connection request and access approver 13-1 which approves the connection of the other object apparatus according to the authentication of the input connection information or the result of the connection authentication.

Here, the object apparatus 10-1 is a concept that collectively refers to devices that can be connected to the object Internet, such as a smart phone, a washing machine, a boiler, a smart window, a home hub router, a TV.

The usage information of the object apparatus 10-1 refers to the details used by the user, the details used by the user other than the details used by the user, or information that can be combined based thereon.

The registration requester 11-1 encrypts the registration request usage information including the changed usage information when the usage information of the object apparatus 10-1 is changed by a user's input or changed to a factor other than a user's input, and requests the encrypted registration request usage information to be registered as the authentication information in the authentication server.

Specifically, it is possible to utilize only the changed usage information as the registration request usage information, but it is also possible to combine the changed usage information and the existing usage information to use as the registration request usage information.

The registration request usage information may be the same as the entire portion of the registered authentication information, or may be the same as a part of the registered authentication information.

Here, the same parts of the registration request usage information and the registered authentication information mean that the registration request usage information is directly used as authentication information. For example, when the registration request usage information is ABCDE, the registered authentication information also becomes ABCDE. At this time, each alphabet of ABCDE means usage information of the object apparatus 10.

In addition, the fact that the registration request usage information is the same as a part of the registered authentication information means that only some information is consistent between the registration request usage information and the authentication information. This is to provide more protection against security exposure due to hacking during information transmission. When the registration request usage information does not transmit all the information for registering as the authentication information, but only ABC, which is a part, is transmitted, According to the information registration algorithm, ABCDE can be registered as the final authentication information by combining the received registration request usage information ABC with the existing registration details CD.

That is, if only A of the registration request usage information ABC is changed usage information and BC is the existing usage information, the authentication server extracts the CD which is the third and fourth existing usage information among the recently used usage details, ABCDE can be registered as the final authentication information.

When receiving the connection request directly or indirectly from the other object apparatus, the authentication checker 12-1 requests the input of the access information corresponding to the registered authentication information through the above-described process, or requests a connection authentication corresponding to the registered authentication information.

When the authentication checker 12-1 requests input of the connection information, the other object apparatus acts as the authentication server. That is, the object apparatus 10-1 and the other object apparatus are P2P connected to register the authentication information of the object apparatus 10-1 in the other object apparatus, and then the other object device is connected to the object device 10-1 (For example, all of the authentication information or a part of the authentication information) corresponding to the authentication information of the object device 10-1 registered in advance when the object apparatus 10-1 is to be controlled, the other object apparatus can be authenticated as a device having a proper access right to the object apparatus 10-1. At this time, the input of the connection information by the other object apparatus means that it is automatically inputted according to the authentication logic configured in advance.

For example, the object apparatus 10-1 may be a home hub router, a smart window, or the like, and the other object apparatus may be a smart phone. Of course, a smartphone may also be a device corresponding to the object apparatus 10-1.

When the object apparatus 10-1 and the other object apparatus perform authentication between the two devices through the input of the connection information, the connection information input by the automatic input of the other object apparatus is the same as the entire portion of the already registered authentication information, it may be the same as one part of the already registered authentication information.

The fact that the authentication information automatically input from the other object apparatus is the same in all the pieces of the authentication information already registered means that the authentication information registered and stored in the other object apparatus is input as the access information as it is. For example, when the registered authentication information is ABCDE, the access information is also ABCDE.

On the other hand, the fact that the access information automatically input from the other object apparatus is the same as a part of the already registered authentication information is intended to further prevent exposure to the risk of hacking during information transmission, in the case of transmitting only the CDE which is a part of the authentication information, instead of transmitting all the correspondence information to be compared with the authentication information, the object apparatus 10-1 which has received the CDE as the connection information compares the existing registration details AB with the currently inputted access information CDE according to a predetermined authentication execution algorithm and compares it with the registered authentication information ABCDE which is the final access information of the comparison object to be processed.

In addition, the connection information provided by the object apparatus 10-1 from the other object apparatus in the authentication execution process may be different from the registration request usage information in the registration process. Of course, it is also possible to set the access information transmitted in the authentication execution process and the registration request usage information of the registration process to be the same.

On the other hand, when the authentication checker 12-1 requests connection authentication, there is a separate authentication server in addition to the object apparatus 10-1 and the other object apparatus. That is, each of the object apparatus 10-1 and the other object apparatus performs registration of the authentication information through the registration request usage information including the changed usage information each time the usage information of each device is changed, and when the object apparatus 10-1 receives the connection request from the other object apparatus, it can request the other object apparatus to obtain the connection authentication from the authentication server regarding whether connection between the object apparatus 10-1 and the other object apparatus is possible have. In response to such a request, when the other object apparatus receives a connection authentication result from the authentication server and is normally processed, the other object apparatus can be authenticated as a device having proper access right to the object apparatus 10-1.

When the access approver 12-1 of the object apparatus 10-1 requests connection authentication from the authentication server when determining whether or not to approve the connection to the other object apparatus, all of the object apparatus 10-1 and the other object apparatus can perform pre-authentication to be authenticated as being a device having a proper access right to the authentication server. In this preauthentication process, the authentication checker 12-1 of the object apparatus 10-1 extracts specific usage information of a predetermined reference from the entire usage information being stored in advance, encrypts the extracted usage information, and transmits the encrypted authentication usage information to the authentication server as information for the pre-authentication. Accordingly, the authentication server decrypts the encrypted authentication usage information provided from the object apparatus 10-1, compares the decrypted authentication usage information with the registered authentication information, and verifies whether the object apparatus 10-1 is a device with a proper access right through the comparison result.

In addition, in the pre-authentication process, the other object apparatus also extracts specific usage information of a predetermined reference from the entire usage information that is being stored in advance, encrypts the extracted specific usage information, and transfers the encrypted authentication usage information to the authentication server as information for the pre-authentication. The authentication server decrypts the encrypted authentication usage information provided from the other object apparatus, compares the decrypted authentication usage information with the registered authentication information, and authenticates whether the other object apparatus is a device having a proper access right through the comparison result.

In such a pre-authentication process, the specific usage information extracted from each object apparatus may be the same as the entire portion of each authentication information registered in advance, or may be the same as a part of each registered authentication information. Here, the fact that the extracted specific usage information and all the registered authentication information are the same means that specific usage information is extracted like the registered authentication information. For example, if the registered authentication information is ABCDE, the specific usage information extracted also becomes ABCDE.

In addition, the fact that the extracted specific usage information is the same as a part of the registered authentication information means that only some pieces of information are identical between the extracted specific usage information and the authentication information. This is also intended to provide more protection against exposure to hacking hazards during information transmission. If the specific usage information does not convey all information to be compared with the authentication information, but only a portion of the CDE, it is possible to complete ABCDE which is the final specific usage information to be compared with the registered authentication information by combining the specific usage information CDE transmitted in accordance with the predetermined authentication execution algorithm and the existing registration details AB have.

The specific usage information extracted in the authentication execution process and the registration request usage information of the registration process may be different from each other as described above. Of course, it is also possible to set the specific usage information extracted in the authentication execution process and the registration request usage information of the registration process to be the same.

The registration requester 11-1 includes a configuration for detecting whether usage information of the object apparatus 10-1 is changed by a user's input or changed to a factor other than a user's input, and requests the registration of the authentication information based on the changed usage information when there is a change in the usage information.

In addition, it is preferable that the authentication information registration request of the registration requester 11-1 is executed automatically in consideration that the authentication information registration request is performed every time the usage information of the object apparatus 10-1 is changed.

The registration requester 11-1 can periodically or non-periodically change the same part of the mutual information if one part is identical between the registration request usage information and the registered authentication information.

For example, the periodic change of the registration requester 11-1 may be based on a method of combining at least one of date, week, and time according to pre-programmed logic, in this way, a part of the registration request usage information and registered authentication information identical to each other can be specified. As a more specific example, if the same part of the registration information of the registration request used in 2015 Sep. 14 and the same part of the registered information corresponds to 3 weeks of September 2015 based on the week of the month, the same part of the authentication information can be specified as the same part from the first to the third digit of the registered authentication information.

An example of the non-periodic change of the registration requester 11-1, the registration requester 11-1 can change the same part between the registration request usage information and the registered authentication information based on the update information received from the authentication server.

If one part of the access information input from the other device is the same as the registered authentication information, one part of the mutual information can be changed periodically or non-periodically.

Periodically changing the same part of the connection information and the authentication information is performed by combining at least one of the date, the week, and the time according to logic preliminarily programmed to the object apparatus and the other object apparatus, and identifies the same part of the connection information and the authentication information, and makes it possible to change a part already specified. The method of combining at least one of the dates, weeks, and hours described above is merely an example, and various methods for specifying the same intersection portion between other information can be applied.

Non-periodically changing the same part of the connection information and the authentication information, when the other object apparatus is a user-controllable mobile phone, can be performed by the non-periodic input of the user to the other object apparatus 10-1, it is possible to specify the same part of the connection information and the authentication information at once or change a part already specified through interaction between the counterpart object apparatus and the object apparatus 10-1.

Also, in the case of processing connection authentication for the object device 10-1 of the other object device through the authentication server, if the specific usage information extracted from each object device and the registered authentication information are the same, the same part can be changed periodically or aperiodically.

Periodically changing the same part of the connection information and the authentication information is performed by combining at least one of the date, the week, and the time according to logic preliminarily programmed, and it is possible that the same part is specified between the extracted usage information and the registered authentication information. As a more specific example, when the same part extracted between the specific usage information extracted from the registration information and the registered authentication information is divided into the even-numbered day and the odd numbered day, and the 14th day corresponds to the even-numbered day, The same part can be specified from the first digit to the second digit of the authentication information in which the same part is registered.

An example of the non-periodic change to the same part of the usage information and the authentication information is that the authentication checker 12-1 of the object apparatus 10-1 can change the same part of the specific usage information and the registered authentication information based on the update information received from the authentication server. It can be executed in the same manner as a counterpart object apparatus.

The registration requester 11-1 can encrypt the changed usage information and the authentication checker 12-1 can encrypt the extracted specific usage information. In addition, the connection information input from the other object apparatus can also be encrypted from the other object apparatus and transmitted to the object apparatus 10-1. Here, at least one of various encryption schemes having a high security level can be applied to the encryption scheme.

For example, at least one of the registration requester 11-1 and the authentication checker 12-1 can encrypt the public key using a decryption key having a predetermined number of digits.

The public key cryptosystem can easily obtain the product m (=pq) of two prime numbers when p and q are given, with two prime numbers (1 and a natural number that can not be separated by a natural number other than the number itself) given a product m of a prime number, it is hard to know which m is a product of two prime numbers. In other words, the public key system is provided with a device such as a trapdoor which can be easily inserted in one direction but can not be returned by any other user.

When you expose m products of two prime numbers, you can use prime numbers in which two prime numbers p and q are 100 or more digits each. For example, m may be:

m=114381625757888867669235779976146612010218296721242362562561842 935706935245733897830597123563958705058989075147599290026879543541

The two prime factors p and q of the top m obtained by the factorization algorithm are as follows.

p=3490529510847650949147849619903898133417764638493387843990820577

q=32769132993266709549961988190834461413177642967992942539798288533

Even if two prime factors p and q of the top m are obtained by using the factorization algorithm, it takes time to derive the result value. This requires absolute computation processing time even if the factorization algorithm is continuously improved.

Accordingly, it is preferable that the public key cryptosystem is encrypted with prime numbers greater than the two prime factors p and q mentioned above. That is, the public key cryptography method requires a minimum time (for example, more than several days) for decrypting even if it is exposed to a hacking program.

The object apparatus 10-1 of the present invention changes the authentication information every time the usage information of the object apparatus 10-1 is changed, and in the case where the object apparatus 10-1 is a cellular phone, for example, the changing interval of the authentication information may be different for each user, but it may be changed every few seconds or changed every few hours.

That is, when the usage information of the object apparatus 10-1, which is frequently changed, is encrypted using the public key cryptosystem described above, even if it is exposed to hacking and decrypted, at the time when the decryption is completed, the authentication information is changed to the new authentication information instead of the hacked and exposed authentication information.

With this principle, the object apparatus 10-1 of the present invention can establish strong security without user intervention.

Referring to FIG. 2, A plurality of usage information is stored in the object apparatus 10-1. For example, the first usage information, the second usage information, the third usage information, and the Nth usage information may be included in the object apparatus 10-1.

Referring to FIG. 3, the first usage information, the second usage information, the third usage information, and the Nth usage information may be arranged in a time series order. When the registration requester 11-1 requests registration to the authentication server including the three pieces of usage information as the registration request usage information, the first usage information to the third usage information may be used as the registration request usage information according to the clock thermal sequence.

The usage information shown in FIG. 3 is different from FIG. 2, and has a time series arrangement in which recent usage details are arranged below and past usage details are arranged on top. When the object apparatus 10-1 is a smartphone, the registration requester 11-1 may request registration using the latest three pieces of usage information as the registration request usage information. the latest three pieces of usage information are as follows: (1) usage information about the B company message sent to the KIM at 8:36 am on Jul. 28, 2015, (2) usage information about receiving B company message from KIM, at 8:37 am on Jul. 28, 2015, (3) usage information about receipt of notifications related to the securities application of the C company at 9:01 am on Jul. 28, 2015.

Thereafter, when the usage information of the object device 10-1 is added and changed, for example, the registration requester 11-1 may add the usage information (the company's stock news from 9:02 am on Jul. 28, 2015 to 9:16 am on Jul. 28, 2015) generated additionally to the above-mentioned usage history. At this time, the registration requester 11-1 may change the (1-1) usage information of the registration request usage information to information about receiving the B message from the KIM at 8:37 am on May 28, 2015, (2-1) usage information to information about receipt of the securities application notice of the C company at 9:01 am on May 28, 2015, and (3-1) usage information to about viewing D company's securities news from 9:02 am on May 28, 2015 to 9:16 am on May 28, 2015. And the registration requester 11-1 may request registration of the authentication information based on the above description.

Referring to FIG. 5, when the object apparatus 10-1 is a smartphone, the registration requester 11-1 may classify the usage information of the object apparatus 10-1 by category and extract usage information to be included in the registration request usage information from each group.

For example, when the registration request usage information is set to three pieces of usage information, the first usage information of the first group is used as the (1) usage information of the registration request usage information, the first usage information of the second group is used as the (2) usage information of the registration request usage information and first usage information of the third group can be extracted as (3) usage information of the registration request usage information.

Referring to FIG. 6, the first group may be a call history, and it is possible to extract the usage information about the details of calling for two minutes by calling his wife at 2:31 pm on Jul. 28, 2015, which is the most recent call history among the call history, as (1) usage information of the registration request usage information.

the second group may be a message history, and it is possible to extract usage information of the E company message received from the LEE as (2) usage information of the registration request usage information at 8:03 am on Jul. 28, 2015, which is the latest message among the message history.

the third group may be a ‘other execution history’, it is possible to extract usage information of the usage information to about viewing D company's securities news from 9:02 am on May 28, 2015 to 9:16 am on May 28, 2015 as (3) usage information of the registration request usage information, which is the latest message among the other execution history.

Referring to FIG. 7, when the object apparatus 10-1 has a control environment such as a smart phone capable of setting a user selection, the usage information can be selected as a user convenience through a selection menu P such as user selection, application, function selection or time selection.

That is, in the selection menu P, the user selects a wife from the user selection menus of the selection menu P, selects a phone call, a message of the company B, and a message of the company E from the application or function menu of the selection menu P, andiIt is possible to select an originating or an incoming call from the view selection menu of the selection menu P.

In this case, the usage information of the object apparatus 10-1 is regarded as changed when the phone conversation, the B company message, and the E company message are transmitted or received from the wife to the object apparatus 10-1. And authentication information registration based on the changed usage information can be executed.

Therefore, in this case, the wife of the user can be regarded as a helper for changing the authentication information of the object apparatus 10-1 from time to time.

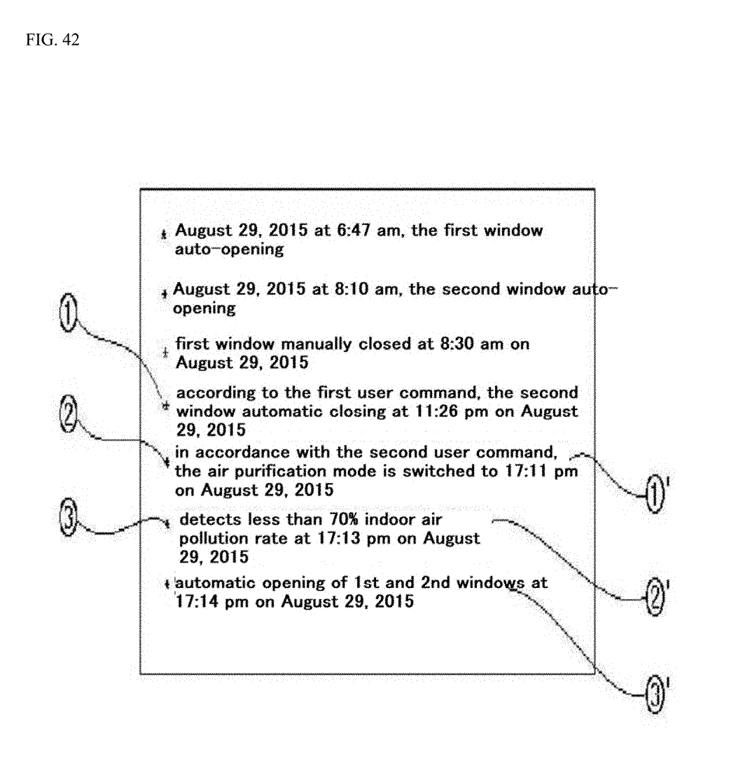

FIG. 42 illustrates another exemplary embodiment of an usage history stored in an object apparatus of FIG. 41.

The usage information shown in FIGS. 4 to 7 is an example in which the object apparatus 10-1 is a smart phone, and the usage information shown in FIG. 42 is a case in which the object apparatus 10-1 is a smart window will be.

The smart apparatus 10-1, which is a smart window, can request to register as authentication information using the three pieces of usage information, i.e., (1) usage information about automatic closing of the second window according to the first user command at 11:26 pm on Aug. 29, 2015, (2) usage information about switching to air cleaning mode according to the second user command at 17:11 pm on Aug. 29, 2015, and (3) usage information on the detection of indoor air pollution rate less than 70% at 17:13 pm on Aug. 29, 2015, as registration request usage information.

Thereafter, when the usage information of the object apparatus 10-1 is added and changed, for example, the registration requester 11-1 of the object apparatus 10-1, which is a smart window, and it is possible to add usage information about automatic opening of the first window and the second window at 17:14 pm on Aug. 29, 2015. At this time, the registration requester can request the registration of the authentication information by changing (1-1) usage information of the registration request usage information to usage information about switching to air cleaning mode according to the second user command at 17:11 pm on Aug. 29, 2015, (2-1) usage information to usage information on the detection of indoor air pollution rate less than 70% at 17:13 pm on Aug. 29, 2015, and (3-1) usage information to information on the detection of indoor air pollution rate less than 70% at 17:13 pm on Aug. 29, 2015.

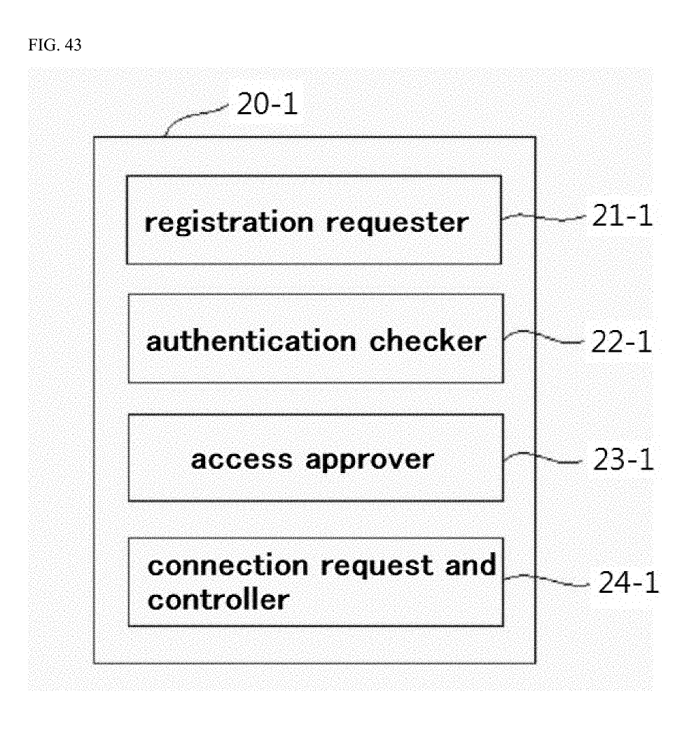

FIG. 43 is a block diagram illustrating an object apparatus according to an another embodiment of the present inventive concept.

As shown in FIG. 43, the object apparatus 20-1 requests connection to any other object apparatus to be controlled in addition to the registration requester 21-1, the authentication checker 22-1 and the access approver 23-1, and a connection request and controller 24-1 for controlling another object apparatus after the connection is approved.

That is, the object apparatus 20-1 including the connection request and controller 24-1 may be referred to as the other apparatus described above.

Also, the object apparatus 10-1 is connected to the other object apparatus and is controlled from the other object apparatus, and performs specific driving. For example, when the object apparatus 10-1 is a smart window, it can perform window opening or window closing operation under the control of the other object apparatus (e.g., a smart phone).

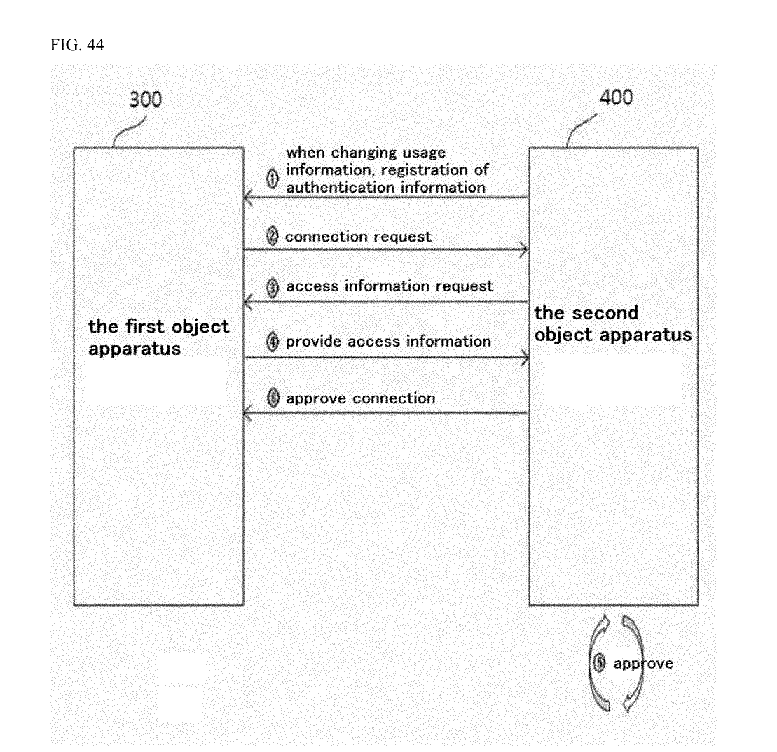

FIG. 44 illustrates another exemplary embodiment of communication configuration between object apparatus of the present inventive concept.

As shown in FIG. 44, in the case of the P2P connection of the first object apparatus 300 and the second object apparatus 400, the second object apparatus 400 can request the first object apparatus 300 to register usage information of the second object apparatus 400. For example, the first object apparatus 300 may be a smart phone, and the second object apparatus 400 may be a washing machine.

The second object apparatus (e.g., washing machine 400) encrypts the registration request usage information including the changed usage information when the usage information of the second object apparatus 400 is changed, and transmits the encrypted registration request usage information as the authentication information and requests registration to the first object apparatus (e.g., smartphone 300) (1).

The first object apparatus (e.g., the smartphone, 300) responds to the authentication information registration request of the second object apparatus (e.g., washing machine 400) based on the details of the subscribed contents and transmits the registration result as the response result to the second object apparatus (for example, washing machine, 400), thereby completing the registration of the authentication information (2)

Thereafter, when the first object apparatus (e.g., smart phone 300) makes a connection request for controlling the second object apparatus (e.g., washing machine, 400) to the second object apparatus (e.g., washing machine 40) (Eg, washing machine, 400) to input a connection number (3).

As the first object apparatus (e.g., smart phone 300) is storing the already registered authentication information, the first object apparatus (e.g. smart phone 300) extracts the authentication information as the connection information corresponding to the registered authentication information and transmits it to the second object apparatus (e.g., washing machine 400) (4).

The second object device (e.g., washing machine 400) extracts the specific usage information corresponding to the registered authentication information generated in the registration step, compares the extracted specific usage information with the access information inputted in step 4, (e.g., smart phone 300), and approves the connection request of the first object device (e.g., smart phone 300) through the comparison result (step 5)

The second object device (e.g., the washing machine) 400 transmits the approval result generated in step 5 to the first object device (e.g., the smartphone 300) (For example, the washing machine 400, and this allows a first object apparatus (e.g., a smartphone, 300) to connect to a second object apparatus (e.g., a washing machine, 400) (step 6).

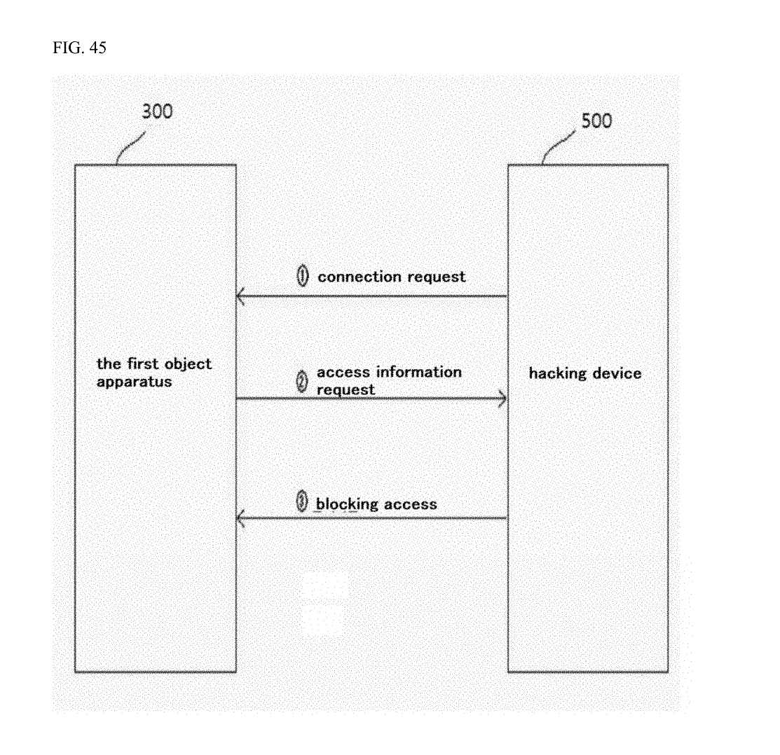

FIG. 45 is a detailed block diagram specifically illustrating one exemplary embodiment of configuration for the case where the first object device in FIG. 44 is hacked.

As shown in FIG. 45, when a hacking apparatus tries to access a first object apparatus (e.g., smart phone 300) (1), the first object apparatus (e.g., the smartphone 300) requests the hacking apparatus 500 to input the connection number as requested by the second object apparatus (e.g., washing machine 400) (2).

If a valid access number is not input from the hacking apparatus 500 or exceeds the input time, the first object apparatus (e.g., the smartphone 300) may refuse the access of the hacking apparatus 500 or access the hacking apparatus 500 (3).

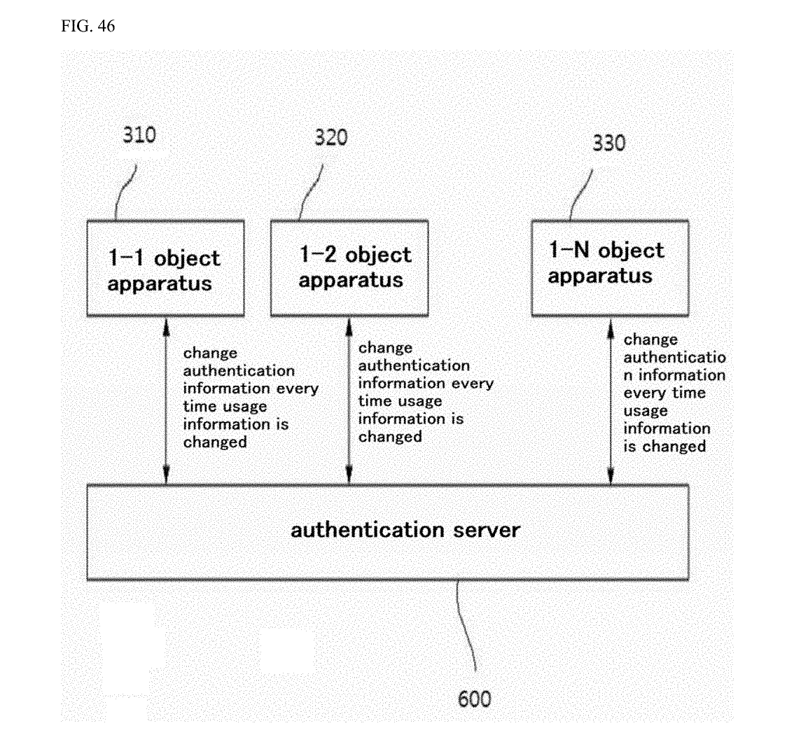

FIG. 46 is a detailed block diagram specifically illustrating one exemplary embodiment of change authentication information for the first object device of FIG. 44.

As described above, the second object device (e.g., washing machine 400) registers usage information of the second object device (e.g., washing machine 400) in the first object device (e.g., smart phone 300). On the other hand, the first object apparatus (e.g., the smartphone 300) registers the usage information of the first object apparatus (e.g., smart phone 300) in the authentication server 600 every time the usage information is changed.

That is, a first object apparatus (e.g., a smart phone) 300 and a second object apparatus (e.g., a washing machine, 400) are connected by P2P, and authentication of the first object apparatus (e.g., smartphone, 300) may be performed via the authentication server (600).

Thus, the authentication server 600 can change and register usage information of a plurality of first object apparatus (e.g., 1-1 object object apparatus 310, 1-2 object object apparatus 320, 1-N object apparatus 330) at each usage information change.

At this time, the first object apparatus (e.g., the smartphone 300) not only registers the authentication information every time the usage information of the first object apparatus (e.g., smart phone 300) is changed, (e.g., smart phone, 300), but also changes the screen information displayed on the specific screen of the first object apparatus (e.g., smart phone 300), change of the usage information of the first object apparatus (e.g., smart phone 300), or information that can be combined on the basis of these, it is also possible to automatically change the authentication information from time to time without user setting through changing the usage information.

Here, the screen information includes arrangement information, notification detail information, background image, or information that can be combined based on at least one application of a specific screen.

The specific screen of the first object device (e.g., smartphone 300) may be a screen that is mainly used by the user at the time of using the first object device (e.g., smart phone 300), and a background screen which is a main operation screen where various applications are located.

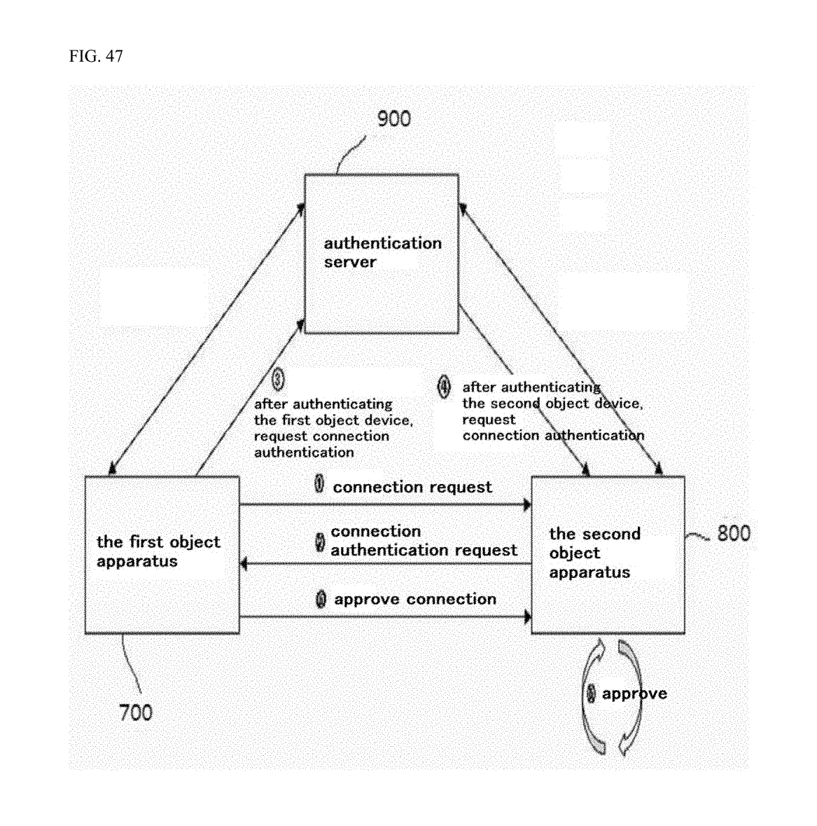

FIG. 47 illustrates another exemplary embodiment of communication configuration between object apparatus of the present inventive concept.

As shown in FIG. 47, the first object apparatus (e.g., a smart phone) 700 and the second object apparatus (e.g., the washing machine 800) can request registration of the registration request usage information including the changed usage information to the authentication server 900 as authentication information every time the usage information is changed.

When a first object apparatus (e.g., a smart phone) 700 makes a connection request to control a second object apparatus (e.g., washing machine 800) to a second object apparatus (e.g., a washing machine 800), and requests input of a connection number to the second object apparatus (e.g., washing machine 800) (2).

The first object apparatus (e.g., the smartphone 700) connects to the authentication server 900, and receives the pre-authentication of the first object apparatus (e.g., the smartphone 700) through the result of comparing the registered authentication information of the first object apparatus (e.g., smartphone 700) and the specific usage information extracted from the first object apparatus (e.g., the smartphone 700), and then requests the authentication server 900 of the second-stage connection authentication (3).

The authentication server 900 connects to the second object apparatus (e.g., washing machine 800), which is an opposite terminal to the second-stage connection authentication, and proceeds with the pre-authentication based on the registered authentication information of the second object apparatus (e.g., the washing machine 800), and provides the result of the second-stage connection authentication to the second object apparatus (e.g., washing machine 800) in accordance with the pre-authentication result (4).

Then, the second object apparatus (e.g., washing machine 800) approves the connection request of the first object apparatus (e.g., smartphone) 70 through the result input in step (4) (step 5).

The second object apparatus (e.g., washing machine 800) transmits the approval result generated in step 5 to the first object apparatus (e.g., the smartphone 700) (E.g., washing machine 800), and it is possible for the first object apparatus (e.g., smart phone, 700) that has received it to access the second object apparatus (e.g., washing machine 800) (step 6).

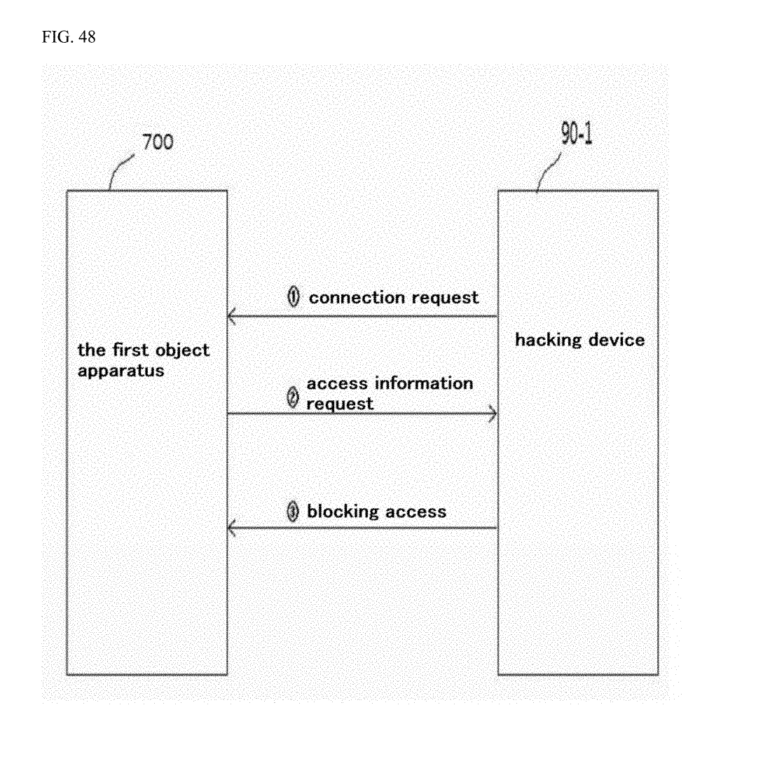

FIG. 48 is a detailed block diagram specifically illustrating one exemplary embodiment of configuration for the case where the first object device in FIG. 47 is hacked.

As shown in FIG. 48, when the hacking apparatus 90-1 attempts to access the first object apparatus (e.g., smart phone 700) (1), the first object apparatus (e.g., the smartphone) 700 requests the hacking apparatus 90-1 to input a connection number, as in the case of the second object apparatus (e.g., the washing machine 80) described above (2).

When a valid access number is not input from the hacking apparatus 90-1 or the input time is exceeded, the first object apparatus (e.g., the smartphone 700) rejects the connection of the hacking apparatus (90-1) (3).

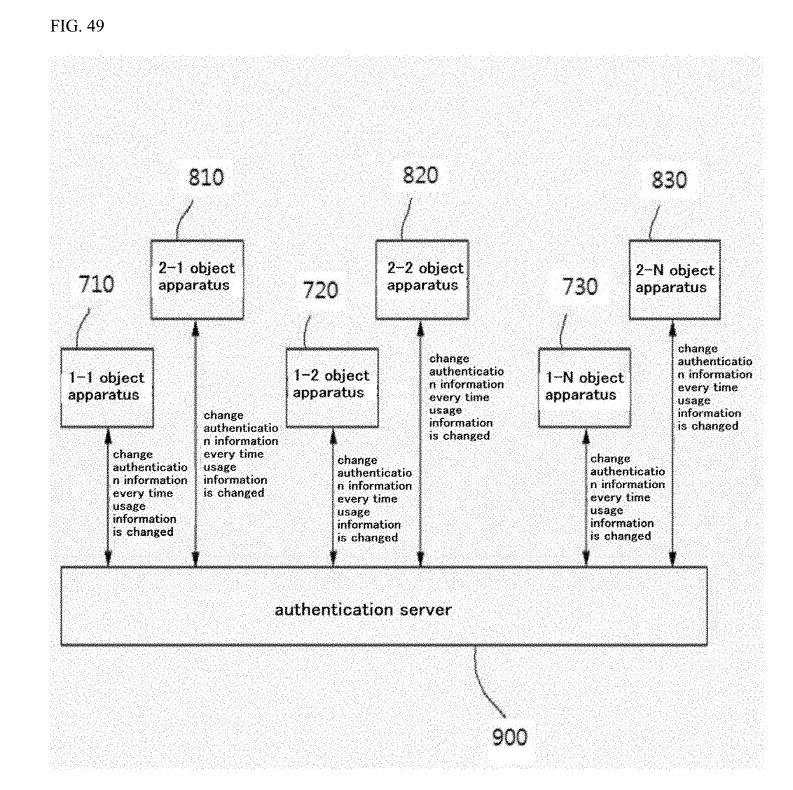

FIG. 49 is a detailed block diagram specifically illustrating one exemplary embodiment of changing authentication information for each object apparatus of FIG. 47.

As described above, 1-1 object apparatus 710 to 1-3 object apparatus 730, and 2-1 object apparatus 810 to 2-3 object apparatus 830 can register the respective usage information to the authentication server 900 each time usage information is changed.

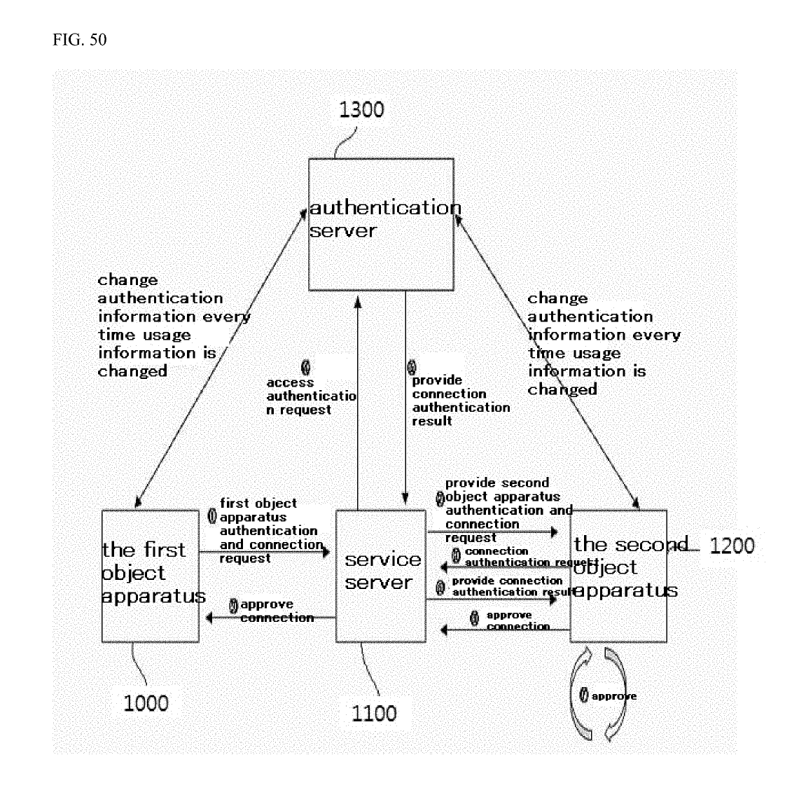

FIG. 50 illustrates another exemplary embodiment of communication configuration between object apparatus of the present inventive concept.

As shown in FIG. 50, the first object device (e.g., a smartphone) 1000 and the second object device (e.g., washing machine) 1200 can request registration of the registration request usage information including the changed usage information to the authentication server 130 as authentication information.

Then, the first object apparatus (e.g., smart phone 1000) accesses the service server 1100 and logs in (1). In step 1, the first object apparatus (e.g., a smartphone, 1000) receives a pre-authentication result obtained from the authentication server 1300 as an intermediary of the service server 1100 by comparing authentication information previously registered using the usage information of the first object apparatus (e.g., smartphone 1000) and specific usage information extracted from the first object apparatus (e.g., a smartphone, 1000). Then, the first object apparatus (e.g., smart phone 1000) that has passed the pre-authentication makes a connection request to the second object apparatus (e.g., washing machine 1200) to the service server 110.

The service server 1100 receives a connection request to a second object apparatus (e.g., a washing machine 1200) of a first object apparatus (e.g., a smartphone 1000), and compares the authentication information previously registered with the usage information of the second object apparatus (e.g., washing machine 1200) with the specific usage information extracted from the second object apparatus (e.g., washing machine 1200), and receives a pre-authentication result from the authentication server 1300 through intermediation of the service server 1100, and provides a connection request to the second object apparatus (e.g., washing machine 1200) of the first object apparatus (e.g., smart phone 1000) to the second object apparatus (e.g., the washing machine 1200).

After that, the service server 1100 is requested to perform connection authentication to determine whether the connection request of the first object apparatus (e.g., smart phone 1000) is valid from the second object apparatus (e.g., washing machine) 1200 (3).

Then, the service server 1100 requests the authentication server 1300 to approve the connection authentication request (3), and receives the result of the connection authentication (3) from the authentication server 1300 (5).

The service server 1100 provides the result of the (3) connection authentication provided in (5) to the second object apparatus (e.g., washing machine 1200) (6).

Then, the second object apparatus (e.g., washing machine 1200) approves the connection request of the first object apparatus (e.g., smart phone 1000) through the result input in (6) (step (7)).

The second object apparatus (e.g., washing machine) 1200 transmits the approval result generated in step (7) to the first object apparatus (e.g., the smartphone 1000) via the service server 1100 so that the first object apparatus (e.g., a smartphone, 1000) can be connected to a second object apparatus (e.g., washing machine 1200) (8).

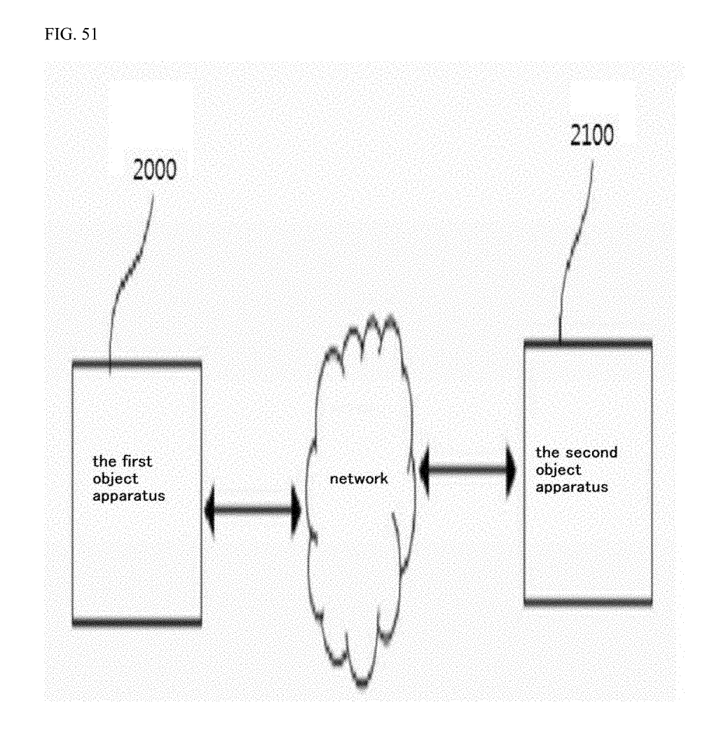

FIG. 51 is a detailed block diagram specifically illustrating an authentication system according to another embodiment of the present inventive concept.

In the authentication system shown in FIG. 51, when a first object apparatus (e.g., a smartphone, 2000) requests a connection to a second object apparatus (e.g., washing machine 2100), the authentication concept shown in FIGS. 10 to 12, or the authentication concept shown in FIGS. 13 to 15, that it is possible to apply the authentication concept.

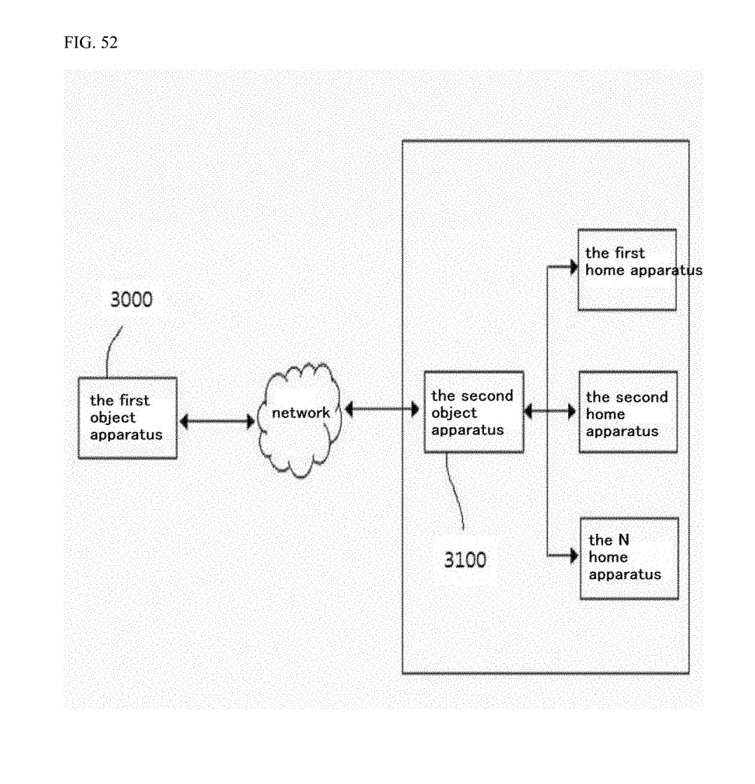

FIG. 52 is a detailed block diagram specifically illustrating an authentication system according to another embodiment of the present inventive concept.

In the authentication system shown in FIG. 52, when a first object apparatus (e.g., a smartphone, 3000) requests a connection to a second object apparatus (e.g., a home hub router 3100), it is possible to apply the authentication concept shown in FIGS. 44 to 46, or FIGS. 47 to 49.

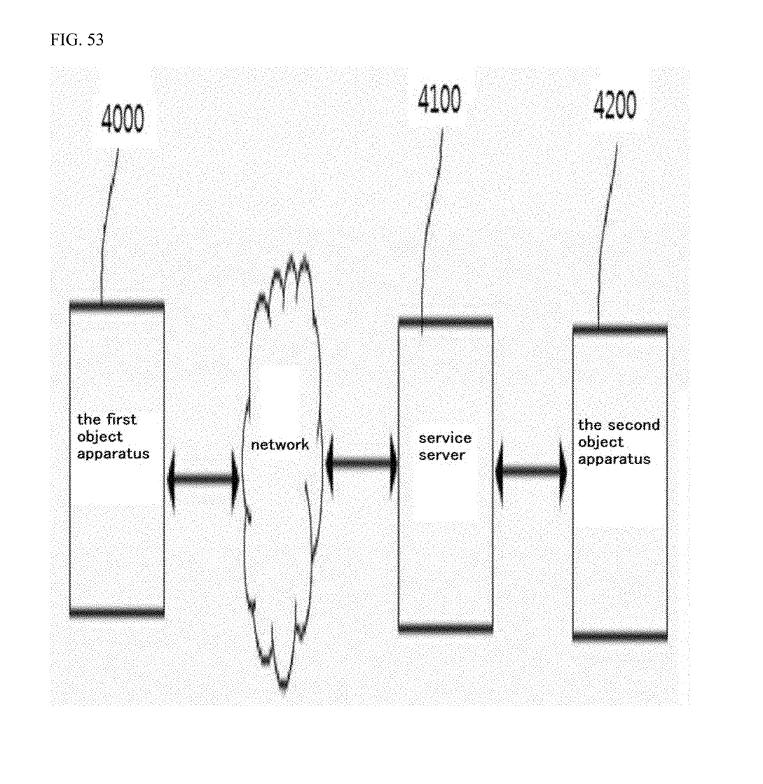

FIG. 53 is a detailed block diagram specifically illustrating an authentication system according to another embodiment of the present inventive concept.

In the authentication system shown in FIG. 53, when a first object apparatus (e.g., smartphone, 4000) requests access to a second object apparatus (e.g., washing machine, 4200) as an intermediary of the service server 4100, it is possible to apply the authentication concept shown in FIGS. 44 to 46, or FIGS. 47 to 49, or FIG. 50.

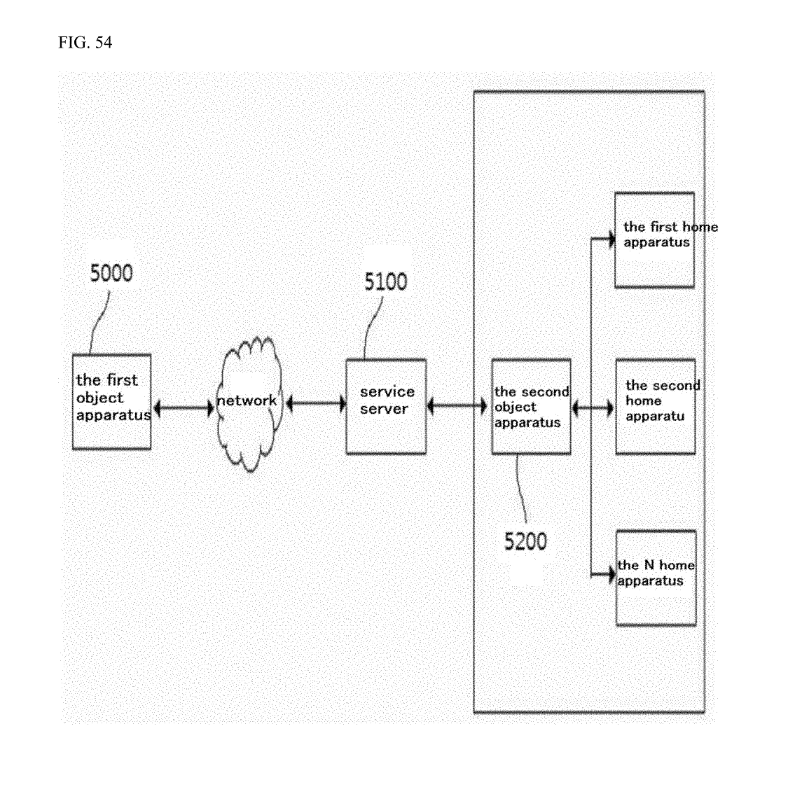

FIG. 54 is a detailed block diagram specifically illustrating an authentication system according to another embodiment of the present inventive concept.

In the authentication system shown in FIG. 54, when a first object apparatus (e.g., smartphone, 5000) requests access to a second object apparatus (e.g., home hub router 5200) as an intermediary of the service server 5100, it is possible to apply the authentication concept shown in FIGS. 44 to 46, or FIGS. 47 to 49, or FIG. 50.

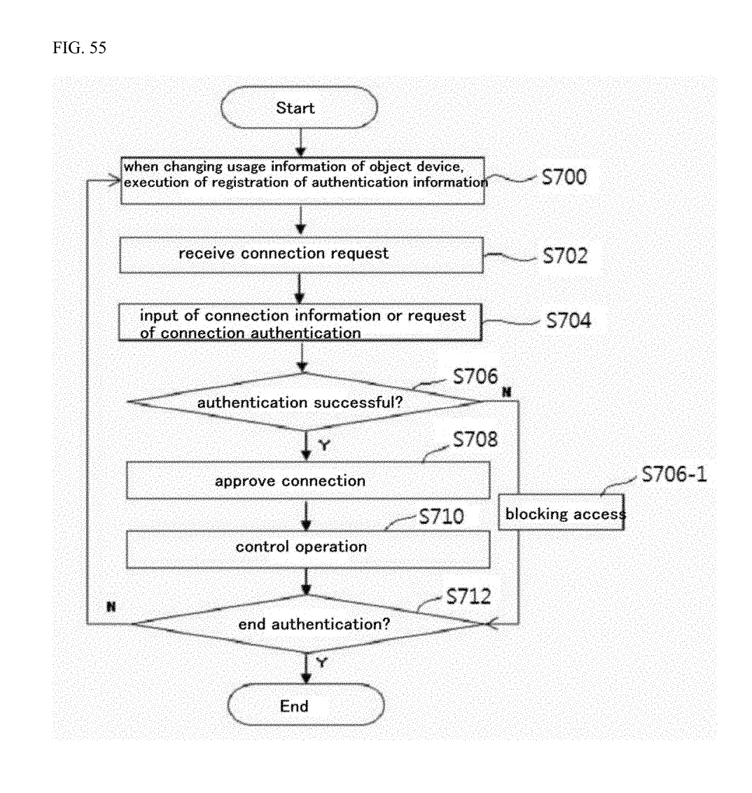

FIG. 55 is a flow chart illustrating one exemplary embodiment of an authentication process of an object apparatus of the present inventive concept.

In the authentication system shown in FIG. 55, the object apparatus 10-1 encrypts the registration request usage information including the changed usage information when the usage information of the object apparatus 10-1 is changed by a user's input or changed to a factor other than a user's input, and requests registration of the encrypted registration request usage information to the authentication server as the authentication information (S700).

Thereafter, when the object apparatus 10-1 receives the connection request from the other apparatus 20-1 (S702), the object apparatus 10-1 requests input of connection information or connection authentication corresponding to the registered authentication information in response to the received connection request (S704).

The object apparatus 10-1 determines whether the access to the other apparatus 20-1 is permitted according to the result of the authentication of the connection information or the connection authentication inputted in step S704 (S706).

If the connection is approved in step S706 (S708), after the connection of the other apparatus 20-1 is completed, the object apparatus 10-1 performs an operation in accordance with the control of the other apparatus 20-1 (S710).

If connection is not possible in step S706 (S706-1), the object apparatus 10-1 is not connected to the other object apparatus 20-1.

Thereafter, when the authentication process of the object apparatus 10-1 is completed, the execution of the above steps is also terminated (S712).

Each step of this authentication process may be implemented as a computer program stored in the recording medium in combination with the object device 10-1, or can be configured as a computer-readable recording medium including an instruction to execute each of the above steps when being executed by the object device 10-1.

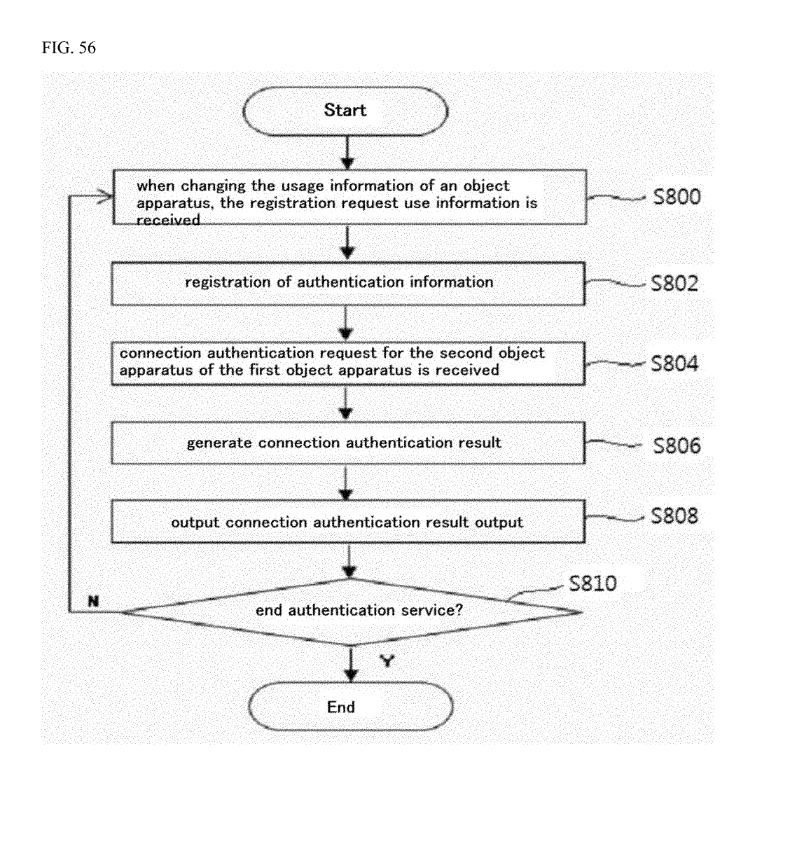

FIG. 56 is a flow chart illustrating one exemplary embodiment of an authentication process of an authentication server of the present inventive concept.

As shown in FIG. 56, when changing the usage information of an object apparatus, the authentication server 600 or 900 receives the registration request usage information including the changed usage information from the object apparatus (S800). At this time, in order to register the authentication information based on the changed usage information in the authentication server 600 or 900, the authentication server 600 or 900 may proceed after the registration procedure for using the authentication service of the present invention proceeds in advance. The subscription procedure may be performed in accordance with a normal service subscription procedure.

Thereafter, the authentication information is registered according to the registration request received in step S800 (S802). Here, the registration is a concept that includes registration of the first authentication information or updating of already registered authentication information.

Then, the authentication server 600 or 900 receives a connection authentication request for a second object apparatus (e.g., a washing machine) of the first object apparatus (e.g., smart phone) (S204).

Then, the authentication server 600 or 900 generates a result of the connection authentication request received in step S804, and outputs the generated connection authentication result as a response to the connection authentication request received in step S804 (S808).

Thereafter, when the authentication service is terminated, the execution of the steps is also terminated (S810).

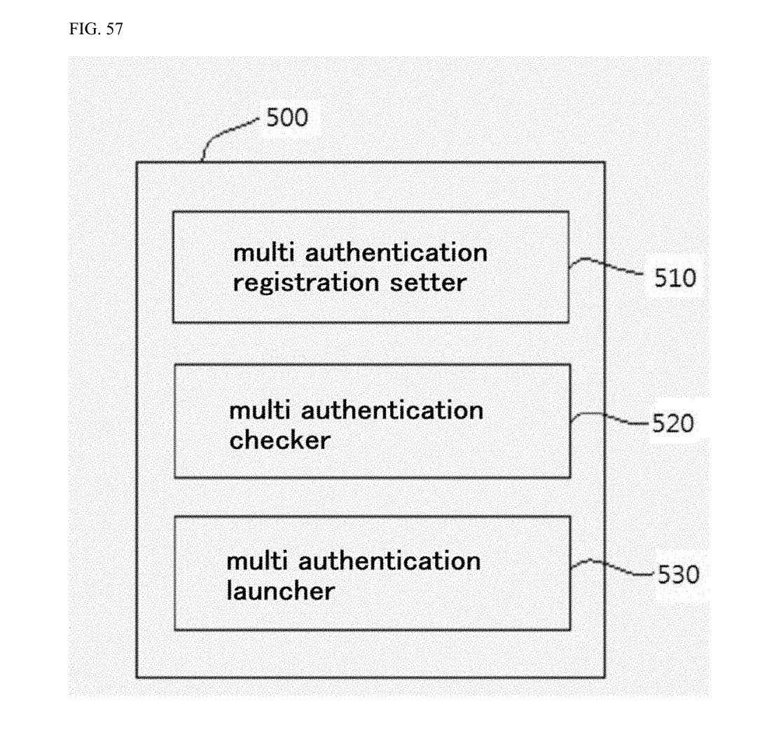

FIG. 57 is a block diagram illustrating a authentication apparatus according to another embodiment of the present inventive concept.

The user apparatus described above is at risk of being lost and stolen. It is possible to prevent the risk of loss and theft by utilizing a locking function (for example, pattern input or pin number input) provided by the user apparatus itself. However, many users do not utilize the locking function provided by the user apparatus itself (for example, pattern input or pin number input). Such a user may suffer damage due to loss or theft of the user apparatus.

In order to cope with this, a multi-approval scheme can be applied in the present invention. That is, the authentication is finally performed after the authentication of the first user apparatus, such as the user apparatus, is verified as well as the verification of the second user apparatus, which is the additional apparatus.

Here, the second user apparatus may be the same user apparatus as the first user apparatus, or may be a user different from the user of the first user apparatus.

If the first user apparatus and the second user apparatus are the same user's apparatus, the user will also verify the authentication of the first user through the second user apparatus other than the first user apparatus, it is possible to prevent unwanted authentication from being triggered even if there is a theft.

If the user touches approval in the approval request message transmitted to the first user apparatus, the user transmits a verification request message for authentication approval of the first user apparatus to the second user apparatus registered in the authentication server. Thereafter, the user can complete the multi-approval by touching approval during approval or rejection of the verification request message transmitted to the second user apparatus.

Here, a plurality of second user devices can be registered. For example, a company PC, a home PC, a tablet PC, and another smartphone of a user can both be registered as a second user apparatus. when a user makes a payment request, an authentication confirmation request message is transmitted to the first user apparatus for authentication to approve the payment request, and when approval is touched in the authentication confirmation request message, validation confirmation messages can be delivered to the tablet PC and to another smartphone of the user.

Of the above-mentioned company PC, home PC, tablet PC and another smart phone of the user, only the home PC is active and the rest may be inactive. The user can complete the verification check by touching approval in the verification confirmation message transmitted to the home PC.

Even if the company PC, the home PC, the tablet PC, and another smartphone of the user are both activated, verification confirmation can be completed even if only authentication is touched in the verification confirmation message of any of the devices.

Here, the activation or deactivation of the second user apparatus may be for power on or off, and may be indicative of the status of an app login or app logout related to verification verification.

When the first user apparatus and the second user apparatus are the same user's apparatus, the user is appropriate to prepare for the loss and theft of the first user apparatus without inconvenience to others.

On the other hand, when the first user apparatus and the second user apparatus are different user apparatus, a method of utilizing a apparatus of another user is used.

Let the user of the first user apparatus be the A user and the user of the second user apparatus be the B user. When the user A touches the approval in response to the authentication confirmation request message forwarded to the first user apparatus, a message is transmitted to the second user apparatus requesting verification of the authentication approval of the first user apparatus. Thereafter, the user B recognizes the authentication process of the user A (for example, the 15000 won commodity payment process at the Y shopping mall) by viewing the verification confirmation request message transmitted to the second user apparatus, and can approve or reject the verification. When the user B's verification is approved, the authentication process proceeded from the user A can be completed. However, if the user B's verification is denied, the authentication process from the user A will not be completed.

That is, when the first user apparatus and the second user apparatus are different user apparatuses, it is applicable to an elderly person who is not familiar with IT technology or a student whose parents require consent.

Specifically, an authentication apparatus 500 comprising: a multi authentication registration setter 510 which sets registration of a second user apparatus for verifying authentication approval of a first user device in a state in which the registration of the authentication information based on a changed information is executed, if at least one of the screen information displayed on a specific screen of the first user apparatus and an usage history of the first user apparatus is changed by an user's input or is changed to a factor other than the input of the user, an multi authentication checker 520 which receives a verification request for authentication approval of the first user apparatus from a network connected to the second user apparatus and an multi authentication launcher 530 which transmits an information for verification confirmation to the network in response to the verification request, according to whether or not the verification request is approved.

The authentication apparatus 500 may be included in the second user apparatus or may be coupled to the second user apparatus.

The multi authentication registration setter 510 may generate a request message to register the second user apparatus as a verification acceptance device and transmit the request message to the authentication server when the users of the first user apparatus and the second user apparatus are identical. The authentication server may forward the received request message to the first user apparatus, and may register the second user apparatus as the verification acceptance device upon receiving the registration approval of the first user apparatus. This is only one registration progress example.

The multi authentication registration setter 510 may generate a request message to register the second user apparatus as a verification acceptance device and transmit the request message to the authentication server when the users of the first user apparatus and the second user apparatus are identical. The authentication server may forward the received request message to the first user apparatus, and may register the second user apparatus as the verification acceptance device upon receiving the registration approval of the first user apparatus. This is only one registration progress example.

Also, the multi authentication registration setter 510 may receive a request message to register the second user apparatus as a verification acceptance device when the users of the first user apparatus and the second user apparatus are different. Thereafter, if the user of the second user apparatus intends to verify the authentication of the first user apparatus, the authentication server may touch the authorization for the received request message, the authentication server may then register the second user device as a verification acceptance device. This is also just one example of the registration process.

The multi authentication checker 520 indicates approval or denial of the verification request message for authentication verification of the first user apparatus so that the user of the second user apparatus can confirm the authentication.

The multi authentication launcher 530 may process the information for verification confirmation in response to the verification request according to the approval or disapproval of the verification request message for the authentication confirmation of the first user apparatus. For example, information for verification can be transmitted to the authentication server.

Here, the information for verification confirmation may be information on the approval or rejection selection for the verification confirmation at the second user apparatus, or may include at least one of the unique identification information of the second user equipment and the authentication apparatus 500, and information about the approval or rejection choice.

In addition, the information for verification confirmation may be such that at least one of the screen information displayed on the specific screen of the second user apparatus and the usage history of the second user apparatus is changed by the user's input or changed to a factor other than the user's input, and it is also possible that the authentication information is registered in the authentication server based on the changed information.

It is also possible that the information for verification confirmation is information that is changed based on the verification execution details of the authentication confirmation of the first user apparatus. For example, it is possible to transmit the verification details of the authentication confirmation of the past first user apparatus to the authentication server as information for verification confirmation at the second user apparatus. If the verification process is completed, the information for verification of the second user apparatus can be the verification result of the authentication verification of the first user apparatus, which has been subjected to the verification process.

When at least one of the screen information displayed on the specific screen of the first user apparatus and the usage history of the user apparatus is changed by the user's input or is changed to other factors than the input of the user, the authentication server 40 can receive the registration setting of the second user apparatus that verifies the authentication approval of the first user apparatus from the authentication apparatus 500 while the registration of the authentication information based on the changed information is executed.

Thereafter, the authentication server 40 may register the second user apparatus as a device for verifying the authentication approval of the first user apparatus.

Thereafter, when the authentication request related to the user of the first user apparatus is received, the authentication server 40 receives the authentication approval of the first user apparatus and transmits a verification request for authentication approval of the first user apparatus to the second user apparatus.

Thereafter, the authentication server 40 generates a final authentication result according to whether the verification request is approved or not, and transmits the final authentication result in response to the received authentication request.

On the other hand, when at least one of the screen information displayed on the specific screen of the first user device and the usage history of the first user device is changed by the user's input or is changed to another factor other than the input of the user, the authentication apparatus 500 can register and set up the second user device that verifies the authentication approval of the first user device in the state where the registration of the authentication information based on the changed information is executed.

The authentication apparatus 500 may then receive a verification request for authentication approval of the first user apparatus from the communication network associated with the second user apparatus.

Thereafter, the authentication apparatus 500 may process information for verification confirmation in response to the verification request to the network, depending on whether or not the verification request is approved.

Each step of this verification process may be implemented as a computer program stored in a recording medium in combination with an authentication apparatus 500 or a computer readable recording medium including instructions for executing the above steps when executed by an authentication apparatus 500.

While the present invention has been described in connection with what is presently considered to be practical exemplary embodiments, it will be understood by those skilled in the art that the present invention may be embodied in other specific forms without departing from the spirit or essential characteristics thereof. It is therefore to be understood that the above-described embodiments are illustrative in all aspects and not restrictive.

1. An authentication apparatus comprising:
a memory; and
at least one processor;
the processor is configured,
to specify the changed information when an usage information of the user apparatus or the object apparatus is changed by being used for the purpose given to the user apparatus or the object apparatus, or is changed by using another factor other than the given use,
to execute patternless security based on the changed information.

2. An authentication apparatus of claim 1,
wherein the authentication apparatus is included in the user apparatus or the object apparatus, or is connected to the user apparatus or the object apparatus.

3. The authentication apparatus of claim 1,
wherein the authentication apparatus supports device authentication for the user apparatus or the object apparatus.

4. The authentication apparatus of claim 1,
wherein the authentication apparatus supports compound authentication in the form of adding user authentication to the device authentication.

5. The authentication apparatus of claim 1,
wherein the authentication apparatus supports independent authentication of the user apparatus or the object apparatus.

6. The authentication apparatus of claim 1,
wherein the authentication apparatus supports multi-authentication between the user apparatus and at least one other user apparatus, or multi-authentication between the object apparatus and at least one other apparatus.

7. the authentication apparatus of claim 1,
wherein the authentication apparatus supports mutual authentication between the object apparatus and at least one other apparatus.

8. An authentication method by authentication apparatus, the method comprising:
specifying the changed information when an usage information of the user apparatus or the object apparatus is changed by being used for the purpose given to the user apparatus or the object apparatus, or is changed by using another factor other than the given use; and
executing patternless security based on the changed information.

9. the authentication method of claim 8,
wherein the authentication method supports device authentication for the user apparatus or the object apparatus through execution of each of the above steps.

10. the authentication method of claim 9,
wherein the authentication method further includes performing user authentication in addition to the device authentication.

11. the authentication method of claim 8,
wherein the authentication method further comprises supporting multi-authentication between the user apparatus and at least one other user apparatus, or multi-authentication between the object apparatus and at least one other apparatus.

12. the authentication method of claim 8,
wherein the authentication method further includes supporting mutual authentication between the object apparatus and at least one other apparatus.

13. A non-transitory recording medium on which a computer program to execute an authentication method, the method comprising:
specifying the changed information when an usage information of the user apparatus or the object apparatus is changed by being used for the purpose given to the user apparatus or the object apparatus, or is changed by using another factor other than the given use; and
executing patternless security based on the changed information.

14.-21. (canceled)
